(19) United States
(12) Patent Application Publication
(10) Pub. No.: US 2007/0255965 A1
(43) Pub. Date: Nov. 1, 2007

(54) System and method for content marketplace, DRM marketplace, distribution marketplace, and search engine: the dodge city marketplace and search engine

(75) Inventor: Elliot McGucken, Malibu, CA (US)

Correspondence Address: Elliot McGucken, 24345 Baxter Drive, Malibu, CA, 90265, US

(73) Assignee: Elliot McGucken, Malibu, CA (US)

(21) Appl. No.: 11/787,287

(22) Filed: Apr. 15, 2007

Related U.S. Application Data
(60) Provisional application No. 60/792,107, filed on Apr. 15, 2006.

(51) Int. Cl. G06F 12/14

(52) U.S. Cl. 713/193

(57) ABSTRACT

The present invention offers novel and superior means for creating a content marketplace. The present invention allows technology companies to compete to meet and serve the creators' rights. Just as reverse auction systems allow consumers to name their price, with service providers competing to meet the price, the present invention allows artists, creators, and content owners to define their rights, whereupon content aggregators, record labels, social networks, DRM providers, device manufacturers, search engines, and others compete to bets meet the creators' needs. This innovation reflects the fact while technology companies are commodities, and thus artists ought declare their independence, and ascend to their natural place in the universe—those who take the risks and create the wealth on their Heroes' Journeys ought reap the rewards. The Dodge City Marketplace will lead to greater revenue and rights for artists, superior search engines, distribution, and art, and trusted standards for DRM.

### CROSS-REFERENCE TO RELATED APPLICATIONS

This application claims the benefit of provisional patent Ser. No. 60/792,107 filed Apr. 15, 2006 by the present inventor.

### FEDERALLY SPONSORED RESEARCH

Not Applicable

### SEQUENCE LISTING OR PROGRAM

Not Applicable

### BACKGROUND OF THE INVENTION

### Field of the Invention

The present invention relates to a marketplace and search engine that provides creators enhanced control of rights definitions, rights management, syndication, distribution, delivery, watermarking, and ecommerce. The moral premise of the present invention is that every creator ought to be afforded the rights to protect and profit from their creations.

Imagine a trusted application where an artist, indie or established, could upload their content, define their rights, and then have device makers/DRM providers such as Apple and Microsoft try to best meet and serve the rights definitions set by the artists. Google and other future device makers/DRM providers would be able to participate, and the artist could select from one or all of the device makers/DRM providers. And too, content aggregators such as youtube®, flickr®, myspace®, google®, microsoft®, apple®, yahoo® could bid for the right to serve the artist's content, pay for the right to serve the artist's content, compete for the right to serve the artist's content, pledge to protect the artist's content, and share profits with the artist, all based on rules and conditions set by the artist. If any of the millions of web 2.0 companies did not want to share procedes nor profits; if any of the DRM systems did not work; if a Steve Jobs at some company decided to foresake DRM and protecting the artist's content as they profit from the commoditization and aggregation of the artists to sell devices, then they artists could simply say “no.” Over time, systems and devices will emerge that best serve the artists' and creators' rights, thusly resulting in enhanced and improved art, and greater profits for those who create it, enriching all.

In this day and age of Reality TV and American Idol, which are far more about the conglomerates' bottom line than they are about Epic Story, the need for digital rights management is easy to overlook. With MFAs/MBAs/lawyers/bloggers driving the content creation for giant media conglomerates and the State, instead of our own Johnny Cashes and John Waynes, our own Audrey Hepburns and Grace Kelly's, our own Sergio Leones and John Fords, and our own Bob Dylans and Beatles driving the creation of content for the sake of higher art, it is easy to say—hey—we don't need DRM to protect all the reality TV crap/manufactured pop stars/MBA marketing plans. But true art needs digital rights management, as sure as true artists need better opportunities to protect and profit from their creations. And not only that, but in the United States of America, every citizen is granted by the US Constitution to protect and profit from that which they create. Devices, software, hardware, and digital rights management that best serve the spirit of the Constitution, and the Natural Rights of the artists, will stand head and shoulders above the current state of the art and prior art, which is characterized by fog-blowing pr machines, snarky bloggers, postmodern lawyers intent on deconstructing the Constitution rather than serving ideals greater than themselves, and Wall Street bankers attempting to transfer all the risk to the small investor, creator, and artists, and all the wealth of others' creations and hard work to themselves. Ironically enough, the Wall street bankers use communistic methods, and then flip the script at the last second, as communists always do, believing that they do not believe in private property such as the truth. It is communistic to tell an artist that they have no value on their own, but when aggregated together, they have a value of over $1.6 billion. The postmodern machine uses this communistic premise, but then at the last denies their communistic tendencies by saying, “hey—we're going to keep all the money and share none of it with the content creators and owners, as really we're capitalists.” So it is that the gutting of our educational institutions, and the year-in-year-out promotion of the ironic ambitious has resulted in a system where the artists—the Atlases of creation—the heart and soul of the internet—the fount of virtue and thus all lasting wealth—have no rights.

The current DRM/device landscape is a vast mess which falls far short of the potential of contemporary technology to serve the spirit of the United States Constitution. Dodge City will become a City on a Hill, providing artists and creators and content owners with the maximum rights options and mechanisms to protect and profit from their art, consumers with the maximum content options, and device makers and DRM providers the maximum opportunity to serve the most artists, creators, and consumers; thusly enriching entrepreneurial companies which best serve everyone upon a level playing field before the Ultimate Umpire's Higher Ideals.

An embodiment of the present invention allows creators upload their content, define their rights and price, and then have DRM providers, distributors, device makers, search engines compete to best serve and distribute their content.

This invention is dedicated to George Lucas, every indie filmmaker, Fifty Cent, Eminem, Harlan Elison, Kid Rock, George Lucas, Puff Daddy, Lars Ulrich, Aimee Mann, Kristin Hersh, Scott Weiland, Kristen Hersh, Chris Robinson, toby Keith, Lou Reed, Victoria Shaw, Art Alexakis, the Beatles and Rolling Stones, Bob Dylan, DMX, and every other artist who started off as an indie artist, as every artist does, and all the indie artists to come. The present invention salutes Abraham Lincoln's eloquence, the spirit and words of the United States Constitution and The Declaration of Independence, Johnny Cash, and the Creator they all served. For it is creator's Natural Right to protect and profit from their creations. Johnny Cash sings a song called, “When the man comes around.” At the end of the Odyssey Odysseus returns to slay all the amoral and immoral slackers who stayed back at home and lead his wealth to waste while he was off fighting for his country. Academia, Hollywood, and Wall Street have banned classic art with a third act—they have banned the classic Western, as Aristotle says, “when storytelling declines, the result is decadence,” and the postmodern elite prosper and profit via decadence. The ideals which keep the family together, seal the handshake, afford indie artists DRM, and guide exalted curriculums all get in the way of the mediocre, arrogant mob's methods for minting money. Truth and Beauty get in the way of bubbles, hype, deception, and false “social entrepreneurship,” which often brings to mind Orwell's Animal Farm. The snarky snark bloggers, CEOs, and academics who dominate will laugh at this invention, as they profit via snark and making the worse argument appear better, and they can laugh and snark all they want, like the suitors in Odysseus's home, as Zeus and Athena are on Odysseus's side, and Odysseus is on his way back. The snickering snarky snark laywer/mba/bloggerati are like the outlaws in Fistful of Dollars, laughing at Clint Eastwood's mule: “I don't think it's nice, you laughin'. You see, my mule don't like people laughing. He gets the crazy idea you're laughin' at him. Now if you apologize, like I know you're going to, I might convince him that you really didn't mean it.”

Moses gave us ten commandments, which when married to the technology, would provide a decent DRM system for the artists, authors, and creators. The ten commandments he gave us are: “1. I am the Lord thy God, which have brought thee out of the land of Egypt, out of the house of bondage. Thou shalt have no other gods before me. 2. Thou shalt not take the name of the Lord thy God in vain. 3. Thou shalt not make unto thee any graven image, or any likeness of anything that is in heaven above, or that is in the earth beneath, or that is in the water under the earth. Thou shalt not bow down thyself to them, nor serve them. 4. Remember the sabbath day, to keep it holy. 5. Honor thy father and thy mother: that thy days may be long. 6. Thou shalt not kill. 7. Thou shalt not commit adultery. 8. Thou shalt not steal. 9. Thou shalt not bear false witness against thy neighbor. 10. Thou shalt not covet thy neighbor's house, thou shalt not covet thy neighbor's wife, nor his manservant, nor his maidservant, nor his ox, nor his ass, nor anything that is thy neighbor's.” It is hard imagine the snarky MBA/blogger/lawyer reading these without laughing, as practically all of the Ten Commandments get in the way of short-term profits. But without these Ten Commandments, without Shakespeare and the Bible, without Homer's Odyssey and the Jewish Christian religion that Einstein and Martin Luther King Jr. and Mother Theresa all held dear, the cultural renaissance cannot be, and it will be hard to contemplate and conceive of a DRM marketplace that better serves the artist and creator.

Commandment #8 would go a long ways, but in these snarkfest-ironic times, what is theft? What is stealing when half of the indie artist's income is taken in taxes, and their creations are taken to be given away by vast media companies, so that they can sell more devices? Commandment #5 has also been tossed aside, so that #8 might be more easily circumvented, as anything that grows the State/Corporation and diminishes the family, replacing covenants with contracts, Character and Plot with Reality TV, and Truth with Fads and fleeting fashions, is a good thing. Thus this present invention—a marketplace of DRM options serving artists and creators, is opposed by the reigning experts of our day, who are great and vast experts in the letter of the law, but have lost its Soul, Spirit, and Meaning via all the acrobatics dedicated to serving the snarkfest's bottom line.

Now a lot of snary-snark lawyer/gipster/hipsters will call me a liar and worse for quoting the ten commandments, but then they are calling Jefferson, Lincoln, and Martin Luther King Jr. liars and worse. Lincoln spoke these famous words, “Four score and seven years ago our fathers brought forth on this continent, a new nation, conceived in Liberty, and dedicated to the proposition that all men are created equal. Now we are engaged in a great civil war, testing whether that nation, or any nation so conceived and so dedicated, can long endure. We are met on a great battle-field of that war. We have come to dedicate a portion of that field, as a final resting place for those who here gave their lives that that nation might live. It is altogether fitting and proper that we should do this. But, in a larger sense, we can not dedicate—we can not consecrate—we can not hallow—this ground. The brave men, living and dead, who struggled here, have consecrated it, far above our poor power to add or detract. The world will little note, nor long remember what we say here, but it can never forget what they did here. It is for us the living, rather, to be dedicated here to the unfinished work which they who fought here have thus far so nobly advanced. It is rather for us to be here dedicated to the great task remaining before us—that from these honored dead we take increased devotion to that cause for which they gave the last full measure of devotion—that we here highly resolve that these dead shall not have died in vain—that this nation, under God, shall have a new birth of freedom—and that government of the people, by the people, for the people, shall not perish from the earth.”

Make no mistake—Lincoln was not being ironic when he said—“that this nation, under God, shall have a new birth of freedom—and that government of the people, by the people, for the people, shall not perish from the earth.”

Thomas Jefferson also references the Founding Father of all Founding Fathers. On the Jefferson Memorial, the following words are enscribed—words you will never see on the Lessig memorial, even though Lessig attended a far more prestigious law school than did Jefferson: “We hold these truths to be self-evident: that all men are created equal, that they are endowed by their Creator with certain inalienable rights, among these are life, liberty, and the pursuit of happiness, that to secure these rights governments are instituted among men. We . . . solemnly publish and declare, that these colonies are and of right ought to be free and independent states . . . And for the support of this declaration, with a firm reliance on the protection of divine providence, we mutually pledge our lives, our fortunes, and our sacred honor.”

So there you have it—all men are created equal. That means that every artist, every creator, and every innovator ought be given the technology that grants them the ability to fulfill their destiny—their hero's journey—by protecting and profiting from their work. It is easy for atheists to cut corners and exploit, but over time, their words do not last, for they have not immortal justice's third act. Also on Jefferson's memorial, it is written, “Almighty God hath created the mind free. All attempts to influence it by temporal punishments or burthens . . . are a departure from the plan of the Holy Author of our religion . . . No man shall be compelled to frequent or support any religious worship or ministry or shall otherwise suffer on account of his religious opinions or belief, but all men shall be free to profess and by argument to maintain, their opinions in matters of religion. I know but one code of morality for men whether acting singly or collectively.” So it is that we have freedom of religion, and if one believes that every artist, author, and creator ought have access to technology that grants them the a full spectrum of rights management and digital rights management to choose from, such a belief shall be freely expressed.

Also on the Jefferson memorial it is written, “God who gave us life gave us liberty. Can the liberties of a nation be secure when we have removed a conviction that these liberties are the gift of God? Indeed I tremble for my country when I reflect that God is just, that his justice cannot sleep forever. Commerce between master and slave is despotism. Nothing is more certainly written in the book of fate than that these people are to be free. Establish a law for educating the common people. This it is the business of the state and on a general plan.” So it is that “commerce between master and slave is despotism.” When artists, creators, and innovators have no access to a free marketplace presenting them with various DRM options, then they are forced to forever labor for the vast conglomerates, aggregators, and their snarky lawyers, which care not for the higher ideals, but only for the money made via mob rule. And thus we have American Idol and Simon Cowell and Reality TV instead of Epic Story, Johnny Cash, Audrey Hepburn, Sergios Leone, and John Wayne. And thus opportunity abounds—vast opportunity.

Also on the Jefferson memorial it is written, “I am certainly not an advocate for frequent and untried changes in laws and constitutions. I think moderate imperfections had better be borne with; because, when once known, we accommodate ourselves to them, and find practical means of correcting their ill effects. But I know also, that laws and institutions must go hand in hand with the progress of the human mind. As that becomes more developed, more enlightened, as new discoveries are made, new truths disclosed, and manners and opinions change with the change of circumstances, institutions must advance also, and keep pace with the times. We might as well require a man to wear still the same coat which fitted him when a boy, as civilized society to remain ever under the regimen of their barbarous ancestors.” And so it is that my and future generations ought not be forced to live under the regimen of our barbarous ancestors—without a turnkey solution for a DRM system providing multiple competitive options to the creators, and the trusted marketplace such a system would afford. We ought not be forced to live under the snarky era of decline ushered in by our barbarous postmodern ancestors, who deconstructed the truth and destroyed the handshake, the Word, the family, the classic western, all so that they could bolster their short-term bottom line.

Lastly, the most prominent words, inscribed around the circular ceiling, state, “I have sworn upon the altar of God eternal hostility against every form of tyranny over the mind of man.” So it is that every artist must remain forever free to say what they want and own what they do—the products and labor of their minds—their sacred dreams and visions. And this present invention, by providing artists with a manner in which to protect and profit from their creations, shall allow them to earn their freedom to make their passions their professions, and their avocations their vocation.

### PRIOR ART

The Orwellian leadership skills of Steven Jobs, while great in creating short-term profits for commoditized aggregators and hardware manufacturers, is not capable of inspiring nor leading nor exalting the greater wealth of the internet, nor is it capable of inspiring and serving the renaissance that shall be built by tomorrow's artists and innovators, liberated from the postmodern doublespeak that pervades the corridors of academia and business, all with the sole goal of transferring the risk to the honest indie artist, creator, innovator, and inventor, and all the wealth to the ever-burgeoning pomo-hipster machines in the Matrix. The google/youtube doublespeak, combined with their rampant copying of books without the authors' permissions, has diminished google's ability to lead the future of content creation and distribution. What is needed is a new sheriff who isn't doing it for the money and bottom line, but a new sheriff who is doing it for the higher ideals, so that law and order, and their children—trust and the handshake—might be restored to the content industry. For yesterday Steven Jobs said DRM is good, today he said it is good for movies, but no longer for music, and tomorrow he will say something else, and be lauded for it, as the mark of the snarky snark blogger is the ability to change direction and ignore higher ideals, and praise their Lord and Saviour Steven Jobs. For similar reasons, NY Times critics such as AO Scott love plotless, storyless, exploitative, cheap movies such as Grindhouse, while snarking deep, profound films about love, honor, duty, glory, and country—about valor and commitment—about living for ideals—movies such as 300 and Braveheart. They cannot help it—with ambitions overshadowing their talents, they must tear the Great Books and Classics and Constitution down, hand out tenure and degrees to their compatriots, and party on Odysseus's estate as culture declines. They watch the shadows dancing on the cave's wall, oooh and ahhh, and sleep peaceably at night, never pausing to reflect nor thank the rough men who stand ready about the globe to give that last full measure of devotion to protect their freedom, which they use for decline and decadence. But as Odysseus approaches home, their reign approaches its end.

Nowhere in the prior nor current art does a system exist which would serve the artist and creator, the Hollywood studios and indie filmmakers, the labels and the indie bands, so well as this present invention. By adhering to exalted principles set forth in our Constitution and paid for in the blood of soldiers who “gave that last full measure of devotion” so that we might have our freedom, the present invention and Dodge City DRM Marketplace, combined with the principles laid forth in the 45 Revolver patent application, shall serve artists with a superior methods and means for protecting and profiting fro their content. Nowhere in the prior nor current art does a system exist wherein the artist/creator/owner is able to easily define their rights, and the DRM providers, aggregators, device makers, and others who profit from the commoditization of art must compete on a level playing field to provide the creators their due and exalted protection and rights, as are granted by Natural Law, Biblical Law, and the Law of the United States Constitution—all of which have ever been opposed by the communist and socialist, in favor of the one and only law they know—their appetite.

Steven Jobs and A Prominent Pomo-Hipster Dot Com CEO and Larry Lessig know that the masses—the bloggers, lawyers, and wanna—be artists vastly outnumber the true artists. As artistic talent is God-given and honed by blood, sweat, and tears, while law degrees are sold to the highest bidder with an aptitude for the lowest common denominator, Steve, Pomo-hipster MBA/Lawyer/CEOs, and Larry know that they can advance their cause of profiteering off of creators by uniting the masses in the spirit of democracy—because there are more listeners and consumers of art than creators of art, the consumers and listeners have the natural right to have DRM-free content, for that is how the blogosphere is voting. Plato's Republic describes how democracy can vote itself into Tyranny by making Kings out of those who trump Eternal, Natural, Biblical, and Constitutional rights via marketing campaigns and snarky-snark management techniques, wherein legions of useful idiots are promoted with degrees and titles in a realm where art alone buys one the ticket to immortality, and Truth and Beauty purchase passage to eternity. Steve's, Pomo-hipster MBA/Lawyer/CEOs's, and Larry's prior art, influenced by their “boomer-irony-must-serve-the-bottom-line-at-the-expense-of-all-future-generations,” has thus fallen short of what the internet could be, were DRM providers and device manufacturers united in best serving the artists. The cultural renaissance inspired by the current invention would contribute far greater overall wealth to society than doublespeaking erosions of private property rights, parading behind a facade of democratic utopia.

Men with iron ideals in their hearts are needed to lead the renaissance, and the resulting Dodge City DRM Marketplace shall become a bustling city of commerce. For whoever can lay down the law shall attract all the greatest artists, authors, and creators—not the pseudo artists who always put politics and flattery above truth—but the eternal artists—who follow the truth, speak the truth, render the truth, and Live the Truth, come hell or high water. Freedom and Justice are the rock upon which all marketplaces must be built, and one cannot have either without Trust—without the Cowboy's handshake and Penelope's faithfulness. It is no mystery, then, that the media companies seek relentlessly to destroy the family, the handshake, and Penelope—all for the sake of short-term profits. But that leaves us vast opportunity to build a renaissance—in Hollywood and the Heartland; on Wall Street and Main Street; in Technology and Movies; in Video Games and Novels. The aging cultural bureaucracies think the people exist to provide them with revenue; and I say we exist to provide the people with exaltation and enlightenment; and I go to give the people this.

The postmodern boomer elite who enjoy rampant profiteering via building bubbles around every virtuous activity, generally approach all with a similar formula. 1) deconstruct the higher ideals—much of the work has already been done throughout academia. 2) assemble a loyal group of people with ambitions overshadowing their talents—a new bureaucratic, talentless, uncreative, useless that has made a virtue out of uncreativity and the complete lack of will to take risks to serve the higher ideals and one's fellow citizens—an uneducated, uncurious, demonic class that can sprinkle that magic MBA dust on any innovation or invention to transform it into a mechanism that allows the elite insiders to more risk to the workers, artists, innovators, and inventors, and more wealth to the MBA insiders who are setting up shop with their two-year degrees of pomo-hipster handwaving, kicking around Ph.D.'s like the beggar and suitors kicked around Odysseus. 3) expel true innovators, free-thinkers, and entrepreneurs in institutions purporting to support innovation, free-thought, and entrepreneurship. 4) raise massive government and institution foundation grants to support innovation, free-thought, and entrepreneurship, blaming the lack of these assets not on the machine that just exiled them, but on the people who have no choice but to be subservient to the machine, as the machine portends to be the only game in town, gobbling up all the surrounding real estate, tax, and tuition dollars. 5) instigate a bubble. 6) market and hype the bubble to the common investor, so as to legally and honorably pillage their pensions and plunder their savings. 7) give tenure to venture capitalists and lawyers to fight off the lawsuits against the venture capitalists for floating dishonest, worthless companies. 8) wait a few years as things get worse, and repeat-university campuses provide excellent health benefits and facilities for lawyers and VCs who are in-between bubbles. 9) create new centers of entrepreneurship to give awards to the old centers of entrepreneurship that never really did anything, other than give awards to the new centers of entrepreneurship. 10) watch TV and enjoy the cultural economic, and familial decline. 11) ignore the higher ideals by focusing on the bottom line, and cash in on every last vestige of cultural wealth to bolster the dollar in the short-term, before cashing on out in the great boomer retirement. 12) replace Johnny Cash and John Wayne with Simon Cowell and Orlando Bloom. 13) Replace Lincoln, Jefferson, and the Law with Lessig and his students that show the greatest potential to serve the aggregators' bottom line over the higher ideals and the artists' Natural, Biblical, and Constitutional Right. 14) Wash, rinse, and repeat on the journey on down, and enjoy the short-term profits for the moment as Odysseus makes his way on home to Penelope—for only one can string the bow.

This present invention is dedicated to all the entrepreneurs seeking to build a renaissance that recognizes the higher ideals by which all everlasting art is created, and by which such art might be protected, so that creators reap the maximum profits. In addition to serving the creator and indie artist, the present invention will open doors for entrepreneurs seeking to build novel and superior distribution systems for digital content—systems which reward the artist and creator in ever improving manners, thusly fostering greater art and wealth—both cultural and monetary. “The world will know that free men stood against a tyrant, that few stood against many, and before this battle was over, that even a God-King can bleed,” as the Spartan King Leonidas says in 300 the movie.

Bryan Chaffin writes the following in an article entitled, Apple Shouldn't Blame Labels for DRM in The Mac Observer, on Apr. 13, 2007 10:19 AM PT: “It is this position that Smith appears to take issue with. “I believe that fundamentally people who produce content and who own the rights to that content deserve the opportunity to make their own decisions about how they want to provide that content to the public,” he said. The present invention would allow the artists and creators maximum choice, by creating a DRM and distribution marketplace called the Dodge City DRM Marketplace.

Ian Johnston writes in Lecture on the Odyssey, in http://www.mala.bc.ca/˜johnstoi/introser/Homer.htm”

“We learn early in the poem from the gods themselves that this universe has a single coherent and binding moral principle, that the home must be respected. There are many references (about ten or more) throughout the poem to the famous story of Agamemnon, the leader of the Greek expedition against Troy, who was murdered by his wife, Clytaemnestra, and her lover, Aegisthus, and of his son, Orestes, who avenged the murder by killing Aegisthus. This story—along with the unequivocal approval of the gods for the actions of Orestes—acts as a repetitive reminder of the single overriding moral principle of this universe, as important in this world as the commandments brought down from Mount Sinai by Moses are in the world of the Old Testament. In other words, central to the vision of the Odyssey is the upholding of the major moral principle of the universe: the value of the home. This is, if you like, the ethical norm established in the poem both in the commandments of the gods and the actions of the principal characters. And Homer in the early books makes sure we see just what that home life really means, in the courts of Nestor and Menelaus. This enables us to understand clearly enough what is going wrong with all the suitors messing things up in Ithaca and why Odysseus, when we meet him, so values his home.”

So it is that the home and the family—the fundamental forms of private property, along with the truth—have been, and are currently under assault. As the Great Books and Classics, from Athens and Jerusalem alike, exalt the better angels of our nature, they have been exiled from the schools of education and college campuses by the suitors trying to win faithful Penelope's heart, so that her bond with Odysseus might be forever broken, and that Homer's glorious, exalting poetry might be forever forgotten, concealed behind the postmodern fog. As living artists so often remind us of the same verities that those artists of yore served, they must be denied their fundamental rights to protect and profit from their content, so that the short-term profits of the lotus eaters and content aggregators might be better served. The artists and creators are the few—the poets and prophets who are eternally exiled and persecuted like Dante, Jesus, and Socrates—but together they form the eternal community of souls.

I remember attending the Creative Commons launch party. It lacked the excitement and soul of an REM concert, or an Aerosmith concert, or a Kid Rock concert, or the movie 300, or a performance of Shakespeare' Hamlet, or Dante's Inferno. So, I wondered to myself, why should Larry Lessig have anything to do with the rights of content creators? Does not our United States Constitution serve the artists, authors, and inventors perfectly well by stipulating that they have full rights to their creations? The technology exists for DRM. The technology exists for a marketplace. The technology exists for various assorted DRM devices and players. So why not combine these technologies in a manner that best serves the creator, placing the artist firmly in the driver's seat, letting them define their rights, choosing from a complete spectrum, and letting all the commoditized device makers, aggregators, search engines, DRM providers, and others compete for the right to copy, use, distribute, spider, search, and list the creator's content? This is nothing more than simple common sense, and as killing common sense is how the three year law degree retains its massive value, by selling the right to transfer wealth via twistings and contortions of the sprit of the law via the postmodern ironic “letter” of the law, lawyers/mbas/Wall Street hypesters will send forth their very best to oppose this innovation, engaging in ad hominem attacks and other preferred methods of rising hipsters mimicking their declining professors from the seventies. We may forgive them, but will the rising generation seeking an exalted cultural and spiritual renaissance?

The technology is there. The Constitution is there. But all the mysticism and doublespeak is standing in its way. The only thing that is missing is taking it to the artists and musicians.

The following article, from Reuters, talks about the winners and losers in the Apple, EMI, DRM-free deal:

http://www.reuters.com/article/reviewsNews/idUSN0819458620070409?pageNumber=1

“WINNERS: Consumers. People who actually pay for digital music finally are free to playback purchased tracks wherever they want, however they want. And they're getting better audio quality to boot. But improved usage rights and sound performance don't come for free: EMI is charging a higher wholesale rate for DRM-free tracks, a cost that is being passed on to the customer. iTunes will charge $1.29 for DRM-free downloads.”

Well, consumers might be winners in the short-term, as Lessig and his freeloaders, aggregators, and billionaire technocrats cheer with the end of technology supporting the artist's constitutional and technological rights, but over time, the consumer and the culture will lose if artist's rights are neglected, scoffed at, and scorned all for the sake of Lessig et als short-term profits. But it is not in the booomer's nature to see beyond anyone else but their own bloated egoes which blot out the sun of the Great Books and Classics. They had the works razed upon the campuses so that they could raise a generation to become servants to their bottom line—a generation that shall never know families, love, honor, children, and the beauty of the home that Odysseus so longs for in the Odyssey—all for a few dollars more for A Prominent Pomo-Hipster Dot Com CEO's and Larry Lessig's coffers—all for a few more self-congratulatory pats on the back from one-another, as they head off into their sixties and seventies, having never moved beyond the sixties and seventies. Mark my word—the rising generation shall have a DRM system that serves the art of the renaissance-art that will be worth protecting-art that will be worth purchasing—and art that will be worth paying the artist for. Sacred art. True art. Somewhere far beyond American Idol and Reality TV, plotless, chararacterless novels bolstered by Dave Eggers' anonymous reviews echoing Henry Blodgets devious, deceitful, and pomo-hipster “ironic” reviews which had him barred from Wall Street for life. But where Blodget was only stealing our money, Eggers et al have been stealing our culture. The Reuters story

http://www.reuters.com/article/reviewsNews/idUSN0819458620070409?pageNumber=1

goes on to say, “LOSERS . . . : Publishers. Songwriters and publishers are dragged into a DRM-free environment with little to no say in the matter. EMI chairman Eric Nicoli wins points in the short run for progressive thinking on DRM by making the first move to break the interoperability log jam. But the company is taking big risks on its long-term digital profitability and stock price. If the move does not increase digital consumption, the results could be disastrous. EMI execs are adamant they are making the right move . . . This is about creating more opportunity in commercialized music by providing the right product to people who are prepared to pay for it,” says Barney Wragg, a Universal Music veteran who took over as London-based head of EMI's worldwide digital operations last year. “We think it's going to significantly increase the size of the market.”

It remains a complete mystery how a system that hurts the artists can help the consumers who consume the art that the artists create, but then one realizes that we now live in an Orwellian World as the pomo-hipster boomer's destruction, deconstruction, and devastation is forced upon all. The loss of artist's rights enhances art. War is peace. Freedom is slavery. Steven Jobs is cool. A Prominent Hipster Author, who runs one of the least-profitable porn sites/Hollywood d-list sites ever created, is a writer of great and vast renown.

In order to perpetuate the myth that socialists create great wealth, the innovative individual must routinely be pilloried, kicked around, and destroyed, in the same way that Odysseus is kicked around and put down by all the beggars and socialist suitors, living off his estate, as he rolls back into town. As artists and innovators and entrepreneurs are the paragon of individuals, their rights are the first to go, so as to make use for the middling mba/lawyer class who consider it great art to come up with marketing campaigns for their degree programs lacking the Great Books and Classics, mutual funds lacking honor, and Reality TV shows lacking plot, Character, Story, and Art. Useful idiots will always outnumber the indie innovator and creator, so tyrants wisely seek to surround themselves with useful idiots with ambitions overshadowing their talents in much the same way the gimp Spartan was given women and riches by Xerxes in 300, in return for his betrayal of King Leonidas and the true warrior Spartans serving their people and dying for their country. “I am Kind,” Xerxes says, “Where King Leonidas asked that you stand, I only require that you kneel.”

There is a Creator mentioned in The Declaration of Independence, in the following early sentence, “We hold these truths to be self-evident, that all men are created equal, that they are endowed by their Creator with certain unalienable Rights, that among these are Life, Liberty and the pursuit of Happiness.” In the spirit of this sentence, and in humble observance of that very same Creator, the Dodge City DRM Marketplace/Search Engine seeks to empower all creators with optimized compensation, distribution, and protection for their content. And what's good for the indie creator will be good for the giant studios. We all use the same electricity, fill up at the same gas stations, and use the same internet. There also ought be equal access to DRM for all, and there will be, via the present invention. “A new age has begun, an age of freedom. And all will know that 300 Spartans gave their last breath to defend it,” as the Spartan King Leonidas says in the movie 300.

Open Source is a great and wonderful entity, and it too relies upon Copyright Law. The indie artists rights are a great and wonderful thing, and they too rely on Copyright Law. The spirit of this invention, as well as all 45 Revolver inventions, is to empower the artist and innovator with an optimum blend of rights management tools—too match the technology that exists and is yet to come with the spirit of the Constitution and Natural Law that stipulates all artists, innovators, and inventors ought be able to protect and profit from their creations.

The present invention will provide tools of vast use to artists, creators, and entrepreneurs on their Hero's Journeys, where they answer the call to adventure to build a renaissance. Luke Skywalker had his light saber, Neo had his martial arts, The Man With no Name had his 45 Revolver, and so too will tomorrow's creators have their Dodge City DRM Marketplace/Search Engine. As Odysseus says during the slaying of the suitors, while sparing a good soul, “Courage: my son has dug you out and saved you. Take it to heart, and pass the word along: fair dealings brings more profit in the end.”—Book XXII, The Odyssey. It is easy to see why they have expelled the Great Books and Classics in the contemporary college curriculums, so that they might further their short-term profiteering in the decline of government, academia, and culture.

There's a showdown coming, wherein the artists and creators—the Atlases and creators of wealth—will be afforded better opportunities to protect and profit from their creations. The present invention cuts out the marketing/mba/lawyer middlemen tansd suitors to Penelope, in the same way that the Vanguard mutual fund cut out the hoaxters and pranksters who claim that they can beat the market, even though none but one can string the bow. In Sergio Leone's Fistful of Dollars, The Man With No Name states at the showdown at the end, “When a man with 0.45 meets a man with a rifle, you said, the man with a pistol's a dead man. Let's see if that's true. Go ahead, load up and shoot.” The movie broke Clint Eastwood as an international star, and it was shot entirely in Italy for under $200,000. It was based on a Japanese movie called Yojimbo, set in the American West, Eastwood was the only English-speaking actor, and the plot is similar to that of the Odyssey and the stories in the Old Testament, where Odysseus, Zeus, and God thunder on down their just judgments as the arrogant outlaws—those who oppose the sacred including Truth, Beauty, Honor, and Family, are dispatched into Dante's Inferno. And so it is that digital rights management is a universal right based on immortal precepts and higher forms. This invention by proposing a novel DRM marketplace and novel DRM search engine, as well as other innovations, seeks to deliver justice to the artists, authors, and creators—to the Atlases and true risk takers who ought get the just rewards of their risks and labors—of their blood, sweat, and tears, so that they might be able to make their passions their professions.

Socialism and communism generally walk hand-in-hand with immorality, whether they lead it or are lead by it, and such systems seek to drag heaven on down with them, as Herman Melville describes in the closing chapter of Moby Dick, “But as the last whelmings intermixingly poured themselves over the sunken head of the Indian at the mainmast, leaving a few inches of the erect spar yet visible, together with long streaming yards of the flag, which calmly undulated, with ironical coincidings, over the destroying billows they almost touched;—at that instant, a red arm and a hammer hovered backwardly uplifted in the open air, in the act of nailing the flag faster and yet faster to the subsiding spar. A sky-hawk that tauntingly had followed the main-truck downwards from its natural home among the stars, pecking at the flag, and incommoding Tashtego there; this bird now chanced to intercept its broad fluttering wing between the hammer and the wood; and simultaneously feeling that etherial thrill, the submerged savage beneath, in his death-gasp, kept his hammer frozen there; and so the bird of heaven, with archangelic shrieks, and his imperial beak thrust upwards, and his whole captive form folded in the flag of Ahab, went down with his ship, which, like Satan, would not sink to hell till she had dragged a living part of heaven along with her, and helmeted herself with it.”

Mob-driven systems are often lead by fools who do not miss the digital rights management that higher, enduring art requires, as they do not miss the higher art. As Hamlet said, “He's for a jig or a tale of bawdry, or he sleeps.”

The following quotes, coming from banned, deconstructed, and forgotten works—from books and movies considered “uncool” by the dominant snarky-snark bloggerati, further characterize the spirit of the present invention:

“Ecce deus fortior me, qui veniens dominabitur michi.”—Dante

“I shall tell you of William Wallace. Historians from England will say I am a liar, but history is written by those who have hanged heroes.”—Braveheart, written by Randall Wallace “A hero is someone who has given his or her life to something bigger than oneself.”—Joseph Campbell

“The most beautiful thing we can experience is the mysterious. It is the source of all true art and all science. He to whom this emotion is a stranger, who can no longer pause to wonder and stand rapt in awe, is as good as dead: his eyes are closed.”—Albert Einstein

“Our problem today is that we have allowed the internal to become lost in the external . . . So much of modern life can be summarized in that arresting dictum of the poet Thoreau: ‘Improved means to an unimproved end.”—Martin Luther King, Jr., Nobel Lecture, Dec. 11, 1964

“I have never thought of writing for reputation and honor. What I have in my heart must come out; that is the reason why I compose.”—Ludwig Van Beethoven

“Dream until your dreams come true,”—Aerosmith

“No poet, no artist of any art, has his complete meaning alone. His significance, his appreciation is the appreciation of his relation to the dead poets and artists. You cannot value him alone; you must set him, for contrast and comparison, among the dead.”—T. S. Eliot. One reason why so much art is so awful these days is that the educational system has been relentlessly deconstructing and disparaging the epic myths and epic stories that have forever reminded us of the better angels of our nature, and keep the family together, and Wall Street workers honest. “When storytelling declines,” Aristotle wrote, “the result is decadence.”

“True art is characterized by an irresistible urge in the creative artist.”—Albert Einstein

“Faith is to believe what you do not see; the reward of this faith is to see what you believe.”—Saint Augustine

“Great art can communicate before it is understood.”—T. S. Eliot

“Beauty is indeed a good gift of God; but that the good may not think it a great good, God dispenses it even to the wicked.”—Saint Augustine

“And when my mind is free, You know a melody can move me, And when I'm feelin' blue, The guitar's comin' through to soothe me, Thanks for the joy that you've given me, I want you to know I believe in your song, Rhythm and rhyme and harmony, You help me along makin' me strong.”—Dobie Gray/Uncle Kracker

“What each must seek in his life never was on land or sea. It is something out of his own unique potentiality for experience, something that never has been and never could have been experienced by anyone else.”—Joseph Campbell

“The first European films that come to mind as mock Action-Adventure movies are the spaghetti westerns produced by director Sergio Leone in the 1960s and 1970s. These mannered art collages of American Western paraphernalia vaulted Clint Eastwood, a barley known TV and B movie actor, to international superstardom due to his flinty-eyed, clenched-jaw portrayal of “the man with no name.” Indeed, like the Bible's Old Testament God, Eastwood's anonymous deity materializes from the heavens; he doth strike the wicked dead with his terrible swift six-shooter, and vanishes as tight-lipped as he arrives. Eastwood's resolute malice, though, is far from the amoral character that some have described. He is, instead, a hirsute, vengeful deity come to visit terrible retribution on the confounded entanglements of mankind, and thus to bring the world to order. These spaghetti western films are essentially very Catholic tableaus of the stability imposed on Pagan Europe by the might of the Church.”—Writing The Action Adventure Film, The Moment of Truth, Chapter 3, by Neil D. Hicks.

### BACKGROUND & PRIOR ART

The ideas, concepts, and various innovations underlying the present invention—The Dodge City DRM Marketplace/Search Engine—will usher in a new era of the internet that supports Creator's Capitalism, instead of the current Aggregators' Capitalism, which employs lawyers, activists, and hipster MBA marketing experts to trample upon the Constitutional rights of indie artists and creators. The Dodge City DRM Marketplace/Search Engine will foster a renaissance in entrepreneurship, wherein the indie creator—the fount of vast wealth throughout the internet and beyond—is afforded new opportunities to protect and profit from their content. Furthermore, entrepreneurs serving the interests of the author and creator will be afforded opportunities to create new business models based upon the novel ideas underlying Dodge City DRM Marketplace/Search Engine. Abraham Lincoln wrote, “to secure to each laborer the whole product of his labor, or as nearly as possible, is a most worthy object of any good government.” This is the moral premise of the ideas and innovations underlying the present invention and all manifestations of the Dodge City DRM Marketplace/Search Engine, which offers novel and superior methods to protecting and profiting from ones content.

The rising generation is longing for a renaissance wherein classical ideals are performed in the contemporary context, and the Dodge City DRM Marketplace/Search Engine will allow those who build the renaissance to protect and profit from their creations, thereby providing artist and authors with incentive to create and share, sell, and distribute the wealth of their creations. There exist thousands of places for one to share, distribute, and sell one's content, but none of the prior art offers the breadth, nor depth of options described herein, which result in a new class of Dodge City DRM Marketplace/Search Engine applications that put the creator at the center of the internet, empowering them with a full suite of rights management and distribution tools with numerous options, thusly commoditizing the myriad of companies that have hitherto commoditized the creator.

“The prudent, penniless beginner in the world,” Lincoln wrote, “labors for wages awhile, saves a surplus with which to buy tools or land for himself, then labors on his own account for awhile, and at length hires another new beginner to help him. This is the just and generous and prosperous system which opens the way to all, gives hope to all, and consequent energy and progress and improvement of condition to all.” The Dodge City DRM Marketplace/Search Engine—an embodiment of the present invention—supports the American Dream as described by Lincoln, and it provides a novel and superior manner for creators to protect and profit from their content.

When Lincoln addressed Congress in 1861, he said, “On the side of the Union is a struggle for maintaining in the world that form and substance of government whose leading object is to elevate the condition of men to lift artificial weights from all shoulders; to clear the paths of laudable pursuits for all; to afford all an unfettered start, and a fair chance in the race of life.” That is the object of The Dodge City DRM Marketplace/Search Engine—to provide creators with a superior means of protecting and profiting from their content.

Every true artist begins as an indie artist, develops as an indie artist, and passes on as an indie artist. Even though corporate and academic bureaucracies regularly try to manufacture non-indie artists, such pseudo-artists work is short-lived, for only the true indie artist can string eternity's bow. Truth comes from within the individual—not from the bureaucracy. Thus the Dodge City DRM Marketplace/Search Engine, which empowers the indie artist, can lead to renaissances in content and culture.

The concepts behind the Dodge City DRM Marketplace/Search Engine are a product of multiple years of Dr. Elliot McGucken's research into intellectual property rights and both open source and proprietary methods for content and rights management and social networking. Dr. McGucken has written several books including the novel Autumn Rangers, and his dissertation on an artificial retina for the blind, entitled, “Multiple unit artificial retina chipset to aid the visually impaired and enhanced holed-emitter CMOS phototransistors,” was awarded a Merrill Lynch Innovations award in an international competition paying homage to fundamental research with commercial applications. Dr. McGucken has spoken at the Harvard Law School's Berkman Center for Internet and Society regarding his Open Source DRM project Authena.org at the oscom.org conference—the present invention offers an improvement over the IP disclosed throughout the Authena.org project. Dr. McGucken's 22surf.org Open Source business plan has been downloaded and read by thousands, and it was accepted into the Zurich OSCOM: http://sourceforge.net/projects/authena22surf. The present invention is an improvement upon Dr. McGucken's prior art. Dr. McGucken appeared on a panel aside John Whealan-Deputy General Counsel for Intellectual Property Law & Solicitor USPTO, and Marybeth Peters-U.S. Register of Copyrights, where he spoke about the fundamental Constitutional concepts underlying the present invention—a video of this panel may be viewed at: http://www.unctv.org/ipcip/: UNC Symposium on Intellectual Property, Creativity, and the Innovation Process. The Wall Street Journal wrote, “Elliot McGucken decided to straddle the two worlds. After he earned a doctoral degree in physics/electrical engineering, Dr. McGucken considered himself “fortunate” to get a teaching job at Davidson College in Davidson, N.C., and to continue his engineering research.

But then, last year, he won the Innovation Grants Competition sponsored by Merrill Lynch Forum, the virtual think tank of the financial-services company. The contest, now in its second year, gives out $150,000 in prizes for Ph.D.s, and their institutions, who find commercial applications for their research . . . After winning the contest, he got to tour the New York Stock Exchange. Dr. McGucken caught the entrepreneurial bug. Eventually, he launched jollyroger.com, an Internet company devoted to his longtime passions: writing and classical literature.”

Dr. McGucken devised and is currently teaching a course, Artistic Entrepreneurship & Technology: artsentrepreneurship.com, which would be well-served by the underlying concepts of the present invention. Indeed, a common problem of so many rising artists is securing and monetizing their creations-protecting and profiting from their content—form their blood, sweat, and tears—from their tireless labors of love. This present invention assists rising creators by providing novel methods by which they can protect and profit from their creations. The Dodge City DRM Marketplace/Search Engine, by focusing on property rights, and offering the creator the ability to define their rights, select from different digital rights management options, watermarking options, and thumbnailing options, will not only helps the indie creator in a vast manner, but will also foster and father an abundance of further innovation and invention, and become best friend to authors, artists, inventors, and entrepreneurs alike.

Thousands of rising artists have little or no means to protect their content before releasing it on the web, where digital content may be copied ad in finitum. A purpose of this invention is to offer artists the ability to use DRM in protecting their content, and not any DRM but the best DRM—the DRM system which beats out the other systems to provide the optimum distribution. The present invention allows authors, artists, and creators to “flip the script”—to commoditize the DRM companies and Web 2.0 aggregators which have for so long tried to commoditize them.

Vast media companies including Myspace, Flickr, and hundreds of other Web 2.0 companies have business models that rely upon freely using, copying, and distributing others' content, without ever compensating the creator. Creators are told that there is little or no value in their creation as it stands alone, but only within the context of the greater group. The media and Wall Street have been successful in convincing creators to work for free in building out web 1.0 and web 2.0, just as traditional record companies have oft been successful in convincing artists to work for free in building traditional record labels. The present invention, by combining existing technologies in novel ways that counter expert opinion, provides a superior means for artists to protect and profit from their work, and for participants in social networks to profit from their participation.

### PRIOR ART AND FURTHER BACKGROUND

In many ways this present invention does for DRM and content what Priceline did for the travel industry. The artist names their terms and conditions—sets their price—and the various companies, hipsters, DRM providers, device makers, and others compete to meet the artist's conditions, so that they might gain the privilege of serving their content.

The Nobel Laureate Economist Friedrich Hayek offers great insight into the quandary of Web 2.0 companies, which millions work for without profiting. Hayek states, “Perhaps the fact that we have seen millions voting themselves into complete dependence on a tyrant has made our generation understand that to choose one's government is not necessarily to secure freedom.” Hayek also states that, “If we wish to preserve a free society, it is essential that we recognize that the desirability of a particular object is not sufficient justification for the use of coercion.” This means that even though Web 2.0 companies want to bolster their bottom lines by claiming rights to everyone's creations and content, that doesn't give Larry Lessig et al the right to deconstruct the United States Constitution. Hayek also states, “There is, in a competitive society, nobody who can exercise even a fraction of the power which a socialist planning board would possess,” thus signifying that the rights of creators ought to be left up to the creators, and not handed over to some faculty board, nor committee of postmodern lawyers, nor Web 2.0 company, nor any other socialistic nor feudalistic entity-no matter what it has changed its name to, nor pretense it hides behind, to escape detection.

The famous economist, and Nobel Laureate, Milton Friedman stated, “The greatest advances of civilization, whether in architecture or painting, in science and literature, in industry or agriculture, have never come from centralized government.” So it is that the indie authors and artists ought be given the technology that affords them their Constitutional Rights.

Friedman also says, “So the question is, do corporate executives, provided they stay within the law, have responsibilities in their business activities other than to make as much money for their stockholders as possible? And my answer to that is, no they do not.” Note that he stipulates “provided they stay with the law.” The law, as stated in the Constitution, is that artists and authors have the right to protect and profit from their creations. Friedman states, “Underlying most arguments against the free market is a lack of belief in freedom itself.” So it is that the activists and lawyers do not believe in freedom fro the artist, as they do not believe in freedom themselves. They do not understand the act of creation and entrepreneurship. They see economics as a zero-sum game, to which Friedman says, “Most economic fallacies derive from the tendency to assume that there is a fixed pie, that one party can gain only at the expense of another.” The Dodge City DRM Marketplace/Search Engine believes in the artists' rights—in the artists' freedom, and the software exists as a method and means for them to profit via the exercising of those rights.

Finally, Friedman says this, “Nobody spends somebody else's money as carefully as he spends his own. Nobody uses somebody else's resources as carefully as he uses his own. So if you want efficiency and effectiveness, if you want knowledge to be properly utilized, you have to do it through the means of private property.” The Dodge City DRM Marketplace/Search Engine believes in the artists' private property—in the artists' freedom—and the software exists as a method and means for them to profit via the exercising of those rights. The prior art, including Web 2.0 companies and Larry Lessig's philosophies and ventures, do not respect the artist's private property.

Sites and companies such as CD Baby are great for the indie artist. But, CD Baby's site states, “No Microsoft products were used in the creation of this website.” This means that musicians are unable to protect, encrypt, or offer their works using Windows DRM directly through the CD Baby site. The Dodge City DRM Marketplace/Search Engine, on the other hand, would allow musicians access to Windows DRM, so that they could protect and profit from their content.

At the Snocap.com site, it says, “Q: How does SNOCAP protect content? Which DRM are you using? A: Rights holders choose whether they want to sell their content in MP3 format, or using Microsoft's Windows Media DRM technology.” So it is that Snocap only offers Windows DRM, and only through snocap, thusly limiting the devices media can be played on, while keeping the price of DRM—a commodity—artificially inflated, so as to benefit the non-creators at Snocap, such as Shawn Fanning. The present invention offers a multitude of DRM and DRM packages from different DRM. Snocap charges the unsigned artist a whopping $0.45/download. Consider a 99 cent song—the artist writes, performs, records, mixes, and masters the song, and snocap automatically gets about half the profits when the song is sold, for doing just about nothing. They did not create the internet, nor DRM, nor the protocols that protect and distribute content, nor the ecommerce engines that handle transactions. The Dodge City DRM Marketplace/Search Engine places all this in perspective, exerting downward pressure on the price of DRM and distribution by offering indie artists a multitude of DRM formats, as well as DRM providers, from which to choose from.

Snocap is very much just another Web 2.0 company. The Dodge City DRM Marketplace/Search Engine will allow users to upload to snocap, but it wall also offer other, superior options. The Web 2.0 company menatility is that they want full control of your content. When you upload content into Snocap, or A Prominet Content Aggregator, or Youtube, they don't want it going anywhere else. Youtube and others change the format and never give you access to the pristine original. The Dodge City DRM Marketplace/Search Engine will always give the user access to the pristine original, as well as interfaces and information that aid in the distribution of the creator's content. Simple web services can register accounts in multiple content companies that aggregate content, and upload, manage, publicize, promote, and profit from the content throughout all of them. The Dodge City DRM Marketplace/Search Engine would be a vast time saver, allowing the user to upload the pristine original once to a secure server, and syndicate watermarked, or degraded versions, on out to hundreds of other portals who make a living by commoditizing hundreds of artists.

The Rapper Fifty Cent (50 Cent) states in his book From Pieces to Weight, “Get Rich or Die Tryin': When I say that, everyone focuses on the negative aspects: death, desperation, depression. But you know what? Everybody, from the guy who gets up to punch a clock every day to the kid standing on the corner, is trying to get rich before they die. The guy punching the clock is probably going to night school or has a hustle on the side or some dream he's working on. Why? To get rich. The kid who picks up a bag of drugs to sell is the same way. He's out there in the entrepreneurial spirit, hustling, trying to get rich. That kid just doesn't want to work for anybody—he wants to work for himself. It's just that he has the wrong direction at that point in his life. All at the same time, he's trying to get rich, just like that guy punching a clock, the old man driving a cab, the kid going to college to get his degree, the girl waiting tables at the restaurant. It's all about back to getting rich—or trying to do so. This is nothing new. You can find pretty much the same sentiments in all philosophies—Samurai codes and sh-- like that. If Confucius says it, it's wisdom. But when 50 Cent says it, he's being negative.”

50 Cent ought to be afforded an application that empowers him with greater versatility to distribute his music. He ought be given the opportunity to upload his songs, set a price, and then be fully compensated. This is because DRM is based on algorithms, which are free as the wind. Instead, when 50 Cent sells a 99 cent song on iTunes, which can only be downloaded by an iPod, he gets about 10 cents. The Dodge City DRM Marketplace/Search Engine, by offering the creator different DRM formats, would make DRM providers compete against one-another, driving the price of DRM down, until it reached its natural level—0.

In the same way that many modern economists and lawyers are ignoring 50 Cent's rights and the profound words of Nobel Prize winners such as Hayek and Friedman, as well as the profound words of Adam Smith, modern physicists are ignoring Einstein and Feynman, so as to create little tyrannies of tax-subsidized foolishness, tenure, and fraud that has become so fashionable these days, wherein the primary objective is to deny that the truth exists, replace it all with personal, political propaganda, and support it with tax, tuition, snark, hype, and lies. So it that you get what we have here—which is the way they want it—well, they get it. Massive corporations profit from the labor and creativity of artists, who are denied their natural rights to the technology, because the lack of innovation in the realm of DRM, due to academia's opposition to the creative individual, and loyalty to the professional bureaucrat. Well, Dr. E is throwing the first academic conference with a panel devoted to DRM—the Hero's Journey Entrepreneurship Festival.

The Dodge City DRM Marketplace/Search Engine seeks to serve Eminem and Fifty Cent. In the December 2006 of Vibe Magazine, Eminem & Fifty Cent talk about the industry in an article entitled Family Matters. Eminem states, “I see a lot of guys on tour, I'm not going to say any names, but on tour, they're touring just to make money. Because the way the record industry is right now, it's tough to sell records. The internet is killing us. At this point of my career, I'd be scared to drop an album for the smell of failure. Do we know how many fans we have in Soundscan says a certain number, but two million people downloaded it? Who knows if I put out another album what I'd sell, who knows what 50 would sell?”

Vibe Magazine responds, “Are you worried that if the record business changes for the worse, you may have a domino effect with other businesses?”

Fifty Cent says “What we have the control of is the actual quality of the actual material. Now, if you're questioning if we're going to make the best music, I think generally if you ask anybody, they're going to tell you we're going to make the best rap records. so having the best rap records tied to a brand of clothing makes the clothing cool. The kid who enjoys a 50 Cent or Eminem project is not gonna stop enjoying the projects, but they may stop purchasing the CD. They may start stealing our music from the Internet. But they won't stop being fans of it.” Vibe Magazine: “And you can't download shirt.”

50 Cent: “Right”

Note 50 Cent says, “They may start stealing our music from the internet.”

So it is that the prior and current art does not afford 50 Cent nor Eminem, any other indie musician, the ability to protect and profit from their content as they ought to. The Dodge City DRM Marketplace/Search Engine provides a new and improved ability to protect and profit from one's content.

50 Cent calls it “stealing,” while Larry Lessig et al would call it “sharing,” as Lessig et al believe that the Feudal Lords of Web 2.0 companies and lawyers ought get paid for the artist's creativity and labor. 50 Cent often quotes the Bible and mentions God on his albums, so he, Like Mark Twain, has a better sense of “Thou shall not steal.” Lessig, unlike the Founding Fathers who wrote the Constitution he has made fortune off of deconstructing, never mentions the Bible nor God, as if our rights are not Natural Property, but as if they are granted and taken away by lawyers. While such a philosophy enriches lawyers in the postmodern marketplace for justice, it degrades society, and it eventually loses out to Justice.

Like Fifty Cent, Mark Twain also prefers the Bible and Constitution over the opinions of postmodern lawyers when it comes to sources regarding copyrights. In 1906 Twain addressed congress concerning copyrights and intellectual property: “I am aware that copyright must have a limit, because that is required by the Constitution of the United States, which sets aside the earlier Constitution, which we call the Decalogue. The Decalogue says you shall not take away from any man his profit. I don't like to be obliged to use the harsh term. What the Decalogue really says is, “Thou shalt not steal,” but I am trying to use more polite language.” Twain also noted, “They always talk handsomely about the literature of the land . . . And in the midst of their enthusiasm they turn around and do what they can to discourage it.” And this, “Whenever a copyright law is to be made or altered, then the idiots assemble.”

Lessig offers two solutions to stop the theft and illegal downloading of music—neither of which involves the logical solution—DRM. Lessig would have Fifty Cent release his song on a creative commons license so that his friends at Web 2.0 and other internet companies could profit from it, but not Fifty. Or he would pass a law so that only activists, who graduated from prestigious law schools, could release rap albums, thusly eradicating piracy for once and for all, by removing all incentive to download and copy music. This may also be achieved by launching MFA programs for hiphop. Just as MFA programs have institutionalized literature and killed Hollywood, to the point where nobody reads and less and less people are seeing movies, an MFA program in hiphop would halt piracy. For the greater good of the state and corporation, the indie artist and independent thinker must die.

Ideas have consequences, and so it is that upon the early web which was created in an era of uncreative, leaching leftists and postmodernists dominating academia, publishing, and entertainment, DRM just isn't allowed to be, as the rights of artists and creators are generally detested by a handful of vocal programmers, techies, and their lawyer heroes who give us Simon Cowell instead of Johnny Cash. Larry Lessig seems to be a living embodiment of a character from an Ayn Rand novel, as he encourages creators to turn over their copyrights voluntarily. He vehemently opposes DRM, which is ironic, because the Constitution recognizes that the creator has the right to do what they want with their creations, including using DRM to protect and profit from it, and the proper role of lawyers is to serve the people and the Constitution—not just the Feudal Lords of Web 2.0 companies and Aggregator Capitalists. The United States constitution recognizes the right of the artist to protect and profit from their content. And it also gives them the right to bear arms.

In Atlas Shrugged, Ayn Rand writes, “‘Precisely,’ said Dr. Ferris. ‘It's extremely important to get those patents turned over to us voluntarily. Even if we had a law permitting outright nationalization, it would be much better to get them as a gift. We want to leave the people with the illusion that they're still preserving their private property rights. And most of them will play along. They'll sign the Gift Certificates. Just raise a lot of noise about its being a patriotic duty and that anyone who refuses is a prince of greed, and they'll sign. Point three. All patents and copyrights, pertaining to any devices, inventions, formulas, and processes and works of any nature whatsoever, shall be turned over to the nation as a patriotic emergency gift by means of Gift Certificates to be signed voluntarily by the owners of all such patents and copyrights. The Unification Board shall then license the use of such patents and copyrights to all applicants, equally and without discrimination, for the purpose of eliminating monopolistic practices, discarding obsolete products, and making the best available to the whole nation. No trademarks, brand names or copyrighted titles shall be used. Every formerly patented product shall be known by a new name and sold by all manufacturers under the same name, such name to be selected by the Unification Board. All private trademarks and brand names are hereby abolished.’”

The Dodge City DRM Marketplace/Search Engine holds the rights of Artists as sacred entities, and it makes search engines and DRM providers, device makers, and content hosting companies bid for the right to distribute their content. The Constitution does not grant rights, so much as it Recognizes Natural rights. For what is not granted, but inherent, can never be taken away. The Dodge City DRM Marketplace/Search Engine recognizes the indie artist and creator's natural rights to protect and profit from their content, and it expresses the ideal via its novel and unobvious combination of technologies. The present invention provides a free market for DRM providers/device makers to compete for the right to distribute the works of authors and artists.

### PRIOR ART AND SUMMARY OF THE INVENTION

“I'm going to pick a fight,” said William Wallace in the movie Braveheart. And with the Dodge City DRM Marketplace/Search Engine, the indie artist can too. The Dodge City DRM Marketplace/Search Engine allows the indie artist to define their rights, and then upload and protect their content with a few clicks of a mouse; and then various companies bid for the right to distribute the artist's content, and/or the right to spider the artist's content.

The Dodge City DRM Marketplace/Search Engine allows the indie artist to sit down at the high stakes table and call the bluff. The internet exists. DRM exists. End devices exist. The Dodge City DRM Marketplace/Search Engine allows indie artists to upload their media, define their rights, set a price, choose from different DRM providers, packagers, marketplaces, and sell their content. When a DRM provider or marketplace such as iTunes takes too big of a cut, or doesn't secure the content well enough. The creator can elect to not upload their content to that marketplace, but instead choose others. So it is that over time distribution will improve, as more and more devices seek to serve the artist, as opposed to traditional record labels, corporate behemoths, and academic fads wherein the indie artist has no right. And the great thing about this is that every true artist is an indie artist, so what works for 50 Cent will work for the garage band down the street—they'll all get to protect and profit from their content as never before.

With the Dodge City DRM Marketplace/Search Engine, the indie artist can call all the bluffs—Larry Lessig's bluff. Tim Oreilly's Web 2.0™ bluff, which disses the artist's rights, while Tim et al trademark Web 2.0. The indie artist has got to call Cory Doctorow's bluff. Bill Gates' bluff. Larry, Eric, and Sergey's bluff. Rupert Murdoch's bluff. The RIAA's bluff. Sony's bluff. Yahoo's bluff—even yahoo, which is located more and more in Hollywood—came out against DRM. For it seems that everyone's bluffing except for maybe Mark Cuban (blogmaverick.com).

The hard part in the act of creation is the act of creation. The internet, DRM protocols, and end devices are already there. They are commodities. The art is not. The art—be it a photograph, painting, song, book, video, film, documentary, or some hybrid combination—is unique. All that's needed are systems, methods, and innovations that treat the technological commodities as commodities, and the creation as unique, which is the way it is. Such a system reverses the Web 2.0 philosophy that commoditizes the artist and strips them of their natural rights, resulting in the “commodity reversal.”

### PRIOR ART & TOWARDS THE DODGE CITY DRM MARKETPLACE

Voyage on over to Mark Cuban's awesome blog where Mark says at http://www.blogmaverick.com/2006/03/19/digital-rights-management—the-coming-collateral-damage/: “Property owners have every right to do whatever they think is necessary to protect their property. Homeowners can build walls and add security. Content owners can add copy protection schemes to their digital content . . . Unfortunately for content owners, digital rights/copy protection schemes have always proven crackable. No matter how smart the good guys think their programmers are, the bad guys have programmers that are just as smart. More importantly, the good guys have to build the perfect protection scheme, impenatrable by any of infinite number of possible attacks. The bad guys only have to find out where the good guys screwed up. It's a lot easier to be the bad guys and crack the copy protection. Which is exactly why every effort to fully protect digital content has failed.”

Mark Cuban also points out that as DRM evolves to keep up, the file we just purchased yesterday might not work on today's device. So how do we solve this problem? How do we protect the rights of the creators and consumers?

The 45 Revolver makes it beyond this impasse by placing digital rights management in the creators' hands. And not just any digital rights system. But every digital rights management system. The content is the unique creation in this story—the DRM systems are the commodities. And the 45 revolver is just that—a system that allows the content to be fired out in many different formats, thusly empowering the lone creator as never before.

Because the 45 Revolver will always maintain a pristine original, it will always be able to serve the content in any DRM format. DRM technologies are a dime a dozen. But there is only one Fifty Cent. There is only one Matrix. There is only one Star Wars, and George Lucas says, “Just because the market has shifted so dramatically. A lot of people are getting very worried about piracy. That has really eaten dramatically into the sales. It really just came down to, there may not be a market when I wanted to bring it out, which was like, three years from now. So rather than just sit by and watch the whole thing fall apart, better to bring it out early and get it over with.”

Why not offer George Lucas a method, system, and means to protect and profit from his content? Many prominent lawyers and activists argue that if we allow DRM, all of culture will disappear the moment the DRM format changes, and that DRM will thus foster the loss culture and will result in the world returning to the stone ages. The 45 Revolver, by maintaining a pristine original, and then offering a full spectrum of DRM—both yesterday's, today's, and tomorrow's will ensure that the media is forever available, as well as available.

The 45 Revolver will afford the artist with Microsoft DRM, Sony DRM, Apple DRM, Open source DRM, and any other DRM schema that is made available to the application or creator. And the 45 Revolver will ensure that companies will want to share their DRM schemas, for DRM is nothing more than a mathematical algorithm, while the content created by the creators are the reason people use the internet. Nobody fires up their computer to download DRM. Competition between DRM providers will ensure that the price for DRM will trend downwards, as no company will wish to be left out of a software application that empowers artists as never before. The 45 Revolver will afford a marketplace in DRM, as well as superior search engines. Let's call it the DODGE CITY DRM MARKETPLACE.

### MORE PRIOR ART FAILING THE INDIE ARTISTS

The same corporate and academic bureaucracies that try to manufacture artists also oppose digital rights management for true artists. Rupert Murdoch runs both American Idol and Myspace. For in their eyes, there is no good nor bad, nor higher aesthetics, nor United States Constitution that's really worth thinking about, nor defending. There is only a postmodern marketplace wherein the elites have the right to exaggerate (lie), profit from other's content, pensions, and saving (steal), and pornify the world, breaking up the family, separating husband and wife, and parents and children, and giving everyone credit cards and encouraging them to kill the unproductive members of society—the innocent unborn—to raise the bottom line for the short term profit of the elites, at the long-term expense of society. As the famous exchange in Scent of a Woman has it, “Lt. Col. Frank Slade: Haven't you heard? CONSCIENCE is daihed. Charlie Simms: No, I haven't heard. Lt. Col. Frank Slade: Well, then, take the f---in' WAX outta your ears! GROW UP! It's f--k your buddy. Cheat on your wife. Call your mother on Mother's Day. Charlie, it's all sh--.” Lincoln is long gone along with all the great Lawyers schooled by the Great Books and the Bible instead of postmodern snarkiness, and with absolutely no leadership at the corporate and academic helms, no taste at the movie studios, no men capable of passing God's Great and Just Judgment, it's mob rule; and it's elite rule too—just as long as the mob and the elite oppose the classical ideals. And the wholesale destruction of the traditional family is justified by a marketplace that replaces epic story and mythology with porn, as the numeric value of the Dow says nothing about the death of the soul, and thus the economists, who killed religion when they labeled economics a science, wash their hands, as Pontius Pilate washed his. The Dodge City DRM Marketplace/Search Engine, by protecting and defending the property rights of those who will build the renaissance, by allowing them to make money independent of myspace, Larry Lessig, Reality TV, Hollywood Studios, Dave Eggers' and his fake amazon review methodology, and American Idol, and all the rest of the bread and circuses that have distracted us from the better angels of our nature, and pit us against one-another. The Dodge City DRM Marketplace/Search Engine will lead to unparalleled wealth creation—both monetary and spiritual.

In Capitalism, The Unknown Ideal, Ayn Rand writes, “Today, patents are the special target of the collectivists' attacks—directly and indirectly, through the proposed abolition of trademarks, brand names, etc. While the so-called “conservatives” look at those attacks indifferently or, at times, approvingly, the collectivists seem to realize that patents are the heart and core of intellectual property rights, and that once they are destroyed, the destruction of all other rights will follow automatically, as a brief postscript.” The ironic collectivists, such as Lessig et al, have figured out a better system—the common creators—the indie artists-shall have no rights to their creations, but only the elite aggregators who Larry hangs out with in Silicon Valley. The principles of the Dodge City DRM Marketplace/Search Engine blow the ironic pretense away, by providing a systems, methods, and means for creators and indie artists to protect and profit from their content.

In Capitalism, The Unknown Ideal, Ayn Rand writes, “The present state of our patent system is a nightmare. The inventors' rights are being infringed, eroded, chipped, gnawed, and violated in to many ways, under cover of so many non-objective statutes . . . Those who observe the spectacle of the progressive collapse of patents—the spectacle of mediocrity scrambling to cash-in on the achievements of genius—and who understand its implications, will understand why in the closing paragraphs of Chapter VII, Part II, of atlas Shrugged, one of the guiltiest men is the passenger who said: “Why should Rearden be the only one permitted to manufacture Rearden Metal?” The Dodge City DRM Marketplace/Search Engine will allow an artist to protect and profit from their content, so that they are the soul distributor. Who needs middlemen on the web?

But alas, Rand is not taught in business and law schools. Postmodern, spineless textbooks have replaced Shakespeare and the Bible, as Epic Mythology reminds us of the Truths in our eternal souls, and thus gets in the way of the creative accounting, doublespeak, hype, lies, deconstruction, and deceit, that are the primary skills taught to pomo-hipster MBA/JD/MFAs. Throughout college, grad school, and work, the honest creator is marginalized, castigated, and impugned, as the creative arts are professionalized by postmodern bureaucracies. Thus the characterless and non-creators excel, and rise to the top of the postmodern class, and the groupthinkers are sent to work at prestigious postmodern firms on Wall Street and Main Street, in Hollywood and the Heartland, to continue cashing in on the destruction of higher ideals, so as to build their fiefdoms.

The same, tired, postmodern gimmick is played out time and time again. Tenured mobs of elite physicists, bankers, MLA members, MFAs, lawyers, and MBAs deconstruct the classics, tell a thousand little lies with things like “blink don't think,” and “string theory,” and “the new economy,” transfer all the risk to he workers and creators and all the wealth to themselves as they play with pensions and cash in on the decline. Their common hallmark is splendid mediocrity overshadowed by avaricious ambition. Their common commitment is to short-term investing to enrich themselves at the expense of everyone else—their neighbors and their children—the preachers, teachers, and firemen—the indie artists and creators—and even the unborn. Their foolishness, along with the Renaissance that is to be, is the theme of Autumn Rangers, Jollyroger.com: Navigating an American Renaissance, The Tragedy of Drake Raft, this present invention, and all the rest of Dr. E's books.

On the back of each dollar it is printed “In God We Trust,” and those who think that Truth is not important; those who think that economics can be separated from art and literature—from a moral context—and yet signify something meaningful in the academy and beyond—those who think that the gold standard can be replaced with the porn standard without hell to pay, have another thing coming.

Ayn Rand writes, “Patents and copyrights are the legal implementation of the base of all property rights: a man's right to the product of his mind . . . By forbidding an unauthorized reproduction of the object, the law declares, in effect, that the physical labor of copying is not the source of the object's value, that the value is created by the originator of the idea and may not be used without his consent; thus the law establishes the property right of a mind to that which it has brought into existence.” The Dodge City DRM Marketplace/Search Engine helps the indie creator protect and profit from their natural property rights in a novel and superior manner, by offering a full spectrum of rights and rights management technologies to choose from. A consequence of this invention is that it will force the creators of Web 2.0 companies, digital rights management technologies, to more directly compete with one another so as to offer the creator better and better deals, and better and better ways to protect and profit from their content.

Just as the Priceline patents revolutionized the auction system by having the buyer name their price, and then letting the suppliers compete to match it, this present invention revolutionizes content distribution, by allowing the creator to define their rights and terms, and then letting all the web companies and digital rights management providers compete to meet the creators' needs. Those companies which offer the creator decent terms will win out. Those companies that do not will lose. Thus innovations to better serve the creator will resound far and wide with the inception of the Dodge City DRM Marketplace/Search Engine, as waves ripple forth when a rock is tossed into the still waters of a lake.

Warren Buffett states, “The business schools reward difficult complex behavior more than simple behavior, but simple behavior is more effective.” Complex and difficult behavior is favored by the postmodern elite as it allows them to obfuscate—to muddy their waters so as to appear deeper—as Nietzsche suggested, so as to provide cover as they plunder pensions, steal inventions, erode property rights, transfer all the risk to the working man and graduate student, and all the wealth to the postmodern elite—anyone who is so uncreative that instead of working for a living, they buy an MBA or JD or MFA, join the administrative intermediary class, make sure that Plato, Shakespeare, and the Bible—the proper context for the United States Constitution are banned, and claim eminent domain on the fruits of others' labors.

The Dodge City DRM Marketplace/Search Engine prefers Warren Buffett's just simplicity. The Dodge City DRM Marketplace/Search Engine offers a novel way to better protect and profit form one's content, which is not only unobvious to the experts, but which is and will be opposed by the experts. It has been helpful to me,” Buffett explained, “to have tens of thousands (students) turned out of business schools taught that it didn't do any good to think.” And too is the Dodge City DRM Marketplace/Search Engine capitalizing on all the MBA/JD denizens who have been trained not to think, who have been taught that marketing is superior to intrinsic meaning, and who sold their souls for the immoral right to erode and capitalize off of the creators' private property. The Dodge City DRM Marketplace/Search Engine I capitalizing on all the MBA/JD/MFAs who never read the constitution. The Dodge City DRM Marketplace/Search Engine gives the indie artist a method to defend themselves against the armies of lawyers and MBAs being sent forth by Lessig et al to complete the cultural and Constitutional destruction. The Dodge City DRM Marketplace/Search Engine empowers the indie artist to protect and profit from their innovations.

Because myspace—the world's largest social network—has little or no mechanism to protect one's property, Rupert Murdoch's business model by and large depends on teenage girls posing in their underwear. Myspace accomplishes many purposes, including the continued destruction of the traditional family so as to drive the economy in the short term. On myspace, far more girls are friends with Burger King than they are with their own fathers. In order to see more pictures of them in your underwear, Rupert Murdoch has set it up to that you too must join, and in the process you'll see hundreds of banner ads designed by snarky design students, hired by snarky MBAs, all of whom are united by their general dismissal of and hatred for the Great Books and Classics and all that gets in the way of the postmodern bottom line, just like their professors were, who wrote them letters of recommendation that got them jobs at Myspace.

Because The Dodge City DRM Marketplace/Search Engine provides artists and authors superior, Constitutional, and moral means to protect and profit from their content, the Dodge City DRM Marketplace/Search Engine will result in superior social networks with superior content, worth protecting. Although it is a primal sin against Lord Lessig and Lord Murdoch to talk about eternal cultural wealth founded within the classics and the Higher Values of values, I will do so, because I believe in a higher God, and this is yet a Free Country. The Dodge City DRM Marketplace/Search Engine will be the primary tool of the Rising Renaissance, and none can stop it. With the Dodge City DRM Marketplace/Search Engine the rising poets and prophets shall destroy the postmodern Temple, and rebuild it in three days.

Regarding the democratic cultural devolution that is myspace—which is as much a manifestation of a logical conclusion of the pomo-elite's opposition to the Constitution, the Bible, Shakespeare, and property rights as are the mutual fund scandals and feminist studies departments-Scott Karp blogs at http://publishing2.com/2006/03/16/myspace-is-a-ticking-time-bomb/, “I've been dreading this post, but I can't avoid saying this any longer—MySpace is a DEEPLY DISTURBING place. It's so disturbing that I'm convinced that the vast majority of the Web 2.0 fan club who gush over MySpace has NEVER actually spent any time on MySpace.” Larry Lessig has never criticized Myspace because passing judgment on porn is as much against his religion as is passing judgment on content theft. Karp continues, “Try doing a Google News search for “MySpace murder” or “MySpace sex” and check out all the stories in reputable local media outlets (which have no obvious ax to grind with MySpace) . . . Still not disturbed? Try spending some time on MySpace. See how long it takes you to find sexually suggestive or explicit content . . . Or, try going to the MySpace page of Reuters CEO Tom Glocer (which I found via I Want Media). Check out his friends, click around, and see what you make of what you find . . . I'm going to be accused of fraternizing with Nick Carr for saying this, but this is what you get when you remove all social barriers—you get humanity in the raw . . . Is this new to the web? Of course not. Is it limited to MySpace? Of course not. Does that mean we should start talking about censorship and regulation? I'm not going to touch that third rail—and I really don't have any answers . . . I'm not going to do a moral critique of MySpace or Web 2.0 or anything else—that's not my gig . . . I will say this—my greatest fear of MySpace is as a parent. That's my personal view, which I won't try to foist on to anyone else . . . But as Web 2.0 watcher, I have a strong view from a business perspective, which leads me to this prediction: Rupert Murdoch will come to regret the purchase of MySpace. Why? Because the reality is that MySpace can't be controlled, and that's a liability . . . Yes, I know, Web 2.0 is all about “ceding control” to the “edge.” But MySpace pushes this evolution to the extreme . . . Before you respond, let me be repeat—this is NOT a moral critique. It's a practical, business critique.”

Until he loses his life, and takes to heart those immortal ideals at the base of our Constitution, Karp will remain lost. For to lose one's life is to find it. Again we see that pomo-hipsters are incapable of passing moral judgments, as moral judgments get in the way of the bottom line, just as the Constitution, Shakespeare, and the Bible get in the way of those who plunder and steal from others for a living. As Jesus said, and as Wall Streeters John Bogle quotes in Battle for the soul of Capitalism and Paul Stiles quotes in Is The American Dream Killing You? “No man can serve two masters: for either he will hate the one, and love the other; or else he will hold to the one and despise the other. Ye cannot serve God and mammon.” Thus Karp is impotent in his critique. He is powerless to stem the tide of decline. And that's why it will be up to the rising generation, which is longing for Epic Storytelling across all media, to build the Renaissance. And that is why I am giving them the Dodge City DRM Marketplace/Search Engine—to protect and profit from the renaissance they create. May the Lord ride with them.

Their Kingdom is not of this world—they will build the renaissance independent of Lessig, independent of Murdoch, independent of all the amoral, indifferent MBAs, MFAs, and JDs who man the helms of the postmodern corporation in the same way that the indifferent, characterless sinners ran in endless circles in Dante's first level of hell, chasing banners with corporate logos and false marketing campaigns all designed with one intent—to transfer all the risk to the common worker, the artist, and the creator; and all the wealth to the soulless, postmodern elite, who claim to support the arts to raise taxes, and then do everything in their power to destroy it. For ye shall know them by their fruits, and look at their fallen culture.

As Dostoyevsky argued, “Without God, anything is permissible,” and that's the amoral premise of the pomo elite. Unfortunately, without God, everlasting art is impossible, and that's why the Renaissance will go to the rising Believers. The Dodge City DRM Marketplace/Search Engine is designed to allow the creators and indie artists to protect their private property—to build their empire piece by piece, bit by bit, reinvesting their profits into their businesses, as Lincoln so eloquently suggested they do. The Dodge City DRM Marketplace/Search Engine shall foster a renaissance in innovation and creation with far-reaching consequences. The Dodge City DRM Marketplace/Search Engine, and the property rights it protects and allows creators to profit from in an improved manner, will be at the heart and soul of the rising renaissance. Any innovation that leads to such great spiritual and cultural wealth will be granted a patent, and it will father child patents.

Rand writes, “ . . . what the patent and copyright laws acknowledge is the paramount role of mental effort in the production of material values; these laws protect the mind's contribution in its purest form: the origination of an idea. The subject of patents and copyrights is intellectual property.” The amoral premise of modern business schools and law schools is to teach that it is one type of person who creates, and another type who owns. Larry Lessig is the logical conclusion of this premise—the creator has to right to protect that which they create, and thus no right to profit from it, as Eminem and 50 Cent remind us. Modern business and law schools have succeeded in taking all the risk out of entrepreneurship—for the elite insiders that is. They risk the investor's money, or the tax dollars, or the tuition, pocket exorbitant fees and salaries while setting up tech transfer departments designed to transfer all the wealth to the permanent MBA bureaucrats and all the risk to the Ph.D. physicists and engineers, pretend to teach something other than socialism as they give one-another rewards, raise taxes, plunder pensions, and smile, smile, and smile. But Hamlet reminds us, “That one may smile, and smile, and be a villain.”

To deny the rising artist the Dodge City DRM Marketplace/Search Engine—an improved method for protecting and profiting from their creations—would make it more difficult for the indie artist to battle the corporate and academic postmodernists to realize a renaissance. Pomo-hipster mob-rule sites, such as myspace, where the artists has little or no rights, are backed by billions of dollars and legions of Lessig's snarky proteges—all of whom get paid handsomely to join in the Constitution's, the Bible's, and Common Sense's deconstruction. To deny the rising artist the Dodge City DRM Marketplace/Search Engine and their Renaissance would be to deny them the Spirit of very Declaration of Independence: “When, in the course of human events, it becomes necessary for one people to dissolve the political bonds which have connected them with another, and to assume among the powers of the earth, the separate and equal station to which the laws of nature and of nature's God entitle them, a decent respect to the opinions of mankind requires that they should declare the causes which impel them to the separation.”

The indie artist—not the bureaucracy-believes in higher ideals—in Beatrice's beauty and Penelope's immortal soul—and sails beyond the corporate and government bureaucracies, to create the works that last. The indie artist shall create and lead the renaissance—the MBA/MFA/JD posses are relegated to creating American Idol, Myspace, and Reality TV, which are definitively void of Epic Story and Higher Ideals, because lawyers have less work where Story naturally prevails. Artistotle said, “when storytelling declines, the result is decadence,” and the decadence of the pomo-hipsters on Wall Street and in Hollywood is supported and funded by the pomo-hispters in government, as their fellow elite's decadence allows the bureaucrats to go to the people to say, “See? We need to increase your taxes to grow the government and create more laws!” The postmodernists' fundamental livelihood is based on growing bureaucracies to augment the problems they claim they can solve. Via short-sighted foolishness, or evil, knowing, cunning, they play this short-term game, enriching the elites for the short-term at the long-term expense to the greater society, denying the common people and the indie artists their natural rights, their property, and their freedoms. Would that it were not so, but humanity will always find a way to build a bureaucracy around an ideal so as to oppose it; and those who are blind to the irony are written letters of recommendation, hired, and made partner after selling their souls and screwing the artist, the creator, and the worker.

To defend against these corruptions, the brilliant Founding Fathers gave us a Constitution with intellectual property rights, the freedom of speech, and the right to bear arms; and in that same Spirit, I give to ye, the indie artist, the Dodge City DRM Marketplace/Search Engine.

Make no mistake, we indie artists just want to live in peace and farm—on the fruits of our labors. But when the porno elite bureaucrats manufacture armies of Orcish MBAs and JDs to suck dry the fruits of our labors, we're not going to take it lying own. As the pomo-hipster Kings send their administrative forces of lawyers and MBAs forth to declare Prima Nocte on our IP, we recall the words of William Wallace, “Aye, fight and you may die, run, and you'll get to work as an assistant professor or lecturer . . . at least for a while. And dying in your beds, many years from now, would you be willin' to trade ALL the days, from this day to that, for one chance, just one chance, to come back here and tell our enemies that they may take our wives, but they'll never take . . . OUR FREEDOM!”

The modern form of capitalism resembles communism in many ways, with all the risk transferred to the workers and creators and artists, and the wealth transferred to the lawyers and bureaucrats; sanctified by the media that is owned and operated by the lawyers and bureaucrats. Wall Street's defense against this is, “how could you accuse us of communism?! We work on Wall Street!” It is funny how they defend the classic socialistic, immoral practice of transferring the wealth to the elites and the risk to the worker—“we're not communists—we love money! Both ours and yours! See? We have a lot of money. We're capitalists. What we need is more communism so as to share the wealth. Just give Larry Lessig one more chance-we promise he will get it right this time. All we need to do is raise the common man's taxes just a bit—the common man shouldn't be so damn selfish. Old people can't get medical help, and children don't have fathers, because the common man and indie artist is so damned selfish.” And so it is that the common man, artist, worker, and creator get caught in the cross-fire between amoral business bureaucracies and amoral government bureaucracies, who must fight over the fount of wealth in their zero-sum games—the indie creator and working man.

But the creator and indie artist plays at a table with far higher stakes—it is not a table with a finite number of chips, but it is a table where all lasting wealth is created via innovation and invention—as, “The Poet's eye, in a fine frenzy rolling, Doth glance from heaven to earth, from earth to heaven, and gives to airy nothing, a local habitation, and a name”—the table from where all other chips derive their value. And the indie artist ought have the Dodge City DRM Marketplace/Search Engine, so that they can hold onto more of the chips they create—their rightful inheritance.

The indie artist is the natural fount of wealth, and thus the indie artist ought be provided the optimum combination of technology that affords them the fullest expression of their rights as set forth in the United States Constitution—the right to protect and profit from their creations. Any society concerned about its well-being and long term growth, must protect the rights of the innovative creators, and all individuals, for they are one and the same. The present invention—The Dodge City DRM Marketplace/Search Engine-affords authors, artists, and writers the access to a full spectrum of rights management tools. The present invention salutes every artist, creator, and author, and vows to offer them maximum and optimum protection, distribution, and reach.

Were authors, creators, and indie artists afforded the opportunity to protect their content in the manner described in this present invention, the floodgates of the world would open to new business innovations based upon the present invention. The present invention—The Dodge City DRM Marketplace/Search Engine—could father hundreds of other inventions that serve the creator, and lead to a new generation of the internet. Major corporations and government bureaucracies that oppose the individual's rights, higher aesthetics, and everlasting art and its source will vocally protest such an invention for the sake of their selfish, short-term gains made by corrupting the meaning of the Constitution, and exploiting the indie artist, author, and creator, as lawyers and MBAs have done since the inception of their schools that teach the art of wealth transfer. The postmodern, soulless academies replaced the classical liberal arts education with a dumbed-down curriculum that rewards the mediocre conformists—those willing to lie, cheat, and steal—and sends them off to work at investment banks and media/porn companies, where they degrade the cultural wealth that brave men fought and died for, while transferring all the wealth to the elite insiders, and all the risk to the workers, creators, and indie artists. The Dodge City DRM Marketplace/Search Engine will create untold wealth by helping rising creators fight these trends of decline and decadence.

Furthermore, were authors, creators, and indie artists afforded the opportunity to profit from their creations in the manner described in this present invention, the floodgates of the world would open to new business innovations, and methods of profiting from content. The Dodge City DRM Marketplace/Search Engine will usher in a brand new era of the internet, where indie artists are free to protect and profit from their content.

The present invention is worthy of the Nobel Prize in Economics—far more than all the indecipherable pseudo-mathematics that has been winning the prize in these postmodern times that have deconstructed the cowboy. I'm a physicist—mathematics is a good friend of mine, and economics is not math. The Dodge City DRM Marketplace/Search Engine provides not only the words of a novel concept, but an embodiment of words in the action of the Dodge City DRM Marketplace/Search Engine. The resent invention provides the heart and soul of a tool that will let the creative cowboy ride again, and protect and profit from their artistic works, while also fostering further opportunities for inventors and entrepreneurs seeking to invent the next-generation internet so as to foster and serve Creator's Capitalism.

Coutney Love calls out the dot-communists in an eloquent speech at the digital Hollywood Online Entertainment conference: http://cdbaby.net/courtney

“Today I want to talk about piracy and music. What is piracy? Piracy is the act of stealing an artist's work without any intention of paying for it. I'm not talking about Napster-type software.

### I'm talking about major label recording contracts.

I want to start with a story about rock bands and record companies, and do some recording-contract math:
This story is about a bidding-war band that gets a huge deal with a 20 percent royalty rate and a million-dollar advance. (No bidding-war band ever got a 20 percent royalty, but whatever.) This is my “funny” math based on some reality and I just want to qualify it by saying I'm positive it's better math than what Edgar Bronfman Jr. [the president and CEO of Seagram, which owns Polygram] would provide.

### What happens to that million dollars?

They spend half a million to record their album. That leaves the band with $500,000. They pay $100,000 to their manager for 20 percent commission. They pay $25,000 each to their lawyer and business manager.
That leaves $350,000 for the four band members to split. After $170,000 in taxes, there's $180,000 left. That comes out to $45,000 per person.

### That's $45,000 to live on for a year until the record gets released.

The record is a big hit and sells a million copies. (How a bidding-war band sells a million copies of its debut record is another rant entirely, but it's based on any basic civics-class knowledge that any of us have about cartels. Put simply, the antitrust laws in this country are basically a joke, protecting us just enough to not have to re-name our park service the Phillip Morris National Park Service.)
So, this band releases two singles and makes two videos. The two videos cost a million dollars to make and 50 percent of the video production costs are recouped out of the band's royalties.

### The band gets $200,000 in tour support, which is 100 percent recoupable.

The record company spends $300,000 on independent radio promotion. You have to pay independent promotion to get your song on the radio; independent promotion is a system where the record companies use middlemen so they can pretend not to know that radio stations—the unified broadcast system—are getting paid to play their records.

### All of those independent promotion costs are charged to the band.

### Since the original million-dollar advance is also recoupable, the band owes $2 million to the record company.

### If all of the million records are sold at full price with no discounts or record clubs, the band earns $2 million in royalties, since their 20 percent royalty works out to $2 a record.

### Two million dollars in royalties minus $2 million in recoupable expenses equals . . . zero!

### How much does the record company make?

### They grossed $11 million.

It costs $500,000 to manufacture the CDs and they advanced the band $1 million. Plus there were $1 million in video costs, $300,000 in radio promotion and $200,000 in tour support.

### The company also paid $750,000 in music publishing royalties.

They spent $2.2 million on marketing. That's mostly retail advertising, but marketing also pays for those huge posters of Marilyn Manson in Times Square and the street scouts who drive around in vans handing out black Korn T-shirts and backwards baseball caps. Not to mention trips to Scores and cash for tips for all and sundry.

### Add it up and the record company has spent about $4.4 million.

### So their profit is $6.6 million; the band may as well be working at a 7-Eleven.

Of course, they had fun. Hearing yourself on the radio, selling records, getting new fans and being on TV is great, but now the band doesn't have enough money to pay the rent and nobody has any credit.
Worst of all, after all this, the band owns none of its work . . . they can pay the mortgage forever but they'll never own the house. Like I said: Sharecropping.
Our media says, “Boo hoo, poor pop stars, they had a nice ride. Fuck them for speaking up”; but I say this dialogue is imperative. And cynical media people, who are more fascinated with celebrity than most celebrities, need to reacquaint themselves with their value systems.
When you look at the legal line on a CD, it says copyright 1976 Atlantic Records or copyright 1996 RCA Records. When you look at a book, though, it'll say something like copyright 1999 Susan Faludi, or David Foster Wallace. Authors own their books and license them to publishers. When the contract runs out, writers gets their books back. But record companies own our copyrights forever.
The system's set up so almost nobody gets paid.”—Courtney Love, http://cdbaby.net/courtney
Courtney continues:
“Now artists have options. We don't have to work with major labels anymore, because the digital economy is creating new ways to distribute and market music. And the free ones amongst us aren't going to. That means the slave class, which I represent, has to find ways to get out of our deals. This didn't really matter before, and that's why we all stayed.
I want my seven-year contract law California labor code case to mean something to other artists. (Universal Records sues me because I leave because my employment is up, but they say a recording contract is not a personal contract; because the recording industry—who, we have established, are excellent lobbyists, getting, as they did, a clerk to disallow Don Henley or Tom Petty the right to give their copyrights to their families—in California, in 1987, lobbied to pass an amendment that nullified recording contracts as personal contracts, sort of. Maybe. Kind of. A little bit. And again, in the dead of night, succeeded.)
That's why I'm willing to do it with a sword in my teeth. I expect I'll be ignored or ostracized following this lawsuit. I expect that the treatment you're seeing Lars Ulrich get now will quadruple for me. Cool. At least I'll serve a purpose. I'm an artist and a good artist, I think, but I'm not that artist that has to play all the time, and thus has to get fucked. Maybe my laziness and self-destructive streak will finally pay off and serve a community desperately in need of it. They can't torture me like they could Lucinda Williams.
You funny dot-communists. Get your shit together, you annoying sucka VCs
I want to work with people who believe in music and art and passion. And I'm just the tip of the iceberg. I'm leaving the major label system and there are hundreds of artists who are going to follow me. There's an unbelievable opportunity for new companies that dare to get it right.
How can anyone defend the current system when it fails to deliver music to so many potential fans? That only expects of itself a “5 percent success rate” a year? The status quo gives us a boring culture. In a society of over 300 million people, only 30 new artists a year sell a million records. By any measure, that's a huge failure.”—http://cdbaby.net/courtney

When Clint Eastwood rode into town as The Man With no Name in A fistful of Dollars, the lawyers/bloggers taunted and teased him, firing shots to scare off his mule. He scoped out the situation from the roof of a bar, whereupon he learned of the two warring gangs—the Baxters and the Rohos. “Two bosses,” he says, “That crazy bell ringer was right—there's money to be made in a town like this. Today the two bosses are the record labels and the systems they inform such as iTunes, who rip off the artist as Courtney Love and Weird Al attest, as well as sites like downhillbattle.org. And on the other side there are the leftist Lessigs and bloggers who don't want DRM, so that everyone can rip the artists off. Both sides hail from the same law schools, and they make a living catching artists in the crossfire, hiding the true glory of the technology with legalisms. Jobs plays both sides, but his fatal flaw—his Achilles heel—is that he doesn't care about reuniting the family as The Man With No Name did in A Fistful of Dollars. And that's why Jobs has left the third act to be played out in Dodge City, with every artist carrying their very own 45 Revolvers.

For the artist rides into town alone, with corrupt record label lawyers and one side, and corrupt dot-communist lawyers on the other side—all of whom must use their energy to create mangled systems in petty turf battles which never realize the full potential and glory of the internet, which would be to afford the creators—the natural founts of wealth with the technology that best provides them with the Glory of their precious Constitutional Rights. The artist is that man with no name—with Honor and Integrity, while Jobs seems just another double-speaking tyrant, and google wrote its own fate as it simply stood by, did no evil, and watched, like all those people and shopkeepers and even the preacher from High Plains Drifter, who let the Marshal be whipped to death.

So it is that the classic Western is banned, to make room for something wicked that this way comes.

### Turning and turning in the widening gyre

### The falcon cannot hear the falconer;

### Things fall apart; the centre cannot hold;

### Mere anarchy is loosed upon the world,

### The blood-dimmed tide is loosed, and everywhere

### The ceremony of innocence is drowned;

### The best lack all conviction, while the worst

### Are full of passionate intensity.

### Surely some revelation is at hand;

### Surely the Second Coming is at hand.

### The Second Coming! Hardly are those words out

### When a vast image out of Spiritus Mundi

Troubles my sight: somewhere in sands of the desert

### A shape with lion body and the head of a man,

### A gaze blank and pitiless as the sun,

### Is moving its slow thighs, while all about it

### Reel shadows of the indignant desert birds.

### The darkness drops again; but now I know

### That twenty centuries of stony sleep

### Were vexed to nightmare by a rocking cradle,

### And what rough beast, its hour come round at last,

### Slouches towards Bethlehem to be born?

### MORE PRIOR ART AND ARTISTS CALLING FOR BETTER SYSTEM

Nor is Courtney Love alone in her sentiments. The 45 Revolver would hand all the power over to the indie musician, and thus grant them even more than 55 cents for ever 99 cent song sold. The 45 Revolver would not require CD Baby, nor Apple, no Microsoft, nor the major labels. The 45 Revolver, by providing the creator a method for choosing from multiple forms of DRM, commoditizes the providers of DRM, thusly driving the price down, of both devices and DRM. As time goes on, hardware and software are naturally commoditized, but a Beatles song will always be priceless.

Microsoft wants everyone to use Microsoft Windows Media DRM or Zune DRM. Apple wants everyone to use Apple DRM. The music marketplaces of Microsoft and Apple are still products of yesterday's record companies and yesterday's technology companies, which devalue the artist. While device makers, hardware makers, lawyers, and web 2.0 firms have cashed out in huge ways; the artists-those who provide the soul for the web, have yet to profit to handsomely. The 45 Revolver will allow them to do so. By offering the artist multiple DRM formats, the 45 Revolver will naturally force the DRM providers to compete. Some DRM providers may not play nicely with others, and then their DRM, and their devices, will not be used—they will be consigned to the dustbins of forgotten technologies. As DRM and devices are commodities, there will be plenty of options for various DRM and devices as time goes on. The pristine original will remain unique, and the 45 Revolver will protect it over time.

Many revered experts oppose the moral premise upon which the 45 Revolver is based. Most of them oppose it because it is a cool and hip thing to oppose morality and the United States Constitution. Lessig also opposes DRM because with a trustworthy DRM system, lawyers will have less work. Lessig opposes DRM, as his livelihood does not depend on DRM, as he is not an indie artist, nor an artist. Lessig blogs, “But some confuse praise for better DRM with praise for DRM. So let me be as clear as possible here (though saying the same thing I've always said): We should be building a DRM-free world. We should have laws that encouraged a DRM-free world. We should demonstrate practices that make compelling a DRM-free world. All of that should, I thought, be clear.” http://www.lessig.org/blog/archives/003353.shtml

So it is that Lessig wants to create laws opposing the authors', inventors', creators', and indie artists' Natural Rights. So it is that Lessig want to legislate against the very United States Constitution.

As an American lawyer, Lessig's primary cause ought to be to uphold the United States Constitution and make sure that the indie-artists rights are protected. Ideas have consequences, because of Lessig et als devotion to deconstructing the Constitution, mammoth corporations, venture capitalists, and Wall Street firms have been profiting at the artist's expense. The aim of the 45 Revolver is to give the indie artist the protection they need, so that they might better profit from their work. Larry Lessig ought to read Nobel Prize economist F. A. Hayek's The Road to Serfdom—especially the chapters The End of Truth and Why The Worst Get on Top.

George Orwell stated, “It cannot be said too often—at any rate, it is not being said nearly often enough—that collectivism is not inherently democratic, but, on the contrary, gives to a tyrannical minority such powers as the Spanish Inquisitors never dreamt of.” And so it is that the purpose of the collectivism of Lessig's Creative Commons licenses and anti-DRM stance is to empower a tyrannical minority and make them lords over all the struggling, indie artists; profiting off of others' labors of love.

Contrast Lessig's stance with Eminem's, Marilyn Manson's, Trent Reznor's, Metallica's, and Elton John's—all who began as indie artists:

Lars Ulrich of Metallica writes, “Let's get the obvious out of the way: This is not just about money (as some of the more cynical people will think). This is as close as you get to what's right and what's wrong. Metallica have always been in favor of giving the fans as much access as possible to our music. This includes taping sections at our concerts, and streaming our music via our website. And while we certainly revere our fans for their continued support and desire for our music, we must stress that the open trading of any copyrighted material is, in effect, the looting of our art. And that is something that no artist can, in their right mind, condone. We are in the business of art. This is a walking contradiction if ever there was one. However, there is no denying it. On the artistic side, Metallica create music for ourselves first and our audience second. With each project, we go through a grueling creative process to achieve music that we feel is representative of Metallica at that very moment in our lives. We take our craft—whether it be the music, the lyrics, or the photos and artwork—very seriously, as do most artists. It is therefore sickening to know that our art is being traded, sometimes with an audio quality that has been severely compromised, like a commodity rather than the art that it is. From a business standpoint, this is about piracy—a/k/a taking something that doesn't belong to you; and that is morally and legally wrong. The trading of such information—whether it's music, videos, photos, or whatever—is, in effect, trafficking in stolen goods. Back to the obvious: Very successful recording artists are compensated extremely well for what they do. For every Metallica, however, there are an endless number of bands who rely on what ever they can get in royalties to survive. And while we all like to take shots at the big, bad record companies, they have always reinvested profits towards exposing new bands to the public (although sometimes not the RIGHT bands). Without this exposure, many fans would never have the opportunity to learn about tomorrow's bands today. Napster and other such sites were obviously not conceived to lose money. They, like the labels, must make money or they're out of business. And whatever money they are generating from their site is dirty money. It's being taken out of the hands of the artist and the record labels and put into the hands of another corporation.”

Eminem states in the 2000 Wall of Sound, “I'm sorry; when I worked 9 to 5, I expected to get a f--king paycheck every week. It's the same with music; if I'm putting my f--king heart and all my time into music, I expect to get rewarded for that. I work hard and anybody can just throw a computer up and download my s--t for free. That Napster s--t, if that gets any bigger, it could kill the whole purpose of making music. It's not just about the money . . . It's the thrill of going to the store; you can't wait till that artist's release date, taking the wrapper off the CD and putting the CD in to see what it sounds like. I've seen those little sissies on TV, talking about [how] ‘The working people should just get music for free,’ I've been a working person. I never could afford a computer, but I always bought and supported the artists that I liked. I always bought a Tupac CD, a Biggie CD, a Jay-Z CD. If you can afford a computer, you can afford to pay $16 for my CD.”

Trent Reznor of Nine Inch Nails, stated in the May 5, 2000 Boston Globe “ . . . Just because technology exists where you can duplicate something, that doesn't give you the right to do it. There's nothing wrong with giving some tracks away or bits of stuff that's fine. But it's not everybody's right. Once I record something, it's not public domain to give it away freely. So I stand behind Dr. Dre and Metallica and support them. And that's not trying to be the outdated musician who is trying to ‘stop technology. I love technology. Technology is here to stay.”

Sean “Puffy” Combs, CEO, Bad Boy Entertainment, Inc., states, “I couldn't believe it when I found out that this Napster was linking thousands of people to the new Notorious BIG album “Born Again,” a week before it even hit the streets. This album is a labor of love from Notorious BIG's friends to the man, his kids, the rest of his family and everyone else whose lives will never be the same since BIG passed. BIG and every other artist Napster abuses deserve respect for what they give us.”

Lou Reed states, “Artists, like anyone else, should be paid for their work.”

Elton John states, “I am excited about the opportunities presented by the Internet because it allows artists to communicate directly with fans. But the bottom line must always be respect and compensation for creative work. I am against Internet piracy and it is wrong for companies like Napster and others to promote stealing from artists online.”

So it is that a vast demand exists to protect one's content and profit from one's work.

The 45 Revolver proposes that the DRM dilemma will not be solved by lawyers, nor activists, nor committees; but by authors, artists, and creators being offered a full spectrum of rights management. Mark Twain said, “Only one thing is impossible for God: To find any sense in any copyright law on the planet.” He also said, in a Speech before Congress in 1906, “They always talk handsomely about the literature of the land . . . And in the midst of their enthusiasm they turn around and do what they can to discourage it.” Finally, he wrote,_“Whenever a copyright law is to be made or altered, then the idiots assemble.”

Michael A. Lechter, ESQ., Intellectual Property Attorney, write the following in a book entitled, Protecting Your #1 Asset: Creating a Fortune from Your Ideas, An Intellectual Property Handbook “Intellectual property is to the world of business what the Colt .45 was to the dime-novel Old West: the great equalizer. It is often the only thing that permits an emerging business to compete successfully against larger, established competitors with vastly more marketing power. In other words, if you are going to compete against the Big Boys, you will typically have to do so through the creation and use of intellectual property.”

So it is that as the indie artists walks into town, they see two warring gangs of lawyers—the old lawyer media—the record labels-who took from the artists all their profit, and the new media, who wants to destroy the artist's profits upfront as they believe that by denying rights and the heart and the soul up front, struggle and war might be avoided—the Lessigs et al who are in the pockets of vast aggregating companies that wish to copy and command every piece of content ever created by mankind and womankind. The only problem is that every artist who makes it past Roe Vs. Wade is born with those entities that cannot be taken away—their heart and soul and spirit—their God-given Natural Rights to life, liberty, and the pursuit of happiness.

While Wall Street, academic economists, and Venture Capitalists have proven adept at Aggregators' Capitalism, wherein the lion's share of the wealth is transferred from indie artists and the individual creator to elite groups of venture capitalists, lawyers, MBAs, and non-creators; often in devious, pump-and-dump schemes such as those that transferred $7 trillion dollars from pensions and working-people to Wall Street Bankers and VCs circa 2000, Wall Street and Venture Capitalists have failed at creating a system that supports Creator's Capitalism—a far better long-term investment. Wall Street and postmodern VCs have failed to create a system that would create far greater wealth in a far more moral manner in accordance with the moral premise of the United States Constitution—affording the artist, author, and creator the opportunity to protect and profit from their works. Ideas have consequences, and because of Lessig et al's constant oppositional chattering, blogs, and campaigns against the Constitution and artists' rights, the technology has not lived up to its greater potential, and artists and musicians in Hollywood and beyond have been denied opportunities for systems that allow them to protect and profit from their creations. As a result of diminished opportunities to protect and distribute one's indie creations, rather than having the economy driven via the natural act of wealth creation by ingenuity and entrepreneurship, the Fed had to drive the economy by printing more money—by lowering interest rates and encouraging people to give more of their homes to Wall Street in exchange for paper money. Because the postmodern lawyers are killing the higher ideals—the Constitution and the Great Books—the older generation has to place the younger generation in vast cultural and monetary debt just to survive and feed their leviathan appetites for superficial power, trinkets, porn, and circuses. The Dodge City DRM Marketplace/Search Engine will allow indie artists to own and capitalize on the renaissance they create, reversing the cultural decline. Thus the Dodge City DRM Marketplace/Search Engine will foster vast wealth creation.

At the end of the day, all economies must be viewed as they are—entities that require souls and moral premises to exist, just as humans do. Kill the moral premise, the human will devolve, and the economy, along with the society, will wander off towards tragedy. By taking the dollar off the gold standard, by taking the Constitution of the God standard, and by replacing it all with the postmodern porn standard, elite groups have derived vast short-term profits at the expense of the indie artist, creator, and working man—the preachers, teachers, and firemen who yet Believe. The Dodge City DRM Marketplace/Search Engine is an invention that will operate on many levels, and which will allow the creation of vast amounts of wealth, as it ushers in a cultural and economic renaissance. The Dodge City DRM Marketplace/Search Engine will allow a return to the Constitutional Ideals which many Great Men pledged their Lives, their Fortunes, and their Sacred Honors so that we might enjoy Freedom and Prosperity today.

### FURTHER DISCUSSION OF PRIOR ART AND INVENTION

Red Herring Magazine, in an article entitled, Paid Citizens, Web 2.0 Colonialism?, Volume 3, No. 06 reports, “In a session at the crowded Web 2.0 conference in San Francisco last October, Yahoo CEO Terry Semel said user-generated content ‘is of utmost importance’ to his company—‘A gigantic piece of what we do and ability to monetize.’ In the last year, Yahoo launched a blog service, a ‘publishers' network’ that places ads on users' sites, and bought the popular photo-sharing service Flickr. The portal profits from these services by selling ads to run alongside them or by charging subscription fees. It's revenues rose 47 percent last year to $5.26 billion . . . Profiting from user-generated content is Web 2.0 Colonialism.”

The Dodge City DRM Marketplace/Search Engine is all about Web 3.0—where content creators make money. And web 4.0 and web 5.0—where movies don't suck. There're all these myths designed to keep the artistic entrepreneur down, and we've got no need for them. The Dodge City DRM Marketplace/Search Engine will allow rising artists to blow the myths away. If you're man enough to create it, you're man enough to profit form it. You're man enough to own it, to define your rights, to control the DRM-you're man enough to profit from it.

There's a pernicious myth perpetuated by the business and law schools that it's one type of person who creates, and another type of person who gets to profit from it. They started that myth in the business and law schools, as that it how they sell the degrees—they give you the right to steal. The postmodern economists ignore the United States Constitution and promote the science of distributing risk throughout the creators, and all the wealth amongst the MBAs/JDs harvesting the rewards. Such an inverted society cannot long last, for, as Hamlet said, “O cursed world, is out of joint, my spite, that I was born to set it right.” Every step of the way, every convoluted porno copyright clause and underhanded snub, is designed to transfer wealth from the creator to the non-creator. But I say the United States Constitution is beautiful and profound, and it does us just fine. For unlike pomo lawyers and MBAs, the US Constitution is Higher Art. The creators are not the commodities—the lawyers and MBAs are. Our songs, movies, and books are unique. MBA bureaucracies abound. What? You don't want to invest in us? Well your money's a commodity too. Our art is unique. And now with all this technology—with Rocky Raccoon's Dodge City DRM Marketplace/Search Engine, we can walk into town, define our rights and launch our creations into thousands of portals—the thousands of portals that had been designed to treat artist and creators as commodities—as widgets.

Well, to the degree an MBA lacks talent, they view art as a widget, as a risk—they view creators as a great herd of prima-donnas to be grouped together in some social network where they can fight it out and enrich the owners of the network. But we artists know where the real risks lie-dealing with MBA bureaucracies. We know that our art is no risk—it is our heart and our soul. For those who have no choice but to serve Eternity, MBA bureaucracies pose the greatest risks. It might not fetch a fair price on the trading floor at the NYSE today—it might fetch nothin', but we're calling the bluff. For our art is unique, and social networks and web 2.0 content sites are a dime a dozen. With the Dodge City DRM Marketplace/Search Engine, we're walking right on in and sitting down at those tables where we had never been allowed before, and we're calling the bluff. Art is the Ace of Spades in this game, and sitting here there's something else I see—you've been playing with our chips.

Red Herring Magazine, in an article entitled, Paid Citizens, Web 2.0 Colonialism?, Volume 3, No. 06 reports, “That's great for Yahoo, but what about the users who create the content? That question is raised by Anil Dash, a well-read blogger (dashes.com) and VP of professional products at the largest independent blogging company, SixApart. In a post last October, Mr. Dash discussed Flickr's process of classifying users' pictures by their ‘interestingness’—a combination of the comments, tags, click-throughs, and favorites associated with a photo. ‘Is interesteningness its own reward?’ asked Mr. Dash, suggesting users might be compensated with money or some other kind of value . . . Paul Mooney (dotnetjunkies.com/weblog/paul/) summed up many people's thoughts in his comment: ‘Profiting from user-generated content is Web 2.0 Colonialism.’”

Many corporate and academic elites will rage and blow against the Dodge City DRM Marketplace/Search Engine, as they detest its moral premise and the very notion of a moral premise, as it gets in the way of their bottom line. The tenured priests are busy tenuring and promoting all the creative mediocrities who write law-review papers opposing the noble invention and the United States Constitution, but by Time and the Power of God, their words will be rendered useless as the moral context upon which this nation was conceived and founded, prevails. For as Abraham Lincoln said, “Those who deny freedom to others, deserve it not for themselves; and,

under a just God, can not long retain it.” The postmodern lawyers and elites cannot long deny the artists and creators their fundamental economic freedom, for without economic freedom, there is no freedom. And artists, not lawyers, are who define our freedom, for as the poet Shelley noted, “Those who imagine and express indestructible order, are not only the authors of language and music, of the dance, and architecture, and statuary, and painting; they are the institutors of laws and the founders of civil society, and the inventors of the arts of life, and the teachers, who draw into certain propinquity with the beautiful and the true that partial apprehension of the agencies of the invisible world which is called religion.” Artists, and art, cannot exist without freedom, and where everlasting art is denied, so is civil society. Artists must be guaranteed the freedom to protect and profit from their innovations, and that is what the Dodge City DRM Marketplace/Search Engine gives them, in a novel and previously unseen manner.

Freedom—the freedom to protect and profit from one's property—is a divine right. Thomas Jefferson reminds us, “We hold these truths to be self-evident, that all men are created equal, that they are endowed by their Creator with certain unalienable Rights, that among these are Life, Liberty and the pursuit of Happiness. That to secure these Rights, Governments are instituted among Men, deriving their just Powers from the Consent of the Governed, that whenever any Form of Government becomes destructive of these Ends, it is the Right of the People to alter or to abolish it, and to institute new Government, laying its Foundation on such Principles, and organizing its Powers in such Form, as to them shall seem most likely to effect their Safety and Happiness.”

And thus the Dodge City DRM Marketplace/Search Engine serves the spirit of The Declaration of Independence.

Jefferson once wrote that “a lively sense of filial duty is more effectively impressed on the mind of a son or daughter by reading King Lear, than by all the dry volumes of ethics, and divinity, that ever were written.” So it is that art, and Epic Story, are of utmost importance o a civil society. So it is that the individual artist's rights must be protected, and they must be able to profit from the fruits of their labor. Shelley, the famous poet, agreed, and I quote him in the opening paragraph at starbuck.com:

The Starbuck Classical Poetry Port was inspired by a mystical memory which has haunted me ever since this foggy May night by the Corolla Lighthouse, which can be found just North of Duck, on the outer banks of North Carolina. The Lighthouse can be found there, while the memory resides here. Hoping to climb the spiral stairs in the Corolla Light, Misty and I had hopped the criss-cross wooden corral fence so as to see if the door to the Light was unlocked. Not only was this a first date with a totally awesome girl, but it also happened on that same gothic night that I was introduced to Moby Dick. Now a lot of people might contend that Moby Dick is a novel, rather than a poem, but as of late I have been staying up to all hours of the morning studying the subject, and I say that Poetry is the music of the rational soul, the ultimate expression of the spirit's reality, and a mirror of the intangible, phantasmal essence of our existence. Poetry is found in all the magnificent works which define the fundamental words at the foundations of all our laws, convictions and conventions, our morality, our conscience, and our sense of divinity. Shelley himself declared that poets are the unacknowledged legislators of mankind, and I contend that one can find no noble milestones in history which were not preceded by the spoken or written work of an individual who had the courage to render a bold new vision in words. Though it is often endowed with rhyme and meter, poetry derives its everlasting glory from the depths of the profundities it preserves. Thus the classical poets, who we shall dedicate all the Classicals Inc. websites to, range in character from Shakespeare, to Plato, to St. Augustine, to Thomas Jefferson, to the Prophets, to Herman Melville, to Kipling, to Salinger. And though lacking corporeality, all Great Poetry is as solid and permanent as the rock of the eternal soul.

In The Natural Aristocracy, Thomas Jefferson wrote to John Adams from Monticello, on Oct. 28, 1813. “I agree with you that there is a natural aristocracy among men. The grounds of this are virtue and talents. Formerly, bodily powers gave place among the aristoi [aristocrats]. But since the invention of gunpowder has armed the weak as well as the strong with missile death, bodily strength, like beauty, good humor, politeness, and other accomplishments, has become but an auxiliary ground for distinction. There is also an artificial aristocracy, founded on wealth and birth, without either virtue or talents; for with these it would belong to the first class. The natural aristocracy I consider as the most precious gift of nature, for the instruction, the trusts, and government of society. And indeed, it would have been inconsistent in creation to have formed man for the social state, and not to have provided virtue and wisdom enough to manage the concerns of the society. May we not even say, that that form of government is the best, which provides the most effectually for a pure selection of these natural aristoi into the offices of government? The artificial aristocracy is a mischievous ingredient in government, and provision should be made to prevent its ascendency . . . I think the best remedy is exactly that provided by all our constitutions, to leave to the citizens the free election and separation of the aristoi from the pseudo-aristoi [pseudoaristocrats], of the wheat from the chaff. In general they will elect the really good and wise. In some instances, wealth may corrupt, and birth blind them, but not in sufficient degree to endanger the society.”

Lessig, Murdoch, et al are doing everything possible to bolster their artificial aristocracies at the expense of the natural aristocracy made up of indie artists and creators. Hollywood is in decline because there is too much nepotism—somebody knows somebody who was a student of Larry Lessig's and they get to write the rewrite of some seventies sitcom. This heartless, soulless system is as incapable of producing art as is myspace is incapable of creating bands, and society suffers. The Dodge City DRM Marketplace/Search Engine will allow Jefferson's “natural aristocracy”—the indie artists, creators, and working men and women—to defend their rights against the feudal MBA/MFA/JD nobility of Lessig's and Murdoch's artificial aristocracy. Abraham Lincoln, the “eloquent president,” also said, “We have, as all will agree, a free Government, where every man has a right to be equal with every other man. In this great struggle, this form of Government and every form of human right is endangered if our enemies succeed.”So it is that every indie creator and artist ought be provided the same rights as Steven Jobs, Google, and Microsoft. Lincoln says, “I have never had a feeling, politically, that did not spring from . . . The Declaration of Independence . . . that all should have an equal chance. This is the sentiment embodied in The Declaration of Independence . . . I would rather be assassinated on this spot than surrender it.” And so it is that the Dodge City DRM Marketplace/Search Engine is dedicated to giving every artist, author and creator an equal chance to protect and profit from their content. Yardley.ca states, “Profiting off user-generated content is Web 2.0 colonialism . . . I suspect that the omission of a payment mechanism is deliberate, and that the biggest proponents of Structured Blogging are just looking for new ways to aggregate a lot of content, use it to build up a valuable userbase, and sell, generating nothing for us-plain-folks but ‘a bigger megaphone.’”Ethan Zuckerman writes at http://ethanzuckerman.com/blog/?p=468, “My buddy Boris has an excellent recent post titled, “It's not about you”. He argues that the rise of Web 2.0 businesses-which build communities around content users post to the sites—shouldn't fool you into thinking that these companies care about you. They don't—they care about your bits.”

Boris writes at http://bopuc.levendis.com/weblog/archives/—2006/03/28/its_not_about_you.php, “But that's not what the bankrollers are on about. They don't care about your newfound ability to publish your thoughts or your pictures. They are just glad that you are doing so. Why? Because in an information based economy, data is your primary natural source. And flow of data creates movement which can be harnessed. Like a water-mill. The difference is that these millers don't need to go find a river: they can make one. And that's what sites like Flickr, del.icio.us, Upcoming, YouTube, Newsvine and the lot of them, have done. Centralize, centralize, centralize. Concentrate and control. What that means: 1—your data is not under your direct control. 2—what is done with your data, is not under your direct control. So what? What are these people doing with your data? It's pretty simple: they use it to drive advertising revenues. We are all working for them. For free. That's how it's ‘about we.’ It's not a ‘media revolution,’ it's a reversion to feudal medievalism. ‘Voluntary servitude’ it's been called (back in 1548!) (This is worth a read too though it has quite a Marxist taste to it.” The Dodge City DRM Marketplace/Search Engine stands head and shoulders of the above mentioned Web 2.0 companies, as it provides the creator superior freedom-freedom to watermark, encrypt, and syndicate their content throughout the entire web. The fount of all wealth is the indie spirit—give them the method to protect and profit from their creations in this invention, and the rising tide will lift all boats.

Boris characterizes the favorite argument of Lessig, Murdoch et al. by which the postmodern lawyer and MBA transfer all the wealth to themselves, and all the risk to the creator—“The counter argument is ‘but they are providing a service which in order to survive must sustain itself economically somehow, and you free information people are the first to yell ‘information wants to be free’ and so it is and we can't rely on subscription or pay-per-content schemes.’ Totally fair. And services like all the above mentioned all do fairly decent jobs of providing ways to export and retrieve your data. One way or another, you gotta pay to play, right? The malaise remains however: they are profiting from our ignorance (or forgetfulness). Whether it is ignorance of their actions or ignorance of your abilities (to do any of this yourself in a de-centralized way) or rights.”

### The Dodge City DRM Marketplace/Search Engine naturally educates the user with their natural rights, and affords them a simple and easy means for protecting and profiting from their content.

The present invention is meant to level the playing field for the indie artist, author, and creator. The Dodge City DRM Marketplace/Search Engine bypasses all the traditional and Web 2.0 middlemen to simply afford the artist and inventor with the method to protect and profit from their work.

In his book The Great Risk Shift: The Assault on American Jobs, Families, Health Care, and Retirement—And How You Can Fight. Back, Jacob S. Hacker characterizes how the postmodem elite's primary goal is to transfer all the risk and work to the indie artist and creator—the working man—and take all the wealth for themselves. The postmodern elite fly Corey Doctorow and Larry Lessig around to conference after conference after conference, so they can lecture the masses on the virtues of voluntary servitude. Lou Dobbs has noticed the “Lessig Bait & Switch” as well, as he reports in his book, War on the Middle Class: How the Government, Big Business, and Special Interest Groups Are Waging War on the American Dream and How to Fight. Back.

Modern law and MBA schools are akin to the Mordor factories that manufactured Orcs to terrorize the land. Modern law schools, business schools, and MFA programs are manufacturing a postmodern elite based on rich mediocrity—rich by the money that is printed. But as one can print money, but not honor, integrity, art, and Truth, the Dodge City DRM Marketplace/Search Engine is betting on the latter.

The same classical values guiding the rising artistic renaissance will protect the artists' intellectual property. The immortal ideals which guide the story of blockbuster books and movies such as The Matrix, Lord of the Rings, Braveheart, The Chronicles of Narnia, and Star Wars, are the very same ideals underlying the United States Constitution. These classic ideals—which pervade Homer, Plato, Shakespeare, and the Bible are the source of both epic story and property rights, of law and business, of academia and civilization. It is great to witness classical ideals performed in Middle Earth, upon the Scottish highlands, long ago, in a galaxy far, far, away, and in Narnia, but too, such ideals must be perpetually performed in the contemporary context and living language. The Dodge City DRM Marketplace/Search Engine shall be powered by the same classical ideals as the art which it protects.

A new age has begun—an age of freedom!—300

The present invention represents a declaration of independence for artists. The present invention will allow artists to protect and profit from their creations as never before.

I've got to make it through heaven, for going through hell.—50 Cent

50 Cent echoes Dante's Inferno, and that's the way it is these days on the DRM landscape. All the legions of lawyers, bubble-inciting VCs, publicists, bloggers, and hypesters have failed utterly and completely to create a system that realizes the full potential of the internet, as they have all begun with the wrong moral premise—that the soulless hypesters, marketers, lawyers, and groupthink leaders create superior wealth to the artists, and ought be paid more than the artists and creators.

Welcome my good friend, allow me to take you on a through the current DRM landscape, as we approach Purgatorio and Paradisio—the day when the Beatrice Game Engine and this present invention reigns supreme. He following is based on wikipedia—I love wikipedia, and it owns a most honorable place in this world. The wisdom of crowds has its place, as does open source software and shared content released under the CC licenses and the Gnu Public License (GPL). What is missing is a DRM system that better serves the artists.

The postmodern boomer elite banned classical story and Westerns, as without stories that portray Justice and the Old Testament God, it is easier for them to raise taxes, pilfer pensions, and legalize abortion—the ultimate form of the destruction of private property—someone else's life. Thus it makes perfect sense that DRM is opposed on every level, through and through, as the vast majority of academics and economists make their money not via creating useful art and innovation, but by taxing those who do create something useful to build more buildings so they can justify raising tuition, so that they can raise taxes. Even when they do pay homage to entrepreneurship, art, and innovation, it is in ironic jest, as they recreate the word entrepreneurship in their own image, until it means the growth of the bureaucracy and skimming pensions and savings, tax and tuition, rather than the creation of wealth by the rugged individual and indie artist—the natural fount of wealth.

The present invention, will bypass the doublespeakers and pomo hipster boomers who are most innovative when it comes to devising new names for bureaucracies all with the same purpose of transferring all the risk and work to the artist, and the wealth to themselves. As the art and creations of others are a vast wellspring of wealth for the bureaucrats, they will rage against this present invention, and they will send their very best law students to deconstruct it. They will choose those who lack souls, give them top honors, and send them forth. But beware, for none of them shall string the bow, and to be standing in that hall when the bow does get strung will be a most dangerous place to be for all those who have spent, and seek to spend their lives living off the creations of others. The snarky pomo-hipster lawyer/mbas are very much like the suitors in the Odyssey, laying Odysseus's estate to waste, while Odysseus was off fighting for his country.

Long ago, Homer wrote, “Telemachus took this speech as of good omen and rose at once, for he was bursting with what he had to say. He stood in the middle of the assembly and the good herald Pisenor brought him his staff. Then, turning to Aegyptius, “Sir,” said he, “it is I, as you will shortly learn, who have convened you, for it is I who am the most aggrieved. I have not got wind of any host approaching about which I would warn you, nor is there any matter of public moment on which I would speak. My grieveance is purely personal, and turns on two great misfortunes which have fallen upon my house. The first of these is the loss of my excellent father, who was chief among all you here present, and was like a father to every one of you; the second is much more serious, and ere long will be the utter ruin of my estate. The sons of all the chief men among you are pestering my mother to marry them against her will. They are afraid to go to her father Icarius, asking him to choose the one he likes best, and to provide marriage gifts for his daughter, but day by day they keep hanging about my father's house, sacrificing our oxen, sheep, and fat goats for their banquets, and never giving so much as a thought to the quantity of wine they drink. No estate can stand such recklessness; we have now no Ulysses to ward off harm from our doors, and I cannot hold my own against them. I shall never all my days be as good a man as he was, still I would indeed defend myself if I had power to do so, for 1 cannot stand such treatment any longer; my house is being disgraced and ruined. Have respect, therefore, to your own consciences and to public opinion. Fear, too, the wrath of heaven, lest the gods should be displeased and turn upon you. I pray you by Jove and Themis, who is the beginning and the end of councils, [do not] hold back, my friends, and leave me singlehanded—unless it be that my brave father Ulysses did some wrong to the Achaeans which you would now avenge on me, by aiding and abetting these suitors. Moreover, if I am to be eaten out of house and home at all, I had rather you did the eating yourselves, for 1 could then take action against you to some purpose, and serve you with notices from house to house till I got paid in full, whereas now I have no remedy.”

It is no coincidence that while the Founding Fathers—the Framers of the Constitution—read the Classics, the Classics are not required in MBA/Law School programs-indeed they have been banned. It is far easier to twist and contort minutae in case studies, based on opinions of arrogant, little judges who came to power in these times of decline. I would wager that Larry Lessig has never taught the Odyssey—the fundamental text on Property Rights, along with the Bible, in any of his classes. All of his boomer elite colleagues deconstructed the Great Books and Classics—the Sprit of the Law—and replaced them with case studies—the Letter of The Law, so as to make way for lying in the corporate world, in government, and the pension fund and mutual fund scandals. For Aristotle reminds us that when storytelling declines, the result is decadence, and vast short-term profits can be made by the snarky elite ironists, such as Henry Blodget, in times of decline. But the long-term damage to the greater society is immense, and thus the typical lawyer/mba has been blessed with the short-sightedness that allows them to be content following the lawyer/mba directly in front of them, who are following the shadows dancing on the cave's walls. So it is that hordes of lawyers can be trained in the arts of snarky deconstruction and desecration, with rewards and top honors being given to those who devise new ways of twisting phrases and corrupting meanings so as to transfer risk to the creators, artists, and innovators—to the teachers, preachers, and firemen—and the wealth to Lessig et al. The postmodern law degree/mba has little to do with justice, as evidenced by the decline of Wall Street and the rise of corporate scandals that are directly proportional to the number of uncreative, unproductive mbas and lawyers who are sent forth like armies of Orcs to profit not via artistic entrepreneurship, but taxation and corruption, pornification and decline. A lot of time is spent by Lessig et al in perpetuating the myth that business is by its very nature corrupt, and thus such corruption is excusable, and too, that we need to grow a larger government to preside over the corruption. These myths have replaced the Great Books and Classics at every level. You will never catch Lessig turning towards Shakespeare and the Bible as Lincoln and Franklin and Madison Jefferson did, for while Lessig went to law school, the latter attended the Great Books and Classics. You will never find Lessig et al turning towards the words of Martin Luther King Jr.: “If we are to go forward, we must go back and rediscover those precious values—that all reality hinges on moral foundations and that all reality has spiritual control.”

Also quoted below are prestigious experts including Larry Lessig—the founder of the Creative Commons and renown Stanford Law professor, as well as Corey Doctorow—the famous blogger, writer, member of the EFF, and influential speaker on topics pertaining to DRM who has addressed many organization, including Microsoft, regarding DRM. While the vast, vast majority of artists support stronger protections for their works, both Lessig and Doctorow, who represent the majority opinions of the web 2.0 tech denizens and their loyal MFA/MBA fanboys, are vocally opposed to Digital Rights Management. Lessig's and Doctorow's vocal opinions have a far-reaching influence throughout the tech world, and the spirit of the present invention counters and opposes their vocal oppositions to DRM. Indeed, the prevailing views of Lessig, Doctorow, and others can explain in part why the present invention, serving the interests of the creators, has not yet seen been manifested. But eternity is on truth's and beauty's die, and the cost of computer applications tends towards zero-so it is that DRM will someday be free as the wind, while art and the individual will never be a commodity; and this invention fully capitalizes upon the proper persepective. While web 2.0 companies seek to commoditize the creator, the present invention treats the creator as unique while commoditizing the web 2.0 companies.

Lessig's and Doctorow's opinions are more fully discussed, as are the objects and advantages of the present invention. Very briefly, here is Corey Doctorow's expert view which was presented during a speech to Microsoft and translated into a dozen languages http://www.craphound.com/msftdrm.txt:

Here's what I'm here to convince you of:

### 1. That DRM systems don't work

### 2. That DRM systems are bad for society

### 3. That DRM systems are bad for business

### 4. That DRM systems are bad for artists

### 5. That DRM is a bad business-move for MSFT

### Microsoft Research DRM talk, Cory Doctorow, cory@eff.org, Jun. 17, 2004, This talk was originally given to Microsoft's Research Group and other interested parties from within the company at their Redmond offices on Jun. 17, 2004.

Trent Reznor of Nine Inch Nails, calls Cory's bluff in Boston Globe, May 5, 2000, “ . . . Just because technology exists where you can duplicate something, that doesn't give you the right to do it. There's nothing wrong with giving some tracks away or bits of stuff that's fine. But it's not everybody's right. Once I record something, it's not public domain to give it away freely. So I stand behind Dr. Dre and Metallica and support them. And that's not trying to be the outdated musician who is trying to ‘stop technology. I love technology. Technology is here to stay . . . ” It has ever been a war against the creator and those who seek to take and profit from another man's labor.

Very briefly, the spirit of the present invention—The Dodge City DRM Marketplace/Search Engine—allows Dr. Dre et al to call the bluff, by countering Cory's conventional web 1.0/web 2.0 wisdom by stating:

### 1. DRM does work

### 2. DRM systems are good for society

### 3. DRM systems are good for business

### 4. DRM systems are good for artists/individuals/creators

### 5. DRM is a good business-move for any business seeking to build a quality brand in the content space

### 6. DRM is the missing key to long-term profitability for social networks.

### 7. DRM is the missing key to better content on the web.

### 8. DRM that best serves the indies creator will also best serve the major creators.

### 9. DRM will allow better “fair use” systems where property that is tagged can be shared and included in other works while still compensating the original creator.

### 10. DRM can help foster a unique and novel business models including social networks and content marketplace.

### 11. DRM is the natural right of every artist and creator.

### 12. DRM is the Constitutional right of every creator.

Unlike prior art, this present invention realizes both the full value of internet technologies and the United States Constitution, by affording authors, artists, and creators the fullest potential to create and profit from social networks and marketplaces filled with content they and other artists create and protect. Contrast Cory Doctorow's words to those of George Lucas who has created a multi-billion dollar empire.

Should other artists, authors, and creators be denied the right to build multi-billion dollar empires just because Cory has not? Cory's books tend to lack plots, characters, and structure—the elements all everlasting art necessitates. There is a Biblical story about two women who claim ownership of a baby. The Wise King Solomon suggests that they cut it in two. One of the ladies thinks this is a good idea. The other is aghast at the prospect, and King Solomon gives the baby to her, as she is the true mother. So it is that DRM ought to be the right of true mother—the true creator who can give birth to true everlasting art.

Contrast Cory Doctorow's words to the words of John C. Bogle—the creator of the world's largest mutual fund, in a speech entitled, “Capitalism, Entrepreneurship, and Investing—The 18th Century vs. the 21st Century:”

“Let's begin with Franklin's entrepreneurship. It was not only remarkable for his era; it was remarkable for any era. While in today's grandiose era of capitalism the word “entrepreneur” has come to be commonly associated with those who are motivated to create new enterprises largely by the desire for personal wealth or even greed, the fact is that entrepreneur simply means “one who undertakes an enterprise,” a person who founds and directs an organization . . . But at its best, entrepreneurship entails something far more important than mere money. Please do not take my word for it. Heed the words of the great Joseph Schumpeter, the first economist to recognize entrepreneurship as the vital force that drives economic growth. In his Theory of Economic Development, written nearly a century ago, Schumpeter dismissed material and monetary gain as the prime mover of the entrepreneur, finding motivations like these to be far more powerful: (1) ‘The joy of creating, of getting things done, of simply exercising one's energy and ingenuity,’ and (2) ‘The will to conquer: the impulse to fight, . . . to succeed for the sake, not of the fruits of success, but of success itself.’ . . . There is a difference, then, between an entrepreneur and a capitalist. Had Franklin possessed the soul of a true capitalist, ‘he would have devoted the time he saved from printing to making money somewhere else.’ 1 But he did not. For Franklin, the getting of money was always a means to an end, not an end in itself. The other enterprises he created, as well as his inventions, were designed for the public weal, not for his personal profit. Even today, Dr. Franklin's idealistic 18th century version of entrepreneurship is inspirational. When he reminded us that ‘energy and persistence conquer all things,’ Franklin was likely describing his own motivations to create and to succeed, using Schumpeter's formulation, for the joy of creating, of exercising one's energy and ingenuity, the will to conquer, and the joy of a good battle.”

So it is that the Dodge City DRM Marketplace/Search Engine is designed to serve the entrepreneur and creator as opposed to the capitalist and communist. While the media celebrates the youtube capitalist/communists who made millions off of aggregating others' content, the Dodge City DRM Marketplace/Search Engine will celebrate the indie artist and creator, by affording them the opportunity to protect and profit from their works, as well as fathering further innovation and inventions that serve the entrepreneur, the artist, and the creator.

### FURTHER PRIOR ART & ADVANTAGES OF THE PRESENT INVENTION

Ideas have consequences, and the repeated persecution of anyone who mentions DRM throughout academia have resulted in massive corporations and state bureaucracies making vast profits at the expense of the individual artist and art. Not only have movies gotten worse in Hollywood, and the literature and books of the land declined in quality—long-term investments, but elite groups of cynical, snarky insiders have profited immensely.

The snarky mutual fund administrator class, which risks all of our money while profiting off of our parent's pensions, is one and the same as the elite contortionists who trample individual rights, so as to enrich a few at the expense of the many. Contemporary MBA programs and law schools are training the elite insiders to never question the big lies. After graduating from gutted undergraduate programs, and taking the soulless GMAT and LSAT, the youngsters are ripe to join the corruption. It is no coincidence that the rise of the MBA and JD programs have coincided with massive bubbles, and the tragic the decline in the indie artist's rights.

Without a moral context, without Shakespeare and the Bible in their hearts; and Dante, Adam Smith, Hayek, and Freidman in their souls, it is easy for young bankers and lawyers to see the masses as those who are to be exploited for ther own personal profit. It is easy for Lessig to advance his socialistic utopia, and make no mistake-socialism by any other name would still be communism.

The Dodge City DRM Marketplace/Search Engine reminds us of the divine property rights that are far more sacred than even titles to land. For Shakespeare teaches us

### Throws up another skull

### Hamlet

There's another: why may not that be the skull of a lawyer? Where be his quiddities now, his quillets, his cases, his tenures, and his tricks? why does he suffer this rude knave now to knock him about the sconce with a dirty shovel, and will not tell him of his action of battery? Hum! This fellow might be in's time a great buyer of land, with his statutes, his recognizances, his fines, his double vouchers, his recoveries: is this the fine of his fines, and the recovery of his recoveries, to have his fine pate full of fine dirt? will his vouchers vouch him no more of his purchases, and double ones too, than the length and breadth of a pair of indentures? The very conveyances of his lands will hardly lie in this box; and must the inheritor himself have no more, ha?

For while titles to land are easily transferred, the title of the book is forever owned by the author. The sacred act of creation is the source of all wealth, for without ideas, what would land, or anything else, be worth? Were it not for the patent system, how would we farm the land, or transport the food that s grown there? The Dodge City DRM Marketplace/Search Engine allows the indie creator to protect and profit from their ideas in a new, and superior manner, thusly encouraging a renaissance.

Nicholas G. Carr blogs at, http://www.roughtype.com/archives/2006/10/web_{—}20ier_than.php: “But Lessig isn't really interested in describing the world as it is. His eyes are on a further goal. He wants to redefine “Web 2.0” in order to promote a particular ideology, the ideology of digital communalism in which private property becomes common property and the individual interest is subsumed into the public interest—in which we become the web and the web becomes us.”

Nickola G. Carr continues contines, “The process of social enlightenment always begins with the reshaping of language. According to Lessig, Web 2.0 is not, as you might have assumed, a technological or a business term. It's an ethical term, a moral term. Differences “in business models,” he writes, “should be a focus of those keen to push the values of Web 2.0.” In a gloss on Lessig's post, Joi Ito writes that “we can't really expect users to initially understand the distinction [between real sharing and fake sharing].” But “in the long run, users will understand that stand-alone or closed services do not allow them the freedoms that are becoming exceedingly more common in the Web 2.0 area.” It is hard not to hear the echo of Mao patiently explaining how the masses will make the transition from China 1.0 to China 2.0: Because of their lack of political and social experience, quite a number of young people are unable to see the contrast between the old China and the new, and it is not easy for them thoroughly to comprehend . . . the long period of arduous work needed before a happy socialist society can be established. That is why we must constantly carry on lively and effective political education among the masses and should always tell them the truth about the difficulties that crop up and discuss with them how to surmount these difficulties.”

Basically Lessig plays the classic card of the none-creator—the rights of the individual must be sacrificed for the greater good of humanity. Although we all know where that leads, it's fun to keep trying. Pockets of elite Orwellian cynicism will always prosper in capitalistic systems, just as long as they never succeed in undermining the moral tenets of capitalism and the US constitution. For, as Saint Thomas Aquinas said, “Good can exist without evil, whereas evil cannot exist without good.”

Carr offers another excellent blog post supporting the moral premise of the Dodge City DRM Marketplace/Search Engine is http://www.roughtype.com/archives/2005/10/the_amorality_o.php “In ‘We Are the Web,’ Kelly writes that “because of the ease of creation and dissemination, online culture is the culture.” I hope he's wrong, but I fear he's right—or will come to be right. Like it or not, Web 2.0, like Web 1.0, is amoral. It's a set of technologies—a machine, not a Machine—that alters the forms and economics of production and consumption. It doesn't care whether its consequences are good or bad. It doesn't care whether it brings us to a higher consciousness or a lower one. It doesn't care whether it burnishes our culture or dulls it. It doesn't care whether it leads us into a golden age or a dark one. So let's can the millenialist rhetoric and see the thing for what it is, not what we wish it would be.”—http://www.roughtype.com/archives/2005/10/the_amorality_o.php

Indeed, the advancement of culture is not the realm of the Web 2.0 groupthinkers, and the groupthinkers rarely understand the value of the moral individual, and most often oppose them. The Dodge City DRM Marketplace/Search Engine allows the moral individual to protect and profit from their content, and is thus an innovation that can advance culture by creating both monetary and spiritual wealth.

No prior art, nor any entity at any of the most prominent technology conferences, including (sxsw.com/interactive/) and web 2.0 con (http://www.web2con.com/pub/w/40/coverage.html) has yet suggested offering a stand-alone software application, either on the desktop or the web, that offers the creator a full spectrum of digital rights management options. No prior art has yet suggest an application that offers watermarking options, syndication options. No prior art, nor any entity at any of the most prominent technology conferences, including (sxsw.com/interactive/) and web 2.0 con (http://www.web2con.com/pub/w/40/coverage.html) has yet suggested offering the creator a full spectrum of digital rights management for free. DRM ought to be free, as it is based on mathematical algorithms which are free as the wind.

Indeed, when I asked about providing creators with a full-spectrum of DRM options at SXSW, my question was met with groans throughout the crowd, as I knew it would be, for fanboys generally march in lockstep. I was just trying to demonstrate that leading expert opinion countered the spirit of this present invention. One panel went on to say that DRM is bad, but that iTunes is good even though it uses DRM, because some men are more equal than others. The creator is not to be trusted with something as dangerous as DRM in these contexts—only Steve Jobs is allowed to use DRM, because he is cool and hangs out with Bono, and because he is working with the major labels, who deserve more and better rights than the individual and indie artists, where, by the way, all major-label artists originate. But Larry Lessig has proclaimed that the indie artist is no longer needed in Web 2.0 business plans that benefit the bankers and aggregators over the creators and indie artists, and thus, that indie artists no longer need their Constitutional rights. Rising rap bands and metalheads must be denied the right to use DRM according to present expert opinion elaborated on throughout this present disclosure of invention.

The Dodge City DRM Marketplace/Search Engine stand-alone DRM application provides a new mechanism and means for artists to get their content to as wide an audience as possible. It can sit next to any content creation/editing/manipulating application, and then embed rights descriptions within it. The present invention allows the artist to ride into any town and charge what they want for their content.

Nicholas Carr writes the following on his blog, “What's being concentrated, in other words, is not content but the economic value of content. MySpace, Facebook, and many other businesses have realized that they can give away the tools of production but maintain ownership over the resulting products. One of the fundamental economic characteristics of Web 2.0 is the distribution of production into the hands of the many and the concentration of the economic rewards into the hands of the few. It's a sharecropping system, but the sharecroppers are generally happy because their interest lies in self-expression or socializing, not in making money, and, besides, the economic value of each of their individual contributions is trivial. It's only by aggregating those contributions on a massive scale—on a web scale—that the business becomes lucrative. To put it a different way, the sharecroppers operate happily in an attention economy while their overseers operate happily in a cash economy. In this view, the attention economy does not operate separately from the cash economy; it's simply a means of creating cheap inputs for the cash economy.”—http://www.roughtype.coin/archives/2006/12/sharecropping_t.php

Nicholas's insight again supports the Dodge City DRM Marketplace/Search Engine. Whereas the Web 2.0 companies deny fundamental moral, economic, and Constitutional rights to the creator, the Dodge City DRM Marketplace/Search Engine provides these rights.

Although Google's mantra is “do no evil,” sometimes doing no evil is not enough. Sometimes one has to take a stand and do good, for “liberty requires eternal vigilance.” The present invention—the Dodge City DRM Marketplace/Search Engine-provides that eternal vigilance. Einstein said, “The world is a dangerous place. Not because of the people who are evil; but because of the people who don't do anything about it.” The Dodge City DRM Marketplace/Search Engine allows the indie creator to do something about it. George Orwell said, “People sleep peaceably in their beds at night only because rough men stand ready to do violence on their behalf.” The Dodge City DRM Marketplace/Search Engine allows indie creators to take the law, and their destiny, into their own hands. Martin Luther King Jr. said, “He who passively accepts evil is as much involved in it as he who helps to perpetrate it. He who accepts evil without protesting against it is really cooperating with it.” The Dodge City DRM Marketplace/Search Engine helps guard against the fundamental crime of theft. Finally, Nietzsche said, “Evil men have no songs.” The present invention—the Dodge City DRM Marketplace/Search Engine—allows men with songs—the indie artists—to protect their content against the legions of lawyers and MBAs with no songs.

You will never find the postmodern lawyers citing the Declaration of Independence which states, “We hold these truths to be self-evident, that all men are created equal, that they are endowed by their Creator with certain inalienable rights, that among these are life, liberty and the pursuit of happiness.” Nor will you find the lawyers citing the Constitution, which simply states, “The Congress shall have power to . . . promote the progress of science and useful arts, by securing for limited times to authors and inventors the exclusive right to their respective writings and discoveries;” Instead the postmodern lawyers cite Larry Lessig, who never acknowledges a Creator, and who insists that we must legislate against DRM, and thus property rights. Larry is a huge hit amongst technology companies, as they profit greatly from the artist's content being traded, downloaded, copied, and consumed. You will never see a modern lawyer citing Albert Einstein, as after three years of law school, there is little room left in one's mind for the simple and profound eloquence of The Declaration of Independence, The Constitution, and Albert Einstein, who said:

“The highest principles for our aspirations and judgments are given to us in the Jewish-Christian religious tradition. It is a very high goal which, with our weak powers, we can reach only very inadequately, but which gives a sure foundation to our aspirations and valuations. If one were to take that goal out of its religious form and look merely at its purely human side, one might state it perhaps thus: free and responsible development of the individual, so that he may place his powers freely and gladly in the service of all mankind . . . There is no room in this for the divinization of a nation, of a class, let alone of an individual. Are we not all children of one father, as it is said in religious language? Indeed, even the divinization of humanity, as an abstract totality, would not be in the spirit of that ideal. It is only to the individual that a soul is given. And the high destiny of the individual is to serve rather than to rule, or to impose himself in any other way.”—Albert Einstein, Einstein's Ideas and Opinions, pp. 41-49.

There you have it from Einstein, and yet Stanford and Harvard Law Schools refuse to teach the simple precepts of the Jewish-Christian religious tradition, including “thou shalt not steal,” as such simple premises hinder lawyers from coming up with little turns of phrases, and cutesy-wootsey-tootsey-snarky-snark-terms to transfer the vast wealth of the artist's creations into their pockets.

The act of entrepreneurship is based upon the common moral premise that forms the foundation of the following quotes—individuals embarking on a hero's journey so as to better serve their peers.

“The classic system—owner's capitalism, had been based on a dedication to serving the interests of the corporation's owners in maximizing return on their capital investment. But a new system developed—manager's capitalism—in which, Pfaff wrote, “The corporation came to be run to profit its managers, in complicity if not conspiracy with accountants and managers of other corporations.”—John C. Bogle, Founder and Former Chairman of The Vanguard Group, The Battle for The Soul of Capitalism

“There's a difference between us. You think the people of this land exist to provide you with position. I think your position exists to provide those people with freedom. And I go to make sure that they have it.”—William Wallace in Braveheart, by Randall Wallace “Man should not be in the service of society, society should be in the service of man. When man is in the service of society, you have a monster state, and that's what is threatening the world at this minute.”—Joseph Campbell, author of Hero With a Thousand Faces

Larry Lessig believes that the artists must exist to serve the State and the Corporation. And he sends forth his Agent Smiths in the form of lawyers to snark the Neos and common cubicles, to keep them harnessed to the machine wherein they are never allowed to protect and profit from their creations. Vast and great ceremonies are held to Sanctify the Saint of the State and the Corporation, and the insiders feel good about themselves and their future, where they shall live off the labors of the artists and creators—letting everyone else take the risk and do the work, and reaping the rewards themselves, in their sanctified bureaucracies. The only long-term downside to this system is that the bureaucrats never create art, and as they move into power, inevitably they seek the glory that the artist alone knows, and they have to create both creative writing curriculums to administrate the arts and make it better serve the State, and American Idol, so that art can better serve the corporation. So it is that the culture must decline as artist's rights are destroyed.

In his book, The Trouble With Physics: The Rise of Physics, The Fall of Science, and What Comes Next, the famous physicist Lee Smolin states that String Thoery's nonsense can be attributed to a deep-rooted jealousy in the mathematical geeks who got picked on in high school. I am not kidding. So it is that as revenge they created string Theory to enrich themselves. In much the same way, lawyers see others creating beauty, and they must join the cause to diminish it, to deconstruct it, to copy, trade, and profit from it. The pay vast and great respect to the wisdom of their crowds, forgetting to pay homage to all the prophets and poets who were persecuted by the “wisdom of crowds” including Socrates, Jesus, Martin Luther King Jr., Bob Dylan, James Joyce, and countless other risk-takers and wealth-creators. So it is that the past was prologue, and history repeats itself via the immortal bureaucrat's short-sighted, self-serving misunderstanding and ignorance of what it takes to create art—of the blood, sweat, and tears that accompany the relentless pursuit of Truth and Beauty. And so the lawyers pervert entreprneurship's fundamental premise—the risk taker—the artist, innovator, and inventor, ought get the reward. The Founding Fathers understood this, as did Mark Twain, who quoted the Bible and the Constitution in when speaking before congress regarding Copyright Law. “Thou shall not steal,” says it simply enough, and the Founding Fathers recognized the right of the artist and inventor to own and profit from that which they create. But with three years of law school, the postmodern lawyer learns the degraded art of saying one thing while meaning another, the degraded art of complexifying and obscuring the simple, the degraded art of reducing higher logic and reason to rubble via assaults of emotion and feelings and snarkety-snark games, and the degraded art of exalting themselves by perpetually saying “yes-we are working on DRM system that serves the artists,” when they are doing the exact opposite, and by trying to take credit for all innovations by waiting until the inventor announces it, and then saying, “oh—yes we did that years ago, and as there are more of us than you, we must be right, for this is a democracy. Are you against democracy? Do you also hate women? Why is it then that you deny that a woman invented this before you?”

The pomo-hipster lawyers, as socialists studying to become communists, must create and perpetuate pernicious myths so as to sanctify the Almighty state. As they are uncreative and fruitless, they must make vast virtues out of the inability to create and bear fruit. They must criminalize the individual creator, as the indie creator can never be seen as the fount of wealth, for that would diminish the role of the State, from where all divine benevolence and lasting wealth does flow. The Nobel Laureate's F. A. Hayek's book The Road to Serfdom has two chapters called The End of Truth and Why The Worst Get on Top, and The Road to Serfdom is never required in any law school class, as it takes all the fun out of ending the truth so as to allow the worst to get on top. The Duke Law School created the world's greatest author—A Prominent Hipster Author—and A Prominet Content Aggregator, where there is power in numbers, was the first to publish his greatness where he reports on video taping anal sex without the girl's knowledge that it is being taped, and then makes up a story about how the tape got broken or lost or something. And there's that story about midgets too, which some would say is more about jumping the shark than anything else. In the same way the A Prominent North American Software Developer, not to be confused with Centos, relied on a veritable bubble to fund A Prominet Content Aggregator with millions of dollars to publish and promote A Prominent Hipster Author, the boomer elite took the dollar off the gold standard and placed it on the porn standard. Once upon a time, on the old system, a working man could afford a home—a family and a wife and children, but on today's new porn standard, and bubble-driven economy which enriches Wall Street insiders, he can't even afford a house. The good news is that the Renaissance shall yet be, as Odysseus makes it on home and slays all the false suitors, trying to buy Penelope's eternity with porn, communism, socialism, corrupt crony capitalism, snarky-insiderism, degraded literature, the banishment of the classic western, the deconstruction of the Great Books and Classics, the destruction of the family, the devastation of the handshake, the perversion of Truth, the exaltation of the petty lawyer and bureaucrat over the prophet and poet, the pillaging, plundering, and burning of academia, the massive growth of government bureaucracies, and the wholesale destruction and banning of the Truth and Beauty in Dante's Inferno, Homer's Odyssey and The Bible to make way for Simon Cowell's, Larry Lessig's, and A Prominent Hipster Author's brave new world—facebook reports that A Prominent Hipster author is so two years ago—he is a product of the feminist movement which destroyed classical fatherhood, so beautifully rendered in the Odyssey within the exalted relationship between Telemachas and Odysseus, pornified the world with cheap, gaudy, degraded art, and exalted anal as the new black. Ye shall know them by their fruits, and it makes sense that postmodern law students from Duke and Stanford alike will detest the cultural renaissance that will halt the Wall Street scandals, exalt the academies of learning, and bring back movies such as Sergio Leone's masterpieces including A Fistful of Dollars and The Good, The Bad, and The Ugly. For from Homer on down, everlasting art has ever been defined by the lone cowboy facing down the perverted multitudes-forgiving them for their vast and degraded perversions and crimes against God and Man.

The present invention, by allowing artists and authors to protect and profit from their creations in novel and exalted manners, will foster a vast and resounding artistic and cultural renaissance, which will reward us all in ways that cannot be counted down in dollars from the mint. The present invention, by organizing a freewheeling marketplace of DRM options, will place the artist, author, and entertainer in the driver's seat. The vast value of this present invention—a DRM marketplace—cannot be underestimated.

As the individual is the wellspring of all lasting wealth, as well as their own personal happiness, that system which best provides and protects the moral indvidual's rights works best in creating long-term wealth. All too often the solutions to the digital rights management marketplace is framed as the record labels' fancy schmancy lawyers versus Larry Lessig and socialist laywers with clever phrases. Companies with hundreds of billions in market capitalization rely on snarky hipster lawyers degrading artists rights, and they will fund, directly and indirectly, all the surrounding media, magazines, blogs, and pundits who oppose artists rights and gain entry into the Party. But still, though tossed upon the ocean and swept astray by the Sea, Odysseus sails on towards home. And there will come that day of reckoning, when Johnny Cash's man comes around, and faces down Simon Cowell in the showdown of all showdowns.

In the long run, as technology continues its natural trajectory, commoditizing the tools of production and distribution, the lawyers will be displaced by the freedom fro artists to choose how to protect and profit from their creations. As this present invention bypasses both the record companies and Larry Lessig, as it bypasses Steven Jobs, and Time Warner, and Google's Youtube, and Fox's Myspace, this invention is written for a future age that realizes the true leveling glory of the internet—the freedom for the creator to protect and profit from their content in a free marketplace of DRM, where DRM providers and distributors compete for the right to distribute the long-term wealth of the internet—the art—the films, music, photography, and more.

Einstein wrote, “The highest principles for our aspirations and judgments are given to us in the Jewish-Christian religious tradition. It is a very high goal which, with our weak powers, we can reach only very inadequately, but which gives a sure foundation to our aspirations and valuations. If one were to take that goal out of its religious form and look merely at its purely human side, one might state it perhaps thus: free and responsible development of the individual, so that he may place his powers freely and gladly in the service of all mankind . . . There is no room in this for the divinization of a nation, of a class, let alone of an individual. Are we not all children of one father, as it is said in religious language? Indeed, even the divinization of humanity, as an abstract totality, would not be in the spirit of that ideal. It is only to the individual that a soul is given. And the high destiny of the individual is to serve rather than to rule, or to impose himself in any other way.”—Albert Einstein, Einstein's Ideas and Opinions, pp. 41-49.

The Web 2.0 hypesters, who talk a lot about open content, open source, and sharing, but then go out and trademark the term Web 2.0 and send nasty letters to others who use the phrase, have a lot in common with the Wall Street bankers who live off of exorbitant fees for managing money while failing on average to beat the market. So many people these days profit from conscienceless, superficial, degraded hype, where the journalists, MBAs, and lawyers all go to the same schools, sign secret pacts to exploit the masses, and then dedicate their lives to ripping off the people with snark, cutesy turns of phrases, outright theft, cover-ups, creative accounting, duplicitous statements, the pornification of the culture, the destruction of the family and classical ideals, the burgeoning of bungling bureaucracies, and forth forms of deconstruction and devastation.

The profiteers on high have a lot in common with the managers described in John Bogle's classic, The Battle for The Soul of Capitalism. In Investment Wisdom and Human Values, Remarks by John C. Bogle, Founder and Former Chairman, The Vanguard Group, “Principles of Economics” at The United States Military Academy, West Point, N.Y., Apr. 6, 2006, John C. Bogle writes,

“In my new book, The Battle for the Soul of Capitalism, published by Yale University Press last November, I express the view that in the recent era, “the business and ethical standards of corporate America, of investment America, and of mutual fund America (the three principal elements of the book) have been gravely compromised.” In each section, I discuss not only what went wrong, but why it went wrong, and how to go about fixing it.”

“Today's capitalism, I believe, has departed, not just in degree but in kind, from its proud traditional roots, a system that served us, admittedly imperfectly but with remarkable effectiveness, for the better part of the past two centuries—a free enterprise system based on open markets and private ownership, and on trusting and being trusted. The system worked. Or at least it did work. And then, late in the 20th century, something went wrong, a “pathological mutation in capitalism,” in which the classic system—owners' capitalism, based on a dedication to serving the interests of the corporation's owners in maximizing the return on their capital investment-morphed into a new system—managers' capitalism, in which “the corporation came to be run to profit its managers, in complicity with accountants and the managers of other corporations. The change came in large measure because the markets had so diffused corporate ownership that no responsible owner exists—a corruption of capitalism itself.”

“Once an “ownership society” in which direct owners of stock held voting control over corporate America, we have become an “agency society,” and we are not going back. The move to an agency society has been massive and unrelenting. In 1950, direct individual owners of American business held 92 percent of all stocks, and institutional agents but 8 percent. Today, institutions own 68 percent of all stocks, and individuals just 32 percent. Averaging as it may seem, our 100 largest financial institutions—with 56 percent of all stocks-hold effective control of our corporations. While we have revolutionized our ownership structure, we have to change the rules of the game.”

“As a result, these agents-largely mutual fund managers and pension fund trustees—have failed to represent, first and foremost, their principals—pension beneficiaries and owners of mutual fund shares. Our corporate CEOs and our investment managers have consumed far too large a portion of whatever returns our corporations and our financial markets were generous enough to provide, with far too small a portion of these returns delivered to the last-line investors who have put up all of the capital and assumed all of the risks, with dire consequences. Let me explain by turning to the simple ABCs of investing.”

As a good friend with all the Wall Street managers and Bankers, Larry Lessig is only doing his part to lessen the ownership abilities and rights of the artists, so as to enrich his uncreative (except for when it comes to creative accounting) Wall Street friends who back the multi-billion dollar companies that have willingly, gleefully, and joyfully failed to provide the artists and creators with a system such as the present invention, which would allow the artists and creators to protect and profit from their creations.

Indeed, it is the same theme played out time and time again, like a band of lawyers that knows but one offkey song. Transfer all the rewards to the lawyers, bureaucrats, and insiders via snark, hype, little creative twists in accounting, deception, the desecration of our classical heritage, and the pretended glory of “social entrepreneurship” and “social consciousness:” which masks the fifty million killed via abortion, the trillions upon trillions transferred to the postmodern elite, and the quiet, but sordid transformation that has taken us from Johnny Cash and Bob Dylan to Simon Cowell, Boy Bands, Lindsay Lohan, and Britney Spears. Spectacle is placed before story as Aristotle is turned upside down, lies are placed before truth, hype before reality, and as our poor, banned Aristotle said, “when storytelling declines, the result is decadence.”

So it is that I have come forth to remind the lawyers and bureaucrats that there is a new sheriff in town, and that it is more important to serve the higher ideals than the bottom line. The artists shall have their natural rights represented and exalted by future technologies contained in this present invention and others. The only way to stop this will be to alter the Constitution, or destroy the language to such an extent that only soulless lawyers are able to comprehend the deep, dark degradation. We can call that circle hell, but even so, artists will be born who will aspire towards Beatrice, even though they are born in the vast depths of the postmodern bit the postmodern boomer elite are willing upon us, as they finish remaking the world in their own image.

The present invention, by providing trusted brand that affords artists and creators the maximum possible protection and opportunities to profit from their work, will stand head and shoulders above the prior art. The present invention, by fostering a system wherein DRM providers and device makers compete directly to best meet the needs of artists and serve their rights definitions, will allow exalted and improved DRM standards to emerge. The present invention, by bypassing the legions of snarky lawyers with comic books and Creative Commons licenses, will allow artists to create tomorrow's cultural renaissance, independent from the grisp and grasp of the diabolical boomers, who wish not to build a renaissance, but only grow the government and absorb our wages, tuition, and tax dollars in their retirement programs, forcing Simon Cowell and degraded rap lyrics upon all, so as to further destroy the family and boost the temporary bottom line by destroying trust and the sacred amongst men and women.

Though this invention will result in profits that can be counted down in immediate dollars from the mint, the long-term wealth creation shall be even greater, as it fosters an artistic and intellectual renaissance, allowing artists to protect and profit from their creations and celebrate the sacred rights recognized in the Declaration of Independence and Constitution.

While Dave Eggers cavorts around San Francisco writing books lacking plots and characters and fake amazon reviews to put a smiley face and the socialist agenda which opposes digital rights management that would allow tomorrow's author's to protect and profit from future classics penned in the context of the classics. Together with Nancy Pelosi, they cut funding for the troops as they enjoy the luxurious gift of freedom given by the troops. Jack Bogle eloquently reminds us,
“In the recent stock market bubble, we witnessed the culmination of an era in which our business corporations and our financial institutions, working in tacit harmony, corrupted the traditional nature of capitalism, shattering both confidence in the markets and the accumulated wealth of countless American families. Something went profoundly wrong, fundamentally and pervasively, in corporate America. At the root of the problem, in the broadest sense, was a societal change aptly described by these words from the teacher Joseph Campbell: “In medieval times, as you approached the city, your eye was taken by the Cathedral. Today, it's the towers of commerce. It's business, business, business.” We had become what Campbell called a “bottom-line society.” But, as I added, “our society came to measure the wrong bottom line: form over substance, prestige over virtue, money over achievement, charisma over character, the ephemeral over the enduring, even mammon over God.”
These words may seem strong, but I expressed the idea far more strongly two years ago in this self-explanatory letter to the editor of The Wall Street Journal:
“After reading your article about the ($185 million) compensation package recently paid to Richard Grasso, President of the New York Stock Exchange, his blistering op-ed response, and your editorial—and whatever all that petty bickering suggests about sums so enormous that few Americans can even imagine them—I read Michael Phillips' moving front-page story about the selfless heroism of Cpl. Jason Dunham in Iraq. I lingered on his every word, every moment, every explosion, every turn for the worse, every hope for survival. And then the devastating news:At 4:43 p.m. on April 22, Marine Cpl. Jason L. Dunham died.
“Look, I'm just a businessman. And a Republican too. But I hope and pray that all of us who have basked in the glorious financial excesses of modern-day managers' capitalism will take a brief timeout from all of our getting and our self-important lives, get down on our knees, and say a prayer for those who have given—sadly, on our behalf—what Lincoln called “the last full measure of devotion.”
“I pray that none of you here today will be called upon to give that last full measure of devotion to the fine nation you proudly serve. But even after today's clouds have passed—as they will—I also hope you will join the millions of other young men and women of your generation who share your values and your commitment. As I say in my new book, dedicated to my twelve grandchildren (five of whom are your contemporaries): “My generation has left America with much to be set right; you have the opportunity of a lifetime to fix what has been broken. Hold high your idealism and your values. Remember always that even one person can make a difference. And do your part ‘to begin the world anew.’”

If soldiers are giving their lives for the Constitution, does it not fall upon we the living to protect that Constitution, and to afford artists and creators opportunities to protect and profit from their creations as the Living Spirit of the Constitution exhorts us to? If soldiers are giving their lives—“that last full measure of devotion”—for the Constitution, should not lawyers do all that is humanly possible to support the Constitution, and allow artists to protect and profit from their creations, rather than devising snarky, underhanded systems that transfer billions more to the Wall Street insiders, while eroding artist and creator's rights, along with epic story, exalted culture, and the glorious moral tales in the Great Books and Classics which include Aristotle's third act of justice rendered? This invention offers a portal to a new era, wherein lawyers and mbas can profit in a far greater manner via serving the higher ideals instead of the bottom line.

A Prominent Hipster Author is sold to us as the new manhood by men such as A Prominent CEO, just as Britney Spears is the new womanhood, but they are all lying—all the hypesters and superficial bottom line, mob-rule supposed leaders. The pomo hipster boomer, and their useful idiots, detest Odysseus and Penelope, Beatrice and Dante, Steve Mcqueen and Audrey Hepburn, as they profit from the destruction of the home and the family, and the growth of the corporation and the State. A Prominent Hipster author has nothing in common with true men such as John Wayne, Sergio Leone, The Man with No Name, Steve McQueen, Dante, and Odysseus, and he is but a remnant of a deconstructed culture where the leftist faculty rage and blow and eradicate the Great Books and Classics. Were it not for Joyce Carol Oates and Tony Morrison pumping feminized, soulless, snarky brownnoser prep-school kids into New York publishing houses for the past thirty years, exalted literature such as Autumn Rangers would be widely read and appreciated. But in this lawyerized, mbaized, mfaized, dumbed-down culture, we are stuck with degradation, reality TV, plotless, soulless seventies remakes, story-by-committee video game movie flops, heartless, soulless video games, and a culture in decline, for Aristotle said, “When storytelling declines, the result is decadence.” On eternity's level playing field, A Prominent Hipster author and Simon Cowell has not a chance against Dante, Johnny Cash, and The Odyssey—Simon is but the God of the academic bureaucrats, the degraded MBA/MFAs who have set up shop to pillage and plunder tax, tuition, and pensions in Odysseus's absence. But Odysseus is sailing on home, and the rising generation shall have an exalted literature which inspires the soul with classical archetypes rendered in living stories that perform eternity's ideals in the contemporary context. All those in favor, say “yeah!” All those opposed—may you be forgiven by the rising generation.

Degraded art and degraded rights walk hand-in-hand, the lawyers preferred method of avoiding piracy sometimes seems to be the removal of story from art, along with the removal of incentive to pirate it. Degraded art and degraded rights are the hobgoblin of small minds, who take great pride in filling out endless tax forms and exalting the minute letter of the law over the greater spirit, like tens of thousands of Lilliputians tying down Gulliver. Like moths to a flame, the small-souled and weak-minded gravitate towards postmodern law schools, and with ambitions overshadowing their talents, they are seduced by the snarl, deception, twistings, and contortions by which they can make a living furthering the decline, and transferring other's wealth to themselves, and the risk of the universe unto the shoulders of the creators and artists—the preachers, teachers, and lawyers. Few lawyers, schooled in the minutae of contemporary lawschool curriculums and classic-free undergraduate educations, will be able to comprehend these words, and their ignorance will grant them great incentive to destroy these words, but like little canoes against the rock of eternity, their efforts will fail. A man's gotta know his limitations.

The pomo hipster lawyers and literati hate Great Art. They force rap music on us, but deny us video games in which Odysseus returns on home, or the Man with no name, and singlehandedly slays every single rap artist and puffy middle-aged A Prominent Hipster Author/snarky/amoral economist/lawyer who dissed or degraded Penelope, pillaged or plundered pensions and savings with hype, and generally contributed to the massive cultural decline noted in title, after title, after title, from The Closing of The American Mind, to The Battle For The Soul of Capitalism,to Excellence Without Soul, How a Great University Forgot Education, penned by a Harvard dean. Now that would be an awesome game—a modern Odysseus returning on home from fighting for his country to kill all the suitors sleeping around with all the loose women, laying to waste his savings, wealth, and cultural heritage, pillaging his son's inheritance. Such a movie would lead to a parallel video game wherein one would have a chance to fight for something greater than oneself, to perform the classical ideals in the contemporary context—to return true manhood to the artistic realm—the manhood found in Homer's Odyssey, Dante's Inferno, Shakespeare, and the Bible. There will be vast demand for the movie and the video game, and thus this present invention, which provides a means and mechanism for a better DRM system, along with the Dodge City DRM Marketplace/Search Engine, will be a vast and great asset in the rising cultural renaissance which the legions of lawyers, creates in Larry Lessig's and A Prominent Hipster Author's amoral image shall bitterly and vehemently oppose, as hell hath no fury like a woman scorned.

Slashdot.org recently reported, BoredStiff writes “NYMag has up an article that explores Boss Science and the minds of American corporate leaders. In the real world, bosses are known to suffer from a long list of social pathologies: naked aggression, credit hogging, micromanaging, bullying, you name it. Leadership research shows that subtle nasty moves like glaring and condescending comments, explicit moves like insults or put-downs, and even physical intimidation can be effective paths to power. Research also shows that employees tend to see the jerk as boss material. The article goes on to discuss some of the science bosses apply to making an operation run smoothly: ‘A researcher reported that one law firm deconstructs its HR needs by personality traits. It insists on extremely bright employees who are also extremely insecure. ‘They want them to think that working really hard matters,’ he explains. Through this prism, personality types can even be mixed and matched to make a team function more efficiently.’”—http://science.slashdot.org/science/07/04/12/1950204.shtml

This is why the postmodern English teachers detest the third act and the MBAs detest the teaching of the classics, wherein the assholes get their asses handed to them. A Prominent Pomo-Hipster Dot Com CEO, who was called an asshole by a prominent content creator during a meeting, and who published self-proclaimed asshole A Prominent Hipster Author, is also famous for running his companies like gangs, pitting engineers against one-another, and claiming to support all sides so that we might claim victory after the bloody battle. You have to be an idiot to stay there, and such character never leads to lasting wealth, as it actually punishes honesty, generosity, hard work, and well-meaning behavior to profit off of assholish behavior and groupthink. But it is incapable of reversing the decline, and has no place in God's eternal Kingdom. Ye shall know them by their fruits, and their wretchedness shall condemn them to the ash heaps of history, as they are incapable of conceiving of and creating art that relies on the third act—art with the Showdown. They have banned the Classic Western, because A Prominent Hipster author fears Odysseus returning from defending his country, while A Prominent Hipster author stayed back and tried to hook up with his wife. Protected by the decadent media empires and A Prominent CEO's millions, the A Prominent Hipster authors of the world have their moment, but Odysseus is sailing on home, along with tomorrow's cultural renaissance, and technological renaissance, which shall foster a rebirth of the Classic Western, tomorrow's Johnny Cashes, Audrey Hepburns, and Sergio Leones. Sergio's Spaghetti Westerns were anything but postmodern, as The Man With no Name, reunites the family and slays the ruthless outlaws. This is why A Prominent CEO & A Prominent Hipster author detest the classic western, and instead prefer to profit via degradation and mob-rule. But what does it profit a man to gain the world and lose their soul?

And the rising generation—the students—yearn for the Classics—for The Odyssey and Dante's Inferno, for Adam Smith, Thomas Jefferson, and Benjamin Franklin. Not for Max/Young/Lessig who only exist in these degraded times because these degraded times have been degraded by short-term corruptors such as themselves—those incapable of string eternity's bow. Indeed they and their mobs may have to need for a DRM system, but tomorrow's creators of classical art-movies echoing the ideals in the Ten Commandments, Ben Hur, A Fistful of Dollars, The Good, The Bad, and The Ugly, Star Wars, The Lord of The Rings, Braveheart, and 300, shall need DRM systems, and the people will be more than happy to pay for the content. In today's degraded artistic age, it is easy to convince people that DRM is not necessary, as who wants to pay for Max/Young/Lessig/Cowell's creations?

Few and far between are great economists such as F. A. Hayek and Milton Friedman and Adam Smith, who deal not with the mathematical equations that allow us to take our eyes of those things that really count, letting the “Geniuses” devise new ways to transfer the risk to the artist/worker/creator and the wealth to themselves, but who deal in the realm of moral philosophy, where they time and again recognize that wealth creation is a story told primarily by an individual set free in a system to protect and profit from their ideas. All too much funding goes towards the postmodern myth which always emphasizes blind obedience to the group instead of rational, independent thought. Even physics has been killed by the postmodern boomer elite—they killed it with string theory, which employs thousands of snarky physicists, but has resulted in bringing physics to a complete standstill. The postmodern boomer elite begin with a premise—we are geniuses—and they then recreate the world to suit it, from the dot-com bubble, to modern English departments, to the real estate bubble, to string theory. The psychological, political, and physical warfare waged against DRM is an extension of their utopia as they sing, “Come on people now, smile on your brother, everybody get together and try to love one-another,” while Simon Cowell chooses our greatest rockers and myspace and youtube profit off all the artists and creators without ever sharing a penny.

The moral imagination allows one to conceive of an entirely different universe, wherein DRM is not necessarily good nor bad, but it is every artist's choice. The technorati, MBA/lawyers, and double-speaking tech leaders such as Steven Jobs have failed to give us a system that allows the artist to simply and easily define their rights, and protect and profit from their work. The present invention, by allowing authors and artists to upload their work, and then requiring the ipod/zune/scandisk/dell player companies to compete to protect and distribute the content, will allow a DRM standard or standards which better serve the artists to emerge. The present invention properly commoditizes the commodities—the zune/ipod/itunes/yahoo music/napsters/mp3 players/online music stores/Microsoft drm/google drm/fairplay/apple drm, while respecting the divine uniqueness of the artist.

Prestigious lawyers from prestigious law schools, who made it through via lack of soul and character, who would rather see the baby cut in half than given to its rightful mother, will rage against this patent and invention. They may be in the pocket of one of the vast anti-artist/creator web/tech companies, or they may just be trying to get top honors by out-snarking all their peers on a blog, or they may recognize that their sustenance depends on ad hominem attacks, and while they profit immensely, it costs them little to lose their souls, as they never felt the sublime glory of their soul's Truth. And thus they take their Marching Orders from Wall Street-information wants to be free—DRM is bad, as DRM doesn't sell more ipods in the short-term, as we still have a lot of music created in an era whence artist got paid-artists such as Johnny Cash and Bob Dylan—but now there is no longer any need to develop and pay artists—everyone just upload your content to myspace/youtube/itunes. For while youtube sold for $1.6 billion, information just wants to be free. And thus those who create art must not and cannot and should not get paid. Only those who aggregate art ought get paid and be afforded the opportunity to have patents.

The present patent represents the dawning of a brand new day—a DRM marketplace wherein artists name their rights and their prices, and the zune/ipod/itunes/yahoo music/napsters/mp3 players/online music stores/Microsoft drm/google drm/fairplay/apple drm compete to serve the artists' wishes, granting artists the best deals for distribution. Over time, better DRM standards will naturally emerge in this free DRM marketplace. And thus that which all the lawyers and technocrats could not devise will be devised in an organic manner by the artists.

Here is the current state of the art, based on wikipedia's treatment of Dante's Inferno—as one reads it, it quickly becomes apparent why the current school systems, corporation, and government bureaucracies must ban the classis:

Wikipedia writes, “The Circles of Hell “Gianciotto Discovers Paolo and Francesca” by Jean Auguste Dominique Ingres. “The Barque of Dante” by Eugene Delacroix First Circle (Limbo). Here reside the unbaptized and the virtuous pagans, who, though not sinful, did not accept Christ. Here also reside those who, if they lived before the coming of Christ, did not pay fitting homage to their respective deity. They are not punished in an active sense, but rather grieve only their separation from God, without hope of reconciliation. The chief irony in this circle is that Limbo shares many characteristics with Elysian Fields, thus the guiltless damned are punished by living in their deficient form of heaven. Their fault was that they lacked faith—the hope for something greater than rational minds can conceive. Limbo includes green fields and a castle, the dwelling place of the wisest men of antiquity, including Virgil himself. In the castle Dante meets the poets Homer, Horace, Ovid, and Lucan. Interestingly, he also sees Saladin in Limbo. (Canto IV) Dante implies that all virtuous pagans find themselves here, although he later encounters two in heaven and one in purgatory.”

So it is that many bloggers cannot dream beyond Steve Jobs. They have not the Faith that would Allow them to believe in a greater system than iTunes, which only gives the artist a tiny percentage of each song sold, and is now, in its most recent iteration, being used as a tool to destroy DRM and artist's rights, so that the aggregators might better profit, replacing Johnny Cash and Bob Dylan's rights with Simon Cowel's smirk. This, my friend, is the first circle of Hell.

Wikipedia writes, “Beyond the first circle, all of those condemned for active, deliberately willed sin are judged by Minos, who sentences each soul to one of the lower eight circles. These are structured according to the classical (Aristotelian) conception of virtue and vice, so that they are grouped into the sins of incontinence, violence, and fraud (which for many commentators are represented by the leopard, lion, and she-wolf[2]). The sins of incontinence—weakness in controlling one's desires and natural urges—are the mildest among them, and, correspondingly, appear first:

Wikipedia writes, “econd Circle. Those overcome by lust are punished in this circle. These souls are blown about to and fro by a violent storm, without hope of rest. This symbolizes the power of lust to blow one about needlessly and aimlessly. Francesca da Rimini informs Dante of how she and her husband's brother Paolo committed adultery and died a violent death at the hands of her husband. (Canto V)”

In this circle, the pirates and freeloaders lust after free music, movies, and videos. They never steal computers not ipods from the store, as they are cowards, but cloaked behind the anonymity of the internet, they steal songs.

Wikipedia writes, “Third Circle. Cerberus guards the gluttons, forced to lie in the mud under continual cold rain and hail whilst being forced to consume their own excrement. Dante converses with a Florentine contemporary identified as Ciacco (“Hog”—probably a nickname) regarding strife in Florence and the fate of prominent Florentines. (Canto VI)”

These are the gluttons who must download hundreds of thousands of songs and movies, and the Wall Street pension and saving pilferers, who speck forth one thing and hold in their hearts another, serving the bottom line over the higher ideals, like Jonathan Edwards chasing ambulances to buy vast tracts of land so that Chapel Hill can raise taxes and kick all the workers and taxpayers off their land, so that the government might seize it, in the same way Lessig seeks to seize all of the wealth created by artist, creators, and filmmakers, and give it to his favorite Wall street-backed companies, distant lawyers, and the Kings of deconstruction, corruption, and deception. And too, it are the aggregator gluttons of the leftist web 2.0 companies, who want your tax and tuition dollars, as well as all your content. And then, when they take their Web 2.0 company public in the next bubble, they want your savings and pensions. All science and technology has become this—a mechanism to grow the government with agencies supporting theologies such as string theology—and to now and then give birth to companies that can be absorb massive amounts of tax incentives, government grants, and then be taken public and dumped upon the unsuspecting public. And as the family breaks up and morals decline, everyone wins. This is the third circle of Hell.

Wikipedia writes, “Fourth Circle. Those whose concern for material goods deviated from the desired mean are punished in this circle. They include the avaricious or miserly, who hoarded possessions, and the prodigal, who squandered them. Guarded by Plutus, each group pushes a great weight against the heavy weight of the other group. After the weights crash together the process starts over again. (Canto VII)”

Those who only ever serve the bottom line lie here. They had to deconstruct the Constitution to rob the artists of their fundamental Constitutional rights. They had to destroy the Creator's fundamental right to protect and profit from what they create, so that they—the aggregators, could profit in the piracy, sharing, hosting, and display of other's content. They hoard money and squander the culture, and always blame it on the people. A true leader's role is to appeal to the better angels of human nature, as did Abraham Lincoln, but the common leaders of our day and age appeal to the lowest common denominator. Incapable of higher art and Epic Story, they must profit from mob-rule, decline, and the deconstruction of the family, the handshake, eternal love, and higher art such as Dante's Inferno. But Dante's Inferno shall far outlive these temporary postmodern boomers who recreated the world in their image—with bubble after bubble after bubble, by finding abortion in the Constitution, and then ignoring the only place that the word “right” appears in the Constitution, and filling all the upper levels of our courts and financial institutions with all the soulless ambitious who excelled in the gutted law school and business school curriculums, where Homer, nor Dante, nor the Odyssey, nor Shakespeare, nor the Bible, is never taught. They shall send their manufactured lawyer/mba orcs after me for penning this patent, but bring it on—go ahead, make my day. It's one thing to take a man's artifical retina to rob the tax payers of tens of millions of dollars to fund a technology invented large by a lone physicist, and stolen by a corporation, but it's another thing to try and take his integrity. Go ahead—make my day.

Wikipedia writes, “Fifth Circle. In the swamp-like water of the river Styx, the wrathful fight each other on the surface, and the sullen or slothful lie gurgling beneath the water. Phlegyas reluctantly transports Dante and Virgil across the Styx in his skiff. On the way they are accosted by Filippo Argenti, a Black Guelph from a prominent family. (Cantos VII and VIII)”

Wikipedia writes, “The lower parts of hell are contained within the walls of the city of Dis, which is itself surrounded by the Stygian marsh. Punished within Dis are active (rather than passive) sins. The walls of Dis are guarded by fallen angels. Virgil is unable to convince them to let Dante and him enter, and the Furies threaten Dante. An angel sent from Heaven secures entry for the poets. (Cantos VIII and IX)”

This is where the relentless Wall Street hype machines of Simon Cowell, Microsoft, Fox, Google, Apple, Yahoo, and all the record labels battle one-another—fighting for that which isn't even theirs in the first place. The content belongs to the artist who creates it, and as the technology democratizes the production and distribution of content, we'll need less and less of google/youtube/itunes/Microsoft/myspace/record labels. The present invention will require all the aggregators—the true commodities—to compete for the right to distribute the artist's content.

Wikipedia writes, “Sixth Circle. Heretics are trapped in flaming tombs. Dante holds discourse with a pair of Florentines in one of the tombs: Farinata degli Uberti, a Ghibelline; and Cavalcante de' Cavalcanti, a Guelph who was the father of Dante's friend, fellow poet Guido Cavalcanti. (Cantos X and XI)”

This is where all the artless, godless lawyers, mbas, professors, and cultural czars gather in eternity, to discuss the latest episode of American Idol, and how it is a vast and great improvement over Johnny Cash, as A Prominent Hipster Author orders a beer.

Wikipedia writes, “Seventh Circle. This circle houses the violent. Its entry is guarded by the Minotaur, and it is divided into three rings: Outer ring, housing the violent against people and property, who are immersed in Phlegethon, a river of boiling blood, to a level commensurate with their sins. The Centaurs, commanded by Chiron, patrol the ring. The centaur Nessus guides the poets along Phlegethon and across a ford in the river. (Canto XII) Middle ring: In this ring are the suicides, who are transformed into gnarled thorny bushes and trees. They are torn at by the Harpies. Unique among the dead, the suicides will not be bodily resurrected after the final judgment. Instead they will maintain their bushy form, with their own corpses hanging from the limbs. Dante breaks a twig off of one of the bushes and hears the tale of Pier delle Vigne, who committed suicide after falling out of favor with Emperor Frederick II. The other residents of this ring are the profligates, who destroyed their lives by destroying the means by which life is sustained (i.e. money and property). They are perpetually chased by ferocious dogs through the thorny undergrowth. (Canto XIII) The trees are a metaphor; in life the only way of the relief of suffering was through pain (i.e. suicide) and in Hell, the only form of relief of the suffering is through pain (breaking of the limbs to bleed). Inner ring: The violent against God (blasphemers), the violent against nature (sodomites), and the violent against art (usurers), all reside in a desert of flaming sand with fiery flakes raining from the sky. The blasphemers lie on the sand, the usurers sit, and the sodomites wander about in groups. Dante converses with two Florentine sodomites from different groups: Brunetto Latini, a poet; and lacopo Rusticucci, a politician. (Cantos XIV through XVI) It is important to note that it was not Dante's position that all sodomites were destined for hell fire, for repentant sodomites can be found on the top of Mount Purgatory. Those punished here for usury include Florentines Catello di Rosso Gianfigliazzi, Ciappo Ubriachi, and Giovanni di Buiamonte, and Paduans Reginaldo degli Scrovegni and Vitaliano di Iacopo Vitaliani.”

The above circles require no explanation. The pomo hipsters know their crimes-crimes against Art and Nature—and they see their inescapable fates in the above words. So of course they will have to oppose this invention, in the same way a modern Wall Street accountant opposes math.

Wikipedia writes, “The last two circles of Hell punish sins that involve conscious fraud or treachery. The circles can be reached only by descending a vast cliff, which Dante and Virgil do on the back of Geryon, a winged monster represented by Dante as having the face of an honest man and a body that ends in a scorpion-like stinger. (Canto XVII)

Dante's guide rebuffs Malacoda and his fiends between bolgia five and six in the Eighth Circle of Hell, Inferno, Canto 21. Dante climbs the flinty steps in bolgia seven in the Eighth Circle of Hell, Inferno, Canto 26.Eighth Circle. The fraudulent—those guilty of deliberate, knowing evil—are located in a circle named Malebolge (“Evil Pockets”), divided into ten bolgie, or ditches, with bridges spanning the ditches:

### Bolgia 1: Panderers and seducers walk in separate lines in opposite directions, whipped by demons. (Canto XVIII)

### Bolgia 2: Flatterers are steeped in human excrement. (Canto XVIII)

Bolgia 3: Those who committed simony are placed head-first in holes in the rock, with flames burning on the soles of their feet. One of them, Pope Nicholas III, denounces as simonists two of his successors, Pope Boniface VIII and Pope Clement V. (Canto XIX)

### Bolgia 4: Sorcerers and false prophets have their heads twisted around on their bodies backward, so they can only see what is behind them. (Canto XX)

Bolgia 5: Corrupt politicians (barrators) are immersed in a lake of boiling pitch, guarded by devils, the Malebranche (“Evil Claws”). Their leader, Malacoda (“Evil Tail”), assigns a troop to escort Virgil and Dante to the next bridge. The troop hook and torment Ciampolo, who identifies some Italian grafters and then tricks the Malebranche in order to escape back into the pitch. (Cantos XXI through XXIII)
Bolgia 6: The bridge over this bolgia is broken: the poets climb down into it and find the Hypocrites listlessly walking along wearing gold-gilded lead cloaks. Dante speaks with Catalano and Loderingo, members of the Jovial Friars. It is also ironic in this canto that whilst in the company of hypocrites, the poets also discover that the guardians of the fraudulent (the malebranche) are hypocrites themselves, as they find that they have lied to them, giving false directions, when at the same time they are punishing liars for similar sins. (Canto XXIII)
Bolgia 7: Thieves, guarded by the centaur (as Dante describes him) Cacus, are pursued and bitten by snakes. The snake bites make them undergo various transformations, with some resurrected after being turned to ashes, some mutating into new creatures, and still others exchanging natures with the snakes, becoming snakes themselves that chase the other thieves in turn. (Cantos XXIV and XXV)
Bolgia 8: Fraudulent advisors are encased in individual flames. Dante includes Ulysses and Diomedes together here for their role in the Trojan War. Ulysses tells the tale of his fatal final voyage, where he left his home and family to sail to the end of the Earth. He equated life as a pursuit of knowledge that humanity can attain through effort, and in his search God sank his ship outside of Mount Purgatory. This symbolizes the inability of the individual to carve out one's own salvation. Instead, one must be totally subservient to the will of God and realize the inability of one to be a God unto oneself. Guido da Montefeltro recounts how his advice to Pope Boniface VIII resulted in his damnation, despite Boniface's promise of absolution. (Cantos XXVI and XXVII)
Bolgia 9: A sword-wielding devil hacks at the sowers of discord. As they make their rounds the wounds heal, only to have the devil tear apart their bodies again. Muhammad tells Dante to warn the schismatic and heretic Fra Dolcino. (Cantos XXVIII and XXIX)

### Bolgia 10: Groups of various sorts of falsifiers (alchemists, counterfeiters, perjurers, and impersonators) are afflicted with different types of diseases. (Cantos XXIX and XXX)”

And so we see that Odysseus, as great as he was, yet fell short of He who is Greater. But we would be quite happy if the pomo-hopsters at least aspired towards Odysseus, or read the Odyssey. It is not that long, and after having read it, along with the Constitution and Declaration of Independence, this patent application will make more sense. The boomer elite destroyed the classical context to make way for their reality dictated entirely by shadows dancing on walls in this postmodern cave called contemporary culture.

Wikipedia writes, “Satan is trapped in the frozen central zone in the Ninth Circle of Hell, Inferno, Canto 34. The Ninth Circle is ringed by classical and Biblical giants. The giants are standing either on, or on a ledge above, the ninth circle of Hell, and are visible from the waist up at the ninth circle of the Malebolge. The giant Antaeus lowers Dante and Virgil into the pit that forms the ninth circle of Hell. (Canto XXXI)

Ninth Circle. Traitors, distinguished from the “merely” fraudulent in that their acts involve betraying one in a special relationship to the betrayer, are frozen in a lake of ice known as Cocytus. Each group of traitors is encased in ice to a different depth, ranging from only the waist down to complete immersion. The circle is divided into four concentric zones:

### Zone 1: Caïna, named for Cain, is home to traitors to their kindred. (Canto XXXII)

Zone 2: Antenora is named for Antenor of Troy, who according to medieval tradition betrayed his city to the Greeks. Traitors to political entities, such as party, city, or country, are located here. Count Ugolino pauses from gnawing on the head of his rival Archbishop Ruggieri to describe how Ruggieri imprisoned and starved him and his children. (Cantos XXXII and XXXIII) Zone 3: Ptolomæa is probably named for Ptolemy, the captain of Jericho, who invited Simon Maccabaeus and his sons to a banquet and there killed them. Traitors to their guests are punished here. Fra Alberigo explains that sometimes a soul falls here before the time that Atropos (the Fate who cuts the thread of life) should send it. Their bodies on Earth are immediately possessed by a fiend. (Canto XXXIII)
Zone 4: Judecca, named for Judas the Iscariot, Biblical betrayer of Christ, is for traitors to their lords and benefactors. All of the sinners punished within are completely encapsulated in ice, distorted to all conceivable positions. Dante and Virgil, with no one to talk to, quickly move on to the center of hell. At the center is Satan, who has three faces, one red, one black, and one a pale yellow, each having a mouth that chews on a prominent traitor. Satan himself is represented as a giant, terrifying beast, weeping tears from his six eyes, which mix with the traitors' blood sickeningly. He is waist deep in ice, and beats his six wings as if trying to escape, but the icy wind that emanates only further ensures his imprisonment (as well as that of the others in the ring). The sinners in the mouths of Satan are Brutus and Cassius in the left and right mouths, respectively, who were involved in the assassination of Julius Caesar (an act which, to Dante, represented the destruction of a unified Italy), and Judas Iscariot (the namesake of this zone) in the central, most vicious mouth, who betrayed Jesus. Judas is being administered the most horrifying torture of the three traitors, his head in the mouth of Lucifer, and his back being forever skinned by the claws of Lucifer. (Canto XXXIV) What is seen here is a perverted trinity. Satan is impotent, ignorant, and evil while God can be attributed as the opposite: all powerful, all knowing, and good . . . The two poets escape by climbing down the ragged fur of Lucifer, passing through the center of the earth, emerging in the other hemisphere just before dawn on Easter Sunday beneath a sky studded with stars.”

And so we find Satan frozen in ice. Isn't it ironic—don't you think? And that is what it's all about—in the deepest level of hell are all the double-speaking ironists—those who have made a snarky living via snarky irony—whether they call themselves conservatives, liberals, religious, non-religious—they are always, always something far more sinister—the ironist. They believe in nothing but their appetites—they feel no trepidation nor nervousness nor humility before a higher power. They pay no respect to all the poets and prophets—all the Founding Fathers and those who penned the foundational documents that the Founding Fathers read. For know ye this—every classic survives but by one entity—the moral premise—the third act where the man with no name rides back into town to see that justice is done. And without that third act, there is no art, nor truth, nor justice—there is no life, nor love, nor freedom. Without that third act—where the Old Testament God thunders on down the mountain, where Odysseus returns on home to kill the corrupt suitors, where Socrates accepts his death along with the immortality of his Soul, where Jesus is resurrected as lightning splits the earth—without that third act, life has no ultimate meaning. Art embodying that third act—both classical and contemporary—is our most valuable asset, as when storytelling declines, the result is decadence. Art is the vessel of the immortal soul—the center and circumference of all justice—not case studies nor lawyer's opinions which are bought and sold for fees—but classic, enduring, rugged, glorious art. And thus artists are the natural fount of all higher and lasting wealth, and this invention is dedicated to them all.

All wealth ultimately derives from virtue, as Socrates reminds us:

“I therefore, O Athenians, should have acted in a dire manner, if, when those rulers which you had placed over me had assigned me a rank at Potidea, at Amphipolis, and at Delium, I should then have remained where they stationed me, like any other person, and should have encountered the danger of death; but that, when Divinity has ordered, as I think and apprehend, that I ought to live philosophizing, and exploring myself and others, I should here through fear of death or any other thing desert my rank. For this would be dire: and then in reality any one might justly bring me to a court of judicature, and accuse me of not believing in the Gods, in consequence of not obeying the oracle, fearing death, and thinking myself to be wise when I am not. For to dread death, O Athenians, is nothing else than to appear to be wise, without being so: since it is for a man to appear to know that which he does not know. For no one knows but that death may be to man the greatest of goods; but they dread it, as if they well knew that it is the greatest of evils. And how is it possible that this should not be a most disgraceful ignorance, I mean for a man to suspect that he has a knowledge of that of which he is ignorant? But I, O Athenians, differ perhaps in this from the multitude of men; and if I should say that I am wiser than some one in any thing, it would be in this, that not having a sufficient knowledge of the things in Hades, I also think that I have not this knowledge. But I know that to act unjustly, and to be disobedient to one more excellent, whether God or man, is evil and base. I shall never, therefore, fear and avoid things which for aught I know may be good, before those evils which I know to be evils. So that neither if you should now dismiss me, (being unpersuaded by Anytus, who said that either I ought not to have been brought hither at first, or that, when brought hither, it was impossible not to put me to death, telling you that if I escaped, all your sons studying what Socrates had taught them would be corrupted,) if besides these things you should say to me, O Socrates, we now indeed shall not be persuaded by Anytus, but we shall dismiss you, though on this condition, that afterwards you no longer busy yourself with this investigation, nor philosophise, and if hereafter you are detected in so doing, you shall die,—if, as I said, you should dismiss me on these terms, I should thus address you: O Athenians, I honour and love you: but I obey Divinity rather than you; and as long as I breathe and am able, I shall not cease to philosophise, and to exhort and indicate to any one of you I may happen to meet, such things as the following, after my usual manner. O best of men, since you are an Athenian, of a city the greatest and the most celebrated for wisdom and strength, are you not ashamed of being attentive to the means of acquiring riches, glory and honour, in great abundance, but to bestow no care nor any consideration upon prudence and truth, nor how your soul may subsist in the most excellent condition? And if any one of you should contend with me, and say that these things are the objects of his care, I should not immediately dismiss him, nor depart, but I should interrogate, explore, and reason with him. And if he should not appear to me to possess virtue, and yet pretend to the possession of it, I should reprove him as one who but little esteems things of the greatest worth, but considers things of a vile and abject nature as of great importance. In this manner I should act by any one I might happen to meet, whether younger or older, a stranger or a citizen; but rather to citizens, because ye are more allied to me. For be well assured that Divinity commands me thus to act. And I think that a greater good never happened to you in the city, than this my obedience to the will of Divinity. For I go about doing nothing else than persuading both the younger and older among you, neither to pay attention to the body, nor to riches, nor any thing else prior to the soul; nor to be so much concerned for any thing, as how the soul may subsist in the most excellent condition. I also say that virtue is not produced from riches, but riches from virtue, as likewise all other human goods, both privately and publicly. If, therefore, asserting these things, I corrupt the youth, these things will be noxious; but if any one says that I assert other things than these, he says nothing. In addition to this I shall say, O Athenians, that whether you are persuaded by Anytus or not, and whether you dismiss me or not, I shall not act otherwise, even though I should die often . . . Be not disturbed, O Athenians, but patiently hear what I shall request of you; for I think it will be advantageous for you to hear. For I am about to mention certain other things to you, at which perhaps you will be clamorous; though let this on no account take place. Be well assured then, if you put me to death, being such a man as I say I am, you will not injure me more than yourselves. For neither Melitus nor Anytus injures me; for neither can they. Indeed, I think it is not lawful for a better to be injured by a worse man. He may indeed perhaps condemn me to death, or exile, or disgrace; and he or some other may consider these as mighty evils. I however do not think so; but, in my opinion, it is much more an evil to act as he now acts, who endeavours to put a man to death unjustly. Now, therefore, O Athenians, it is far from my intention to defend myself, (as some one may think,) but I thus speak for your sake, lest in condemning me you should sin against the gift of Divinity. For, if you should put me to death, you will not easily find such another (though the comparison is ridiculous) whom Divinity has united to this city as to a great and generous horse, but sluggish through his magnitude, and requiring to be excited by a certain fly. In like manner Divinity appears to have united such a one as I am to the city, that I might not cease exciting, persuading and reproving each of you, and every where sitting among you through the whole day. Such another man, therefore, will not easily arise among you. And if you will be persuaded by me, you will spare me. Perhaps, however, you, being indignant, like those who are awakened from sleep, will repulse me, and, being persuaded by Anytus, will inconsiderately put me to death. Should this be the case, you will pass the rest of your time in sleep, unless Divinity should send some other person to take care of you. But that I am such a one as I have said, one imparted to this city by Divinity, you may understand from hence. For my conduct does not appear to be human, in neglecting every thing pertaining to myself and my private affairs for so many years, and always attending to your concerns, addressing each of you separately, like a father, or an elder brother, and persuading you to the study of virtue. And if indeed I had obtained any emolument from this conduct, and receiving a recompense had exhorted you to these things, there might be some reason for asserting that I acted like other men; but now behold, even my accusers themselves, who have so shamelessly calumniated me in every thing else, have not been so impudent as to charge me with this, or to bring witnesses to prove that I ever either demanded or solicited a reward. And that I speak the truth, my poverty I think affords a sufficient testimony.”—Socrates, The Apology

Socrates says, “I also say that virtue is not produced from riches, but riches from virtue, as likewise all other human goods, both privately and publicly,” and thus we must support the virtuous arts, as artistic entrepreneurs are the founts of our cultural wealth. They deserve the best DRM system that we can conceive of.

As collaborative efforts such as wikipedia and the linux kernel are the results of contributions from tens of thousands of people, and as they are based on algorithms and information that already exists “out there,” the GPL and other similar licenses suits them fine. However, because a song, or painting, or novel rely on the unique individual 's vision, and blood, sweat, and tears, the promotion of the higher arts requires a system that allows indie authors and artists to protect and profit from their works. And make no mistake-all true artists are indie artists.

“Follow your bliss and don't be afraid, and doors will open where you didn't know they were going to be,” said Joseph Campbell, “I wish there was one grand artistic depot where the artist only need hand in his artwork. As things stand now, one must be half a businessman,” said Beethoven. And this invention aims to be Beethoven's “grand artistic depot,” wherein artists define their rights, and aggregators, device makers, and DRM providers compete to serve the artists. The novel system will lead to superior content, increased opportunities for artists, augmented abilities for artists to protect and profit from their content, and a cultural renaissance which shall bestow us with value that cannot be counted down in dollars from the mint.

“The stock exchange is a poor substitute for the Holy Grail”—Joseph Schumpeter

Imagine video games with plots, characters, and Epic Storytelling. Imagine contemporary novels and movies with the same—with heroes and heroines—with Audrey Hepburns and Steve McQueens; whence our own John Wayne and Man with No Name ride into town for the showdown where story trumps spectacle, where Beatrice exalts Dante, and Odysseus sails on home to Penelope. Imagine software systems and startups that actually pay the artists and talent—the filmmakers, models, photographers, and bands. Imagine new classes/research programs/ventures supporting all this. This present invention aims to help deliver the vast wealth of the renaissance.

The Hero's Journey Entrepreneurship Festival seeks to give students, artists, and entrepreneurs the tools to make their passions their professions—to protect and profit from their ideas—to take ownership in their careers and creations. For Adam Smith's invisible hand enriches all when happiness is pursued by artists and innovators—society's natural founts of wealth. Jefferson eloquently expressed the entrepreneurial premise:

We hold these truths to be self-evident, that all men are created equal, that they are endowed by their Creator with certain inalienable rights, that among these are life, liberty and the pursuit of happiness.—The Declaration of Independence

The only clause in the main body of the United States Constitution that mentions “Rights” states the following:

The Congress shall have power to . . . promote the progress of science and useful arts, by securing for limited times to authors and inventors the exclusive right to their respective writings and discoveries;—The United States Constitution

Couple these two passages together, and one has the moral premise of Artistic Entrepreneurship & Technology. Every student ought be given the tools to create new ventures—to protect their intellectual property, and to pursue and profit from their dreams on their “Hero's Journey” into entrepreneurship. For it is along that journey that the long-term “wealth of nations” is generated.

Entrepreneurship has aspects of art—creation and the pursuit of higher aesthetics; and science—economics, finance, engineering, and physical invention. How these aspects, and many more—from intellectual property to corporate structures—combine to generate wealth, are part of an Epic Story that is told whenever an individual sets out to render their ideals and dreams real. Thus a most efficient way to study entrepreneurship—to unite its diverse aspects—is via Joseph Campbell's Hero's Journey.

As a new cornerstone in a classical liberal arts education, Artistic Entrepreneurship is for those seeking to make their passions their professions. This festival is dedicated to all those embarking on the “Hero's Journey” to create enduring wealth, be it a new venture, video game, indie film, record label, book, DRM system serving artists and musicians, or course. And this present invention shall be that DRM system that better serves the artists.

Plato's Republic weighs the virtues and vices of various forms of government, and we would be most wise to consider it in contemplating wise and prudent DRM systems. I can hear the pomo-hipster bloggers snarkily laughing, as that is how they excelled in the postmodern schools—by developing the primal, degraded impulse to laugh at, degrade, and oppose all exalted contemplations, and then go watch Amercian Idol. But nonetheless, Plato's Republic patiently endures:

Yes, if I can, I will, I said.

I shall particularly wish to hear what were the four constitutions of which you were speaking.

That question, I said, is easily answered: the four governments of which I spoke, so far as they have distinct names, are, first, those of Crete and Sparta, which are generally applauded; what is termed oligarchy comes next; this is not equally approved, and is a form of government which teems with evils: thirdly, democracy, which naturally follows oligarchy, although very different: and lastly comes tyranny, great and famous, which differs from them all, and is the fourth and worst disorder of a State. I do not know, do you? of any other constitution which can be said to have a distinct character. There are lordships and principalities which are bought and sold, and some other intermediate forms of government. But these are nondescripts and may be found equally among Hellenes and among barbarians.

Yes, he replied, we certainly hear of many curious forms of government which exist among them.

Do you know, I said, that governments vary as the dispositions of men vary, and that there must be as many of the one as there are of the other? For we cannot suppose that States are made of ‘oak and rock,’ and not out of the human natures which are in them, and which in a figure turn the scale and draw other things after them? Yes, he said, the States are as the men are; they grow out of human characters.

Then if the constitutions of States are five, the dispositions of individual minds will also be five?

Certainly.

Him who answers to aristocracy, and whom we rightly call just and good, we have already described.

We have.

Then let us now proceed to describe the inferior sort of natures, being the contentious and ambitious, who answer to the Spartan polity; also the oligarchical, democratical, and tyrannical. Let us place the most just by the side of the most unjust, and when we see them we shall be able to compare the relative happiness or unhappiness of him who leads a life of pure justice or pure injustice. The enquiry will then be completed. And we shall know whether we ought to pursue injustice, as Thrasymachus advises, or in accordance with the conclusions of the argument to prefer justice.

Certainly, he replied, we must do as you say.

Shall we follow our old plan, which we adopted with a view to clearness, of taking the State first and then proceeding to the individual, and begin with the government of honour?—I know of no name for such a government other than timocracy, or perhaps timarchy. We will compare with this the like character in the individual; and, after that, consider oligarchical man; and then again we will turn our attention to democracy and the democratical man; and lastly, we will go and view the city of tyranny, and once more take a look into the tyrant's soul, and try to arrive at a satisfactory decision.

That way of viewing and judging of the matter will be very suitable.

First, then, I said, let us enquire how timocracy (the government of honour) arises out of aristocracy (the government of the best). Clearly, all political changes originate in divisions of the actual governing power; a government which is united, however small, cannot be moved.

Very true, he said.

In what way, then, will our city be moved, and in what manner the two classes of auxiliaries and rulers disagree among themselves or with one another? Shall we, after the manner of Homer, pray the Muses to tell us ‘how discord first arose’? Shall we imagine them in solemn mockery, to play and jest with us as if we were children, and to address us in a lofty tragic vein, making believe to be in earnest?

How would they address us?

Socrates goes on to show how an amoral Web 2.0 system may foster a tyrant, or how amoral author who courts corruption might be made king by the mob, or how, in Hayek's words, we encounter the “end of ruth” as “the Worst Get on Top.” Above and below are Socrates' treatment, which is taken from Plato's republic, which is no longer required reading in the vast majority of law schools nor undergraduate curriculums, so it might seem new and strange and different to those brought up on Boy Bands, Reality TV, and Simon Cowell. But don't be a player-hater. Read it, enjoy it, and acknowledge its immortality, for whether you do or not, it will yet be read long after you are gone, assure as the mountains and the ocean shall yet be, and Dante shall speak of Beatrice's divine eternity. Here's Socrates:

Very true, he said.

Then there is another class which is always being severed from the mass.

What is that?

They are the orderly class, which in a nation of traders sure to be the richest.

Naturally so.

They are the most squeezable persons and yield the largest amount of honey to the drones.

Why, he said, there is little to be squeezed out of people who have little.

And this is called the wealthy class, and the drones feed upon them.

That is pretty much the case, he said.

The people are a third class, consisting of those who work with their own hands; they are not politicians, and have not much to live upon. This, when assembled, is the largest and most powerful class in a democracy.

True, he said; but then the multitude is seldom willing to congregate unless they get a little honey.

And do they not share? I said. Do not their leaders deprive the rich of their estates and distribute them among the people; at the same time taking care to reserve the larger part for themselves?

Why, yes, he said, to that extent the people do share.

And the persons whose property is taken from them are compelled to defend themselves before the people as they best can?

What else can they do?

And then, although they may have no desire of change, the others charge them with plotting against the people and being friends of oligarchy? True.

And the end is that when they see the people, not of their own accord, but through ignorance, and because they are deceived by informers, seeking to do them wrong, then at last they are forced to become oligarchs in reality; they do not wish to be, but the sting of the drones torments them and breeds revolution in them.

That is exactly the truth.

Then come impeachments and judgments and trials of one another.

True.

The people have always some champion whom they set over them and nurse into greatness.

Yes, that is their way.

This and no other is the root from which a tyrant springs; when he first appears above ground he is a protector.

Yes, that is quite clear.

How then does a protector begin to change into a tyrant? Clearly when he does what the man is said to do in the tale of the Arcadian temple of Lycaean Zeus.

What tale?

The tale is that he who has tasted the entrails of a single human victim minced up with the entrails of other victims is destined to become a wolf. Did you never hear it?

Oh, yes.

And the protector of the people is like him; having a mob entirely at his disposal, he is not restrained from shedding the blood of kinsmen; by the favourite method of false accusation he brings them into court and murders them, making the life of man to disappear, and with unholy tongue and lips tasting the blood of his fellow citizen; some he kills and others he banishes, at the same time hinting at the abolition of debts and partition of lands: and after this, what will be his destiny? Must he not either perish at the hands of his enemies, or from being a man become a wolf—that is, a tyrant?

Inevitably.

This, I said, is he who begins to make a party against the rich?

The same.

After a while he is driven out, but comes back, in spite of his enemies, a tyrant full grown.

That is clear.

And if they are unable to expel him, or to get him condemned to death by a public accusation, they conspire to assassinate him.

Yes, he said, that is their usual way.

Then comes the famous request for a bodyguard, which is the device of all those who have got thus far in their tyrannical career—‘Let not the people's friend,’ as they say, ‘be lost to them.’

Exactly.

The people readily assent; all their fears are for him—they have none for themselves.

Very true.

And when a man who is wealthy and is also accused of being an enemy of the people sees this, then, my friend, as the oracle said to Croesus,

By pebbly Hermus' shore he flees and rests not and is not ashamed to be a coward.

And quite right too, said he, for if he were, he would never be ashamed again.

But if he is caught he dies.

Of course.

And he, the protector of whom we spoke, is to be seen, not ‘larding the plain’ with his bulk, but himself the overthrower of many, standing up in the chariot of State with the reins in his hand, no longer protector, but tyrant absolute.

No doubt, he said.

And now let us consider the happiness of the man, and also of the State in which a creature like him is generated.

Yes, he said, let us consider that.

At first, in the early days of his power, he is full of smiles, and he salutes every one whom he meets;—he to be called a tyrant, who is making promises in public and also in private! liberating debtors, and distributing land to the people and his followers, and wanting to be so kind and good to every one!

Of course, he said.

But when he has disposed of foreign enemies by conquest or treaty, and there is nothing to fear from them, then he is always stirring up some war or other, in order that the people may require a leader.

To be sure.

Has he not also another object, which is that they may be impoverished by payment of taxes, and thus compelled to devote themselves to their daily wants and therefore less likely to conspire against him? Clearly.

And if any of them are suspected by him of having notions of freedom, and of resistance to his authority, he will have a good pretext for destroying them by placing them at the mercy of the enemy; and for all these reasons the tyrant must be always getting up a war.

He must.

Now he begins to grow unpopular.

A necessary result.

Then some of those who joined in setting him up, and who are in power, speak their minds to him and to one another, and the more courageous of them cast in his teeth what is being done.

Yes, that may be expected.

And the tyrant, if he means to rule, must get rid of them; he cannot stop while he has a friend or an enemy who is good for anything.

He cannot.

And therefore he must look about him and see who is valiant, who is high-minded, who is wise, who is wealthy; happy man, he is the enemy of them all, and must seek occasion against them whether he will or no, until he has made a purgation of the State.

Yes, he said, and a rare purgation.

Yes, I said, not the sort of purgation which the physicians make of the body; for they take away the worse and leave the better part, but he does the reverse.

If he is to rule, I suppose that he cannot help himself.

What a blessed alternative, I said:—to be compelled to dwell only with the many bad, and to be by them hated, or not to live at all!

Yes, that is the alternative.

And the more detestable his actions are to the citizens the more satellites and the greater devotion in them will he require?

Certainly.

And who are the devoted band, and where will he procure them?

They will flock to him, he said, of their own accord, if lie pays them.

By the dog! I said, here are more drones, of every sort and from every land.

Yes, he said, there are.

But will he not desire to get them on the spot?

How do you mean?

He will rob the citizens of their slaves; he will then set them free and enroll them in his bodyguard.

To be sure, he said; and he will be able to trust them best of all.

What a blessed creature, I said, must this tyrant be; he has put to death the others and has these for his trusted friends.

Yes, he said; they are quite of his sort.

Yes, I said, and these are the new citizens whom he has called into existence, who admire him and are his companions, while the good hate and avoid him.

Of course.

Verily, then, tragedy is a wise thing and Euripides a great tragedian.

Why so?

Why, because he is the author of the pregnant saying,

Tyrants are wise by living with the wise; and he clearly meant to say that they are the wise whom the tyrant makes his companions.

Yes, he said, and he also praises tyranny as godlike; and many other things of the same kind are said by him and by the other poets.

And therefore, I said, the tragic poets being wise men will forgive us and any others who live after our manner if we do not receive them into our State, because they are the eulogists of tyranny.

Yes, he said, those who have the wit will doubtless forgive us.

But they will continue to go to other cities and attract mobs, and hire voices fair and loud and persuasive, and draw the cities over to tyrannies and democracies.

Very true.

Moreover, they are paid for this and receive honour—the greatest honour, as might be expected, from tyrants, and the next greatest from democracies; but the higher they ascend our constitution hill, the more their reputation fails, and seems unable from shortness of breath to proceed further.

True.

But we are wandering from the subject: Let us therefore return and enquire how the tyrant will maintain that fair and numerous and various and ever-changing army of his.

If, he said, there are sacred treasures in the city, he will confiscate and spend them; and in so far as the fortunes of attainted persons may suffice, he will be able to diminish the taxes which he would otherwise have to impose upon the people.

And when these fail?

Why, clearly, he said, then he and his boon companions, whether male or female, will be maintained out of his father's estate.

You mean to say that the people, from whom he has derived his being, will maintain him and his companions?

Yes, he said; they cannot help themselves.

But what if the people fly into a passion, and aver that a grown-up son ought not to be supported by his father, but that the father should be supported by the son? The father did not bring him into being, or settle him in life, in order that when his son became a man he should himself be the servant of his own servants and should support him and his rabble of slaves and companions; but that his son should protect him, and that by his help he might be emancipated from the government of the rich and aristocratic, as they are termed. And so he bids him and his companions depart, just as any other father might drive out of the house a riotous son and his undesirable associates.

By heaven, he said, then the parent will discover what a monster he has been fostering in his bosom; and, when he wants to drive him out, he will find that he is weak and his son strong.

Why, you do not mean to say that the tyrant will use violence? What! beat his father if he opposes him?

Yes, he will, having first disarmed him.

Then he is a parricide, and a cruel guardian of an aged parent; and this is real tyranny, about which there can be no longer a mistake: as the saying is, the people who would escape the smoke which is the slavery of freemen, has fallen into the fire which is the tyranny of slaves. Thus liberty, getting out of all order and reason, passes into the harshest and bitterest form of slavery.

True, he said.

Very well; and may we not rightly say that we have sufficiently discussed the nature of tyranny, and the manner of the transition from democracy to tyranny?

Yes, quite enough, he said.

And thus we see how the liberal boomer elite are leveraging the “free love” era to usher in an era of mob-rule on A Prominet Content Aggregator which launched A Prominent Hipster Author, and myspace/Simon Cowell. Well, nice try, but this is America—the country that loves third act—the showdown—and we're free to write our own destiny, so go ahead and make our day, as Odysseus is sailing on home, and bring with him a renaissance in Epic Story, which will complement a renaissance in technological systems that allow authors, artists, and creators to protect and profit from their content, such as the present invention.

Platos says, “And so tyranny naturally arises out of democracy, and the most aggravated form of tyranny and slavery out of the most extreme form of liberty? As we might expect.”

A Renaissance in Epic Story

The rising generation is longing for Epic Story, and thus opportunity abounds for artistic entrepreneurs to perform the classical ideals in the contemporary context—in Hollywood and the Heartland, on Wall Street and Main Street, in video games and academia.

The classic hero, from Odysseus on down, is one who serves. This moral premise pervades all enduring literature and entrepreneurial ventures, as expressed by John C. Bogle—the “student entrepreneur” who founded the $700 billion Vanguard fund based on an idealistic premise in his 1951 Princeton senior thesis. Mr. Bogle recently quoted his original thesis in one of his eloquent speeches—“After analyzing fund performance, I concluded that “funds can make no claim to superiority over the market averages,” perhaps an early harbinger of my decision to create, nearly a quarter-century later, the world's first index mutual fund. And my conclusion powerfully reaffirmed the ideals that I hold to this day: The role of the mutual fund is to serve—“to serve the needs of both individual and institutional investors . . . to serve them in the most efficient, honest, and economical way possible . . . The principal function of investment companies is the management of their investment portfolios. Everything else is incidental.”

Watch the academy-award-winning movie Braveheart, and you will see the very same moral premise at the film's center and circumference, as expressed by William Wallace's actions and his words to the Scottish Nobles—“There's a difference between us. You think the people of this land exist to provide you with position. I think your position exists to provide those people with freedom. And I go to make sure that they have it.”

And Joseph Campbell, author of The Hero With a Thousand Faces which helped inspire Star Wars, The Matrix, The Lord of The Rings, and Dr. E's AE&T class wrote, “Man should not be in the service of society, society should be in the service of man. When man is in the service of society, you have a monster state . . . ”

Entrepreneurship is the force that continually rights the world by rewarding those who serve—those who battle the bureaucracy with a better way. Entrepreneurship is an epic story wherein the world is continually “begun anew,” as the humble risk-taker—the reluctant hero—the fount of lasting cultural and monetary wealth—happens upon an innovation, invention, or epiphany, and takes a risk in rendering it real for others.

The classic entrepreneur navigates on out while keeping the higher ideals over the bottom line, endures the road of trials en route to the countless showdowns with competitors and convention, seizes the sword, and returns on home with the elixir—with the rewards gained from risking their time, their talents, their passions, and their money in penning that novel, shooting that film, and creating that venture. And so often it is all based on some simple, pervading moral premise. For Google it is “Do no evil.” For Apple it is “Think different.” For Buffett it is “Our favourite holding period is forever.” For Bogle, Wallace, and Campbell it is “institutions must serve.” For this HJE Festival, it is “own the risk of the renaissance.”

And our goal is to serve you with a most useful, informative, and inspirational day regarding how best to make your passion your profession, as we celebrate the words of that classic entrepreneurial document, “We hold these truths to be self-evident, that all men are created equal, that they are endowed by their Creator with certain unalienable Rights, that among these are Life, Liberty and the pursuit of Happiness.”

Crossing the Threshold

Opportunities abound for those who in Joseph Campbell's words “follow their bliss”—for those who perform the classical ideals in the contemporary context. Percy Bysshe Shelley once wrote, “Poets are the unacknowledged legislators of the world,” and artists and inventors are its natural entrepreneurs. The Founding Fathers saluted these natural founts of wealth in the Constitution with a simple clause that became the foundation of intellectual property law:

The Congress shall have Power To promote the Progress of Science and useful Arts, by securing for limited Times to Authors and Inventors the exclusive Right to their respective Writings and Discoveries;

And so it is that, “American movies, television programs, music, books and computer software have surpassed traditional factory and agricultural products as our largest category of exports.—NCPA.ORG”

This present invention serves the spirit of the Declaration of Independence and The United States Constitution in a manner superior to the present and past art. By allowing artists to define their rights, as well as producers, directors, record label owners, and all artists, models, and entertainers; and then requiring the aggregators, DRM providers, device makers, and others compete to best meet the artist's terms, the present invention serves artists and indie artists and creators in a superior manner.

A vast demand exists for the classical ideals performed in the contemporary context—for honor, integrity, courage, and committment—on Wall Street and Main Street, in Hollywood and the Heartland, in Academia and Government. And thus opportunity abounds for entrepreneurs who keep the higher ideals above the bottom line—for humble heroes in all walks of life.

The present invention aims to be a most useful application for students, teachers, and anyone starting or launching a venture.

The same classical values guiding the rising artistic renaissance will protect the artists' intellectual property. The immortal ideals which guide the story of blockbuster books and movies such as The Matrix, Lord of the Rings, Braveheart, The Chronicles of Narnia, and Star Wars, are the very same ideals underlying the United States Constitution. These classic ideals—which pervade Homer, Plato, Shakespeare, and the Bible—are the source of both epic story and property rights, of law and business, of academia and civilization.

It is great to witness classical ideals performed in Middle Earth, upon the Scottish Highlands, long ago, in a galaxy far, far, away, and in Narnia, but too, such ideals must be perpetually performed in the contemporary context and living language.

The digital media revolution has collapsed the distance between art, business, law, and media technology programs, and students are longing for those general permanent principles found within the pages of the Great Books. In many ways, an AE&T program founded upon the classics, would become a flagship in reviving the lost art of the liberal arts education.

Throughout the greater culture, there exists a longing for contemporary heroes and heroines in literature reflecting those brave men and women wearing uniforms in real life—there exists a longing for epic stories in our books, movies, and video games, and for digital rights management software and systems based on the Founding Fathers' idealism. And thus there exist vast opportunities for rugged artistic entrepreneurs to lead renaissances on all fronts.

For a time many have been tempted to forget classical ideals, valuing short-term profits over long-term wealth, exalting the bottom line over the higher ideals; but the nascent brilliance of the technological revolutions can only achieve its fuller potential via Story. While many will suggest that the best solution to digital rights management is to remove story from movies—as Hollywood has dedicated itself to as of late—thusly removing incentive to pirate them, I counter that classical ideals can enhance both the storytelling within movies and the DRM that protects them.

Just as the Founding Fathers complimented property rights by providing everyone with the right to bear arms, a novel software system that provides all creators with a turnkey choice from a full spectrum of digital rights management would foster a renaissance in the creation and distribution of intellectual property and art. The name of this software is the Dodge City DRM Marketplace/Search Engine, and the killer app could lead next-generation social networks and content portals that would benefit Hollywood—from the indie filmmakers to the major studios. Let's build it. Let's build tomorrow's ecommerce portals—tomorrow's books, movies, video games, and culture—upon classical ideals.

That distant wave has been a long time coming, and the new fashions will be about performing the classical ideals in the contemporary context. The rising generation will lead a renaissance in storytelling; a renaissance in the composition, production, and distribution of art—a renaissance in business, culture, and civilization in academia and entrepreneurship. For that is the artistic entrepreneur's duty, and this present invention aims to empower the natural fount of wealth—the artistic entrepreneur.

“If we are to go forward, we must go back and rediscover those precious values—that all reality hinges on moral foundations and that all reality has spiritual control.”—Martin Luther King Jr.

### The Hero's Journey to Dodge City

Dodge City is a place where artists, authors, and professors can gather, free from fear for their professional careers if they wish to aspire towards the higher ideals, pass classical judgment, install art with everlasting values, and own what they do. Out here the United State's Constitution is lauded and praised in words, deeds, and actions, including the Bill of Rights and its first two amendments are respected—everyone gets the freedom of speech and a 45 Revolver.

What is Hero's Journey Entrepreneurship?

HJE pervades the exalted form of all noble and lasting endeavors in the arts, culture, government, academia, blockbuster movies, and business—all of which are characterized by the individual, creator, and innovator's will to serve—both the higher ideals and the end customer. So often it is that HJE is characterized by an indie entrepreneur or a rugged band of revolutionairies, such as the Founding Fathers, who penned that business plan of all business plans—The United States Constitution. John C. Bogle, the founder and former CEO of Vanguard, reflects upon the nature of entrepreneurial Fellowships in his speech: Vanguard: Saga of Heroes.

Just as heroes are so often the least likely suspects in movies—such as a Hobbit named Frodo in Lord of The Rings, a farmboy named Luke Skywalker in Star Wars, and a common cubicle worker named Neo in The Matrix, so too are entrepreneurs most often humble heroes. They embark on great journeys by simply “doing the right thing,” while serving with a better way and new day. They end up leading and creating wealth not by degrees and titles, but by innovation, common sense, and humble service. They may seem rebellious, but look closer, and one shall see that they are extremely loyal to higher ideals, and they have the ability—the Classic Character—to render those ideals real in any arena they partake in. As William Wallace said in Braveheart, “men don't follow titles—they follow courage.” And courage is not the absence of fear, but the ability to hold true to one's convictions and ideals while facing down the bureaucracy that inverts entrepreneurship's fundamental premise of service.

A vast demand exists for the classical ideals performed in the contemporary context—for honor, integrity, courage, and committment—on Wall Street and Main Street, in Hollywood and the Heartland, in Academia and Government. And thus opportunity abounds for entrepreneurs who keep the higher ideals above the bottom line—for humble heroes in all walks of life. And the Dodge City marketplace will be founded by such artistic entrepreneurs-seeking to render their ideals real in the forms of tomorrow's technologies wherein artists will be granted the rights to protect and profit from their creations.

Check out the “Hero's Journey” in John C. Bogle's Career and Vaughan Penn's Ready to Rise video, shot in the original Artistic Entrepreneurship & Technology class. From the call to adventure, to the refusal of the call, to crossing the threshold, to the road of trials, to the showdown, and the return with the elixir, it's all there. You might recognize Ready to Rise from Gray's Anatomy, Laguna Beach, and Roller Girls.

Inspired by Joseph Campbell's Hero With a Thousand Faces, HJE approaches life as an Epic Story, wherein the rugged innovator, inventor, artist, or entrepreneur embarks on a journey to realize their dream—to render some ideal real.

Definitive aspects of the entrepreneurial journey can be seen in movies ranging from The Matrix to The Lord of The Rings to Star Wars—the call to adventure (seeing an opportunity), refusal of the call (it's too hard—somebody else would have done it—working a corporate job is safer), meeting the mentor (finding the angels/professors/books/coaches/leaders/entrepreneurs who can help), crossing the threshold (the point of no return—signing the lease/hiring employees), seizing the sword from the stone (getting the patent/raising funds), the showdown/ordeal (facing down competitors), tests, allies, and enemies (collaborators and competition). And even after all that, even after the patent has issued and the funds have been raised, there's still the classic road on home (getting the product to market!) and the return with the elixir—the exit strategy.

And too, there's the belly of the whale (Steve Jobs being kicked out of Apple by the MBAs and into the darkness of NEXT) and the resurrection (Steve Jobs returning on home, reinventing Apple with the iPod, and leading it to new heights). And it's always the least likely suspect—the reluctant hero—who somehow succeeds—Frodo was just a little Hobbit, Neo was a lowly cubicle worker—and Jobs, Branson, and Gates have not a college degree between them. So too will humble heroes arise to create Dodge City.

Failure isn't always failure, so much as a small step along the greater journey. Frodo and Neo both appeared to be dead at one point. In tirelessly testing different filaments, Edison said, “I have not failed 1,000 times. I have successfully discovered 1,000 ways to NOT make a light bulb.”

Hero's Journey Entrepreneurship is a philosophy of life—ideals are real, and they're not just meant for epic myths of yore and the silver screen. HJE is all about recognizing the true nature of risk, calling the bluff, and reaping the higher rewards. HJE is a class, a festival, a blog, and a couple upcoming books. It's about taking ownership in your dreams—your most valuable assets—and making your passion your profession. An outline of Hero's Journey Entrepreneurship, complete with useful resources for patents, trademarks, and incorporating, may be found below.

In this day and age, there exist all-to-many of sales-pitches designed to diminish your dreams, take your money or creations, and all too often place you at risk or in debt to fund someone else's ventures. Whenever someone on Wall Street, or at a Record Label, or at a University, tells you they are managing your risk, they are generally bluffing, as pointed out by Bogle, Buffett, and Mark Cuban, who states:

“Risk is what Wall Street lies about every day. Risk is what they try to sweep under the covers knowing that we all are addicted to the dream of financial freedom. Risk is the poison that is masked by the commercials . . . You Inc. is the best stock you can ever buy . . . if you are willing to do the work.”—Mark Cuban

The bureaucracy—be it the Mutual Fund or the Record Label or Web 2.0 company—is generally transferring the lion's share of the risk to you and the lion's share of the wealth to themselves. HJE is where the risk-takers—the artists, creators, and entrepreneurs—get the reward, as set forth in the United States Constitution. HJE salutes Nobel Laureate economists such as Friedman, Hayek, and Schumpeter—all of whom recognized the indie innovator—not the bureaucracy—as society's natural fount of wealth, and thusly held the notion of property rights in high regard.

Hero's Journey Entrepreneurship is about calling the bluff and reaping the rewards of your innovations. HJE is all about investing your time, your energy, and your money into your own passions and dreams—for there is no better investment. The resources throughout Dr. E's websites, syllabi, and books are dedicated to giving you the tools for your journey. Dodge city will be a place where the risk takers—the artists and creators-reap the rewards.

HJE is not so much about making money as it is about creating wealth. For money derives from wealth, and following your dreams is a vast payment in and of itself—that type of payment, that as Herman Melville said, “Cannot be counted down in dollars from the mint.” HJE seeks mentorship in the classics and contemporaries—in the words of Socrates, Mark Cuban, John Bogle, Richard Branson, the Founding Fathers, and Joseph Campbell.

HJE manifests itself in many forms, but it is always based on Joseph Campbell's Hero's Journey, which traces the natural path that an idealist usually follows en route to rendering their ideals real. “The Hero's Journey” provides the plot outline for blockbuster movies such as The Matrix, Star Wars, Lord of The Rings, as they are all about the battle of good and evil—the lone cowboy facing down the Agents, the Empire, or the Orcs of Mordor. HJE is about taking those classic ideals and rendering them real—in your very own ventures. You are the director, and you are the star—you take the risks, and you get the reward.

You will find Hero's Journey Entrepreneurship outlined on Dr. E's Artistic Entrepreneurship & Technology Page (artsentrepreneurship.com), his Hero's Journey Matrix, and in a podcast of a speech he delivered to Bijoy's Bootstrap Network. Here's a brief outline, inspired by the works of Joseph Campbell's Hero With a Thousand Faces and Christopher Vogler's The Writer's Journey, that Dr. E presented at SXSW. It contains a few invaluable resources and links for entrepreneurs:

### Hero's Journey Entrepreneurship Outline

1. The Ordinary World: You awake each day to the routine, rise, and leave your dreams behind. Blog your dream. Set it down in a notebook. Take ownership in your ideas with blogger.com or wordpress.org. You are dreaming of Dodge City, where artists get to protect and profit from their works with a turnkey system, and the vast wealth of the internet is shared with those who create the soul and the reason we surf the internet—the artists and creators.
2. The Call to Adventure: A more vivid dream—a flash of inspiration. You can't shake the feeling—the wave is real, though they can't see it. You are dreaming of Dodge City, where artists get to protect and profit from their works with a turnkey system, and the vast wealth of the internet is shared with those who create the soul and the reason we surf the internet—the artists and creators.
Register those copyrights. File that provisional patent. Register that trademark. Voyage on out to your bookstore and cruise the section on entrepreneurship. Check out the USPTO. Read the Declaration of Independence and the Constitution—they were written for you, and they will be displayed prominently and proudly in dodge City. Dodge city will have single-click copyrights, trademarks, and patents, and DRM, whereby after defining one's rights, with as single click, one can protect and register their content.
3. Refusal of the Call: Voices tell you that you aren't good enough. Friends, parents, teachers, bosses, and your own internal voice. Seek mentorship from those who have done, for they will say, “yes you can.” You are dreaming of Dodge City, where artists get to protect and profit from their works with a turnkey system, and the vast wealth of the internet is shared with those who create the soul and the reason we surf the internet—the artists and creators.
4. Meeting the Mentor: With newfound energy you seek mentorship—you turn to the Great Books & Classics—The Odyssey & The Inferno—Shakespeare & The Bible, Franklin, Lincoln, Jefferson, and Martin Luther King Jr. Mentorship surrounds us. Wisdom comes from all walks of life. So listen, watch, and read. And then read some more—for those books which have lasted have lasted via the profound mentorship they provide. The USPTO has resources dedicated to artists, musicians, authors, and creators, and Dodge city will be a place where these resources are easily accessed and leveraged, where with a single click, a full spectrum of DRM rights will be afforded.
Nolo.com has wonderful books for artists, authors, and creators. Two of my favorites are Patent it Yourself and Patents, Trademarks, and Copyrights.
5. Calling the Bluff: Nobody knows the hand you hold. And you can't see theirs. But it seems—yes—they're bluffing. So you call 'em and raise 'em, and you let them see the .45 revolver by your side—the Truth of the Great Books and Classics. You're going to surf that dream on home. Dr. E added the “calling the bluff” stage to Campbell's outline. You gotta call the postmodern bluff. Postmodern Wall Street transfers the risk to you and the wealth to themselves. Postmodern academia sells expensive degrees that often don't teach much of value, instead teaching the exact opposite, opposing classical entrepreneurship. Postmodern politics and literature have replaced plot and character with hype, and Hollywood has replaced Epic Story with reality TV and remakes of seventies sitcoms. Call the bluff, live the renaissance, and vast wealth will be yours. The 45 Revolver will let you call the web 2.0 bluff in Dodge city, which dictates to artists that they are worth nothing on their own, but only in the collective company of millions of others. This form of mob rule exalts the degraded, indifferent, long-tail “blin-don't-think” CEOs who wouldn't know true art if it bit them in the ass. The CEOs hand out awards to useful, ambitious idiots—not to artists—and the result is forgettable myspace bands and Simon Cowell instead of John Wayne, Audrey Hepburn, Homer, Shakespeare, the Bible, and Johnny Cash. You gotta call the bluff and ride off to Dodge city.
6. Crossing the Threshold: And so you set out, crossing that point of no return. You have no choice but to succeed. Once you're on that wave, you've got but one choice—ride it.
Suddenly the words of the Greats take on a new, more immediate meaning. Watch Braveheart, The Matrix, The Outlaw Jose Wales, and A Fistful of Dollars. Take those ideals off the silver screen, take them out of the books, for ideals are most useful tools in reaching your most valuable assets—your passions and dreams.
Incorporate at bizfilings.com. As of today, you are your own business, and you can take Mark Cuban's investment advice—“invest in You, Inc.” Dodge City will allow you to easily incorporate with “one-click” incorporation.
7. The Road of Trials: It ain't easy out here. Some statistics say that 90% of small businesses fold in five years. An infinitesimal percentage of novels are published and screenplays optioned. But you do it anyway, as did everyone who ever succeeded. So you patent it, trademark it, copyright it, and live it.
“Every fighter has a plan,” Mike Tyson once said, “until they get hit.” But that's the joy of battle—for out here alone do we ever find our true constitution—our ability to innovate and think on our feet, and still prevail. So follow your dream, and tell the world, “My name is ______.”
8. Tests, Allies, Enemies: Even when your business is launched, when your screenplay is being produced, there will yet be those forces that oppose and sabotage. But too, loyal friends will emerge, and a Fellowship will form.

### And you shall find those best of friends that one only finds away out here, along this journey—they too left the ordinary world long ago and set off to follow their ideals, and Destiny brought you together.

Beware of all the shape-shifting marketers, mbas, and lawyers—the Orcs that are being manufactured in droves in Mordor. Not all of them are bad—many of them are good, but all that good men must do for evil to propagate is to do nothing. So it is that a motto that says, “do no evil,” is the same as “let evil be if need be.”
As bureaucrats and Pharisees produce nothing but bureaucracy, be eternally vigilant, and watch for that moment when they start transferring all the risk to you, and all the wealth to themselves, as they always inevitably do. Call the bluff, and head to Dodge City, where the artists and creators take the risks and get the rewards, where the creators “own the risk™” and walk around in 45 Surf shirts™.
And too, the fellowship is forming. Guided by similar ideals, we had faith in a great future, and that is what has brought us together upon this unsettled intellectual frontier, where we might create a better marketplace that accomplishes the commoditiy reversal—which makes all the apples and microsofts and googles and time warners and youtubes and viacoms compete to give us artists and creators the best deals, compete to offer us drag-and-drop DRM™ and one-click DRM™.

### For the profits from our art, however small they are, are significant, and over time, when invested in the Vanguard Mutual Fund, they can grow into vast fortunes.

9. Supernatural Aid: Away out here, something magical happens. A stroke of luck that only means something because of the risk you took. You took a chance, called the bluff, and caught the wave just right. So it is that “God helps those that help themselves.”
Open source software, in all its robust freedom, can provide that seemingly supernatural aid. Software is labor immortalized, and open source has bestowed us with not only LAMP (Linux, Apache, MYSQL, PHP/PYTHON/PERL/RUBY) servers, but it offers free and robust solutions for ecommerce, content management, blogging, album hosting, and more.
Fantastico allows for the quick and easy installing of leading open source application such as wordpress (blogging), joomla/drupal/postunke (content management), and cubecart/oscommerce/zencart (ecommerce). Hostgator accounts come with Fantastico and the intuitive cpanel interface. Also check out hotscripts.com for more free software.
Don't be afraid to get under the hood and “teach yourself” linux/php/mysql/apache in ten minutes, twenty-four hours, or fourteen days—you know those books. Hard work and studious industry is the best supernatural aid there is!
And now it's your turn to give someone a break—to provide trusting mentorship. Should you ever find yourself waiting around to be helped, reach out and help someone—give 'em a break.
Dodge City and the 45 Revolver are innovations that will serve the artist and creator in superior ways, opening up the floodgates of opportunity in the digital age, providing unprecedented manners for protecting and profiting from one's content. And of course the establishment will detest these tools, as artist and creators are public enemy number one, and the administrators on high will talk behind their backs and try to caricature them, and tell them they need to first fill out forms and translate their ventures into MBA speak, so that the MBA degree might retain its value as an asset-transfer degree. A prominent MBA VC instructor told me my words were too poetic, and then, within the next year, I founded the Hero's Journey Entrepreneurship conference and I hosted a founder of a trillion dollar Wall Street fund who said that words and character and values were the most important thing, and I hosted an executive producer of several #1 blockbusters who said the same thing. And so it is that the MBA/VCs make their money via deception, degradation, and snarky-putdowns to facilitate wealth transfer to their dull bureaucracies and risk transfer to the common folks. And their days are numbered, as Odysseus makes his way on home.
10. Stringing the Bow/Seizing the Sword: Degrees, money, and titles mean little out here—victory goes to those with integrity—those with honor, courage, and commitment. For ideals alone can string eternity's bow.

### Ideals are your most valuable asset—they are those entities which inspired those dreams that awoke you long ago—the dream that haunted your days, always beckoning you to embark on this journey.

Dodge City can only be built by those brave souls who can string the bow and see the Truth—the glorious Truth of the Constitution embodied in the full power of today's technology. DRM exist. Devices exist. We have thousands of engineers and creators and artists just waiting to be liberated from the petty postmodern prejudices so that they might build Tomorrow Renaissance. Come ride with us! We're heading to Dodge City!
11. The Showdown/Ordeal: It's been a long time coming. You just wanted to live in peace and harmony, but that boss/bureaucrat/outlaw antagonist just wouldn't let you. But you call them out, and now you get to stand toe-to-toe; face-to-face with a new book, or invention, or film, or venture that serves the world in a better way.
So often it is that entrepreneurship is opposed. “No good deed goes unpunished.” Socrates and Jesus were sentenced to death for seeing a better way and speaking the simple truth to power. Steve Jobs was kicked out of Apple. Read Richard Branson's biography, and you will see the hundreds of showdowns he partook in.

### And make no mistake—there will be many who oppose the 45 Revolver and Dodge City—where artists are free to define their rights, protect and profit from their content, and enjoy the glory of the digital revolution in ways that have not yet been realized.

12. Rescue From Without/The Resurrection: So often it is that just as one wins, the jealous bureaucracy moves in to seize control. In every Western, after our hero wins the showdown fair and square, yet another Outlaw draws a bead on him—to shoot him in the back. I know I have my enemies, but they should beware, for 1 have far more powerful angels watching over me.

### Remember how Zeus and Authena watched over Odysseus because he respected the family, the home, and the sacred.

Jobs was kicked out of Apple, but then brought back to take it to new heights. Richard Branson lost Virgin Records, but was reborn in Virgin Airlines and a thousand other ventures. John C. Bogle founded Vanguard upon the ideals set forth in his Princeton Senior Thesis, and now he pens inspirational books and speeches based on those very same ideals. Every entrepreneur ought read Battle for The Soul of Capitalism, as it reminds us that entrepreneurship's greater purpose is to serve.
Those who live by ideals have no need to fear death, as Socrates realized, for the soul is immortal. Though some bureaucracy rejects the implementation of your ideals, they can't steal nor kill those ideals—for America recognizes the entrepreneur's rights.
So it is that after opposing The 45 Revolver and Dodge City, the lawyers and mbas and marketing bureaucrats will move in to take credit for it. Such is the lowly human nature found in high places build upon the shifting sands of popular opinion and mob rule.

### 13. The Road Back/Return with the Elixir/Freedom: You took ownership in your dreams and destiny—you called the bluff and caught the wave, and the Truth set you free.

### You added to the wealth of the world—the long-term wealth of the world—via the simple act of following your passions and dreams.

### And everything you learned on this Hero's Journey will come in handy along tomorrow's journey—we're setting out at dawn.

I'll see you at Dodge City. Grab that 45 Revolver, saddle on up, and join us in our brave, new, and free world. For taxation without representation is not freedom, and Steven Jobs has no need for 90% of the money from the sales of songs, when he is no longer even interested in providing the artists with DRM, if he ever was.

### The Artists' Yearning for Dodge City

Below are what some of the artists are saying, from http://www.riaa.com/about/artists/quotes.asp. Their quotes reflect the need for artists of all kinds, from photographers, to musicians, to indie filmmakers, to be afforded the opportunity to protect and profit from their content in this digital age. This present invention serves the long-felt need, without an obvious or immediate solution in the prior art, to better protect and profit from one's creative labors and creations.

Artists are yearning for dodge City—a portal dedicated to allowing them to protect and profit from their content, making sure that all the best cutting edge DRM and devices are available to them fro their benefit, all with the single click of a mouse.

“The fundamental point is: no music, no Napster. This is obviously a big business that was built by taking stuff without the consent of the artists who created it . . . More and more people are going to download their music, and if it all stays free and there is no control over the payments, then it will be difficult for younger artists to make a livelihood . . . We would first like to be consulted before our stuff gets taken, and [we'd like to] have some vote in deciding what's distributed for free and what isn't . . . Second, we'd like to get some payment.”—Peter Gabriel The Red Eye/Redherring.com Feb. 5, 2001
“I don't like to have a record out and have people hear . . . versions that we don't want them to hear. With the Internet, there is no more privacy and not even the chance to express yourself in front of your audience in the intimacy of a concert that lets songs evolve. You can't do this because they immediately get circulated.”—Neil Young Yahoo! Entertainment News Jan. 31, 2001
“You know, my whole vibe on Napster is, I understand how it will help life for unsigned bands. It is definitely a window to showcase a lot of bands [that] probably wouldn't be getting to hear from a lot of these majors, but at the same time you all need to pay us now . . . I mean, straight up! This is some hard work. I mean, I was in the military for, like, four years, man, and I'm telling you, boy, the music business is some hard work . . . You need some sort of pension, you know? And if they can't regulate it to where the artist gets paid, well, then it's not that great of an idea because even the unsigned artists, at some point, they're going to want to get paid for their things also.”—Shaggy Feb. 2, 2001
“The bottom line is this; The works of recording artists are being stolen and disseminated over the Internet without fair and just compensation for those artists. This is the way songwriters and singers make their living, and stealing that music and giving it away for free is not right. Then there's the absurd argument that, ‘Well, rock stars are wealthy, and therefore, it's all right to steal from them.’ But the majority of singers and songwriters and recording artists in this business are not wealthy. They're struggling from hand to mouth, day to day, and they need fair and just compensation for their work. I'm deeply concerned, as are all artists about these issues, particularly Napster.”—Don Henley Boston Globe May 5, 2000
“The Internet is both a democratizing force and a force for undermining democracy. The concept that music should be free is some holdover from the Sixties, I guess. And I resent it when people imply that this is not a legitimate profession, that what I do for a living should be given away. Napster and MP3.com try to make people believe that they are some sort of Robin Hood organization, stealing from the record companies and giving music to the people. But they are stealing from the people who create that music.—Don Henley Rolling Stone Jun. 22, 2000
“ . . . Just because technology exists where you can duplicate something, that doesn't give you the right to do it. There's nothing wrong with giving some tracks away or bits of stuff that's fine. But it's not everybody's right. Once I record something, it's not public domain to give it away freely. So I stand behind Dr. Dre and Metallica and support them. And that's not trying to be the outdated musician who is trying to ‘stop technology. I love technology. Technology is here to stay . . . ”—Trent Reznor of Nine Inch Nails Boston Globe May 5, 2000
“ . . . Yeah, I feel like I'm being stolen from, and I'd like to knock that punk around that invented it, but it was bound to happen. . . . I think Metallica's got the right idea sue 'em. It's your copyright, it is copyright infringement, and even though Napster is only the pipeline . . . ”—Johnny Rzeznik of the Goo Goo Dolls Sonicnet.com Jun. 7, 2000
“I'm sorry; when I worked 9 to 5, I expected to get a f--king paycheck every week. It's the same with music; if I'm putting my f--king heart and all my time into music, I expect to get rewarded for that. I work hard and anybody can just throw a computer up and download my s—t for free. That Napster s—t, if that gets any bigger, it could kill the whole purpose of making music. It's not just about the money. It's the thrill of going to the store; you can't wait till that artist's release date, taking the wrapper off the CD and putting the CD in to see what it sounds like. I've seen those little sissies on TV, talking about [how] ‘The working people should just get music for free,’ I've been a working person. I never could afford a computer, but I always bought and supported the artists that I liked. I always bought a Tupac CD, a Biggie CD, a Jay-Z CD. If you can afford a computer, you can afford to pay $16 for my CD.”—Eminem Wall of Sound May 17, 2000
“ . . . [But] right now, if it's affecting anybody, it's affecting a band like us. Metallica sells millions of records, you know what I mean? They're not in the hot seat as much as we are . . . Our new record, it hasn't even come out yet, and I'm sure probably a quarter of our fan base have already heard it. We just have to hope these people still buy our record when it comes out, but it's kind of scary for us.”—Chino Moreno of the Deftones Sonicnet.com Jun. 7, 2000
“In the genre of music that *NSync does, fans want more than just the record. They want the whole package, they want the packaging and the credits and the pictures and the thank you's because they're true fans of the band so they want to have a memento of everything the guys wanted for their fans. So if you can download it off the Net, yeah, you're going to get the music, but you're not going to get the other things. So I think in some cases, it wouldn't be as big of an impact on us because of the fans that we reach. But still, if somebody is going to work on their craft, they should have the opportunity to benefit from the rewards of their work, and not have someone put it up on the Net so people can steal it.”—Johnny Wright, *NSync manager Sonicnet.com Jun. 7, 2000
“ . . . there should be some way that Napster compensates the artists. Because obviously they wouldn't be providing a service if they weren't getting compensated, it's not a free service, it's not like it's done just to please fans. Everything that's done is done for a profit.”—Scott Weiland of Stone Temple Pilots Sonicnet.com Jun. 7, 2000
“It's not even just about money, the quality is lesser. That's not good. We work really hard to make the music sound good, so we want people to hear it the way it actually sounds. So I would give it a thumbs down.” [sonicnet.com: “MP3s are actually close to CD quality.”] “Oh, well, still thumbs down.”—Arion Salazar of Third Eye Blind Sonicnet.com Jun. 7, 2000
“It sounds kind of parochial to say this, but you have to play by the rules. There's rules that have been established over a long period of time. The rules aren't always the right rules, but you have to [follow them] . . . If [Public Enemy rapper and Napster supporter Chuck D] can figure out a way to get paid somehow with music getting downloaded without people having to pay for it, then good for him. That doesn't work for me, I've got three kids now.”—Jimmy Jam, producer Sonicnet.com Jun. 7, 2000
“It totally pisses me off, because musicians get hardly any money from this at all. I could make more money washing dishes at the moment. It's unfair . . . ”—Dandy Warhols guitarist Peter Holmstrom Sonicnet.com Jun. 7, 2000
“It's beneficial and unfortunate at the same time. It's beneficial because people are getting into your music. It's unfortunate because it's harder to keep control of your music and your career.”—Ideal singer P. Z. Sonicnet.com Jun. 7, 2000
“The foundation of every industrial country is the preservation of property rights, and it boils down to that. So I'm not really sure why intellectual property would be an exception.”—Tal Bachman Sonicnet.com Jun. 7, 2000
“Maybe there's some really independent cool band that by this method gets some word around. The problem is, in the future, how are they going to make it? Maybe they think they can make money from their performances, but I don't know if that's something you can count on.”—Green Velvet (a.k.a. Cajmere) Sonicnet.com Jun. 7, 2000
“I am excited about the opportunities presented by the Internet because it allows artists to communicate directly with fans. But the bottom line must always be respect and compensation for creative work. I am against Internet piracy and it is wrong for companies like Napster and others to promote stealing from artists online.”—Elton John

### “Artists, like anyone else, should be paid for their work.”—Lou Reed

“Let's get the obvious out of the way: This is not just about money (as some of the more cynical people will think). This is as close as you get to what's right and what's wrong. Metallica have always been in favor of giving the fans as much access as possible to our music. This includes taping sections at our concerts, and streaming our music via our website. And while we certainly revere our fans for their continued support and desire for our music, we must stress that the open trading of any copyrighted material is, in effect, the looting of our art. And that is something that no artist can, in their right mind, condone. We are in the business of art. This is a walking contradiction if ever there was one. However, there is no denying it. On the artistic side, Metallica create music for ourselves first and our audience second. With each project, we go through a grueling creative process to achieve music that we feel is representative of Metallica at that very moment in our lives. We take our craft—whether it be the music, the lyrics, or the photos and artwork—very seriously, as do most artists. It is therefore sickening to know that our art is being traded, sometimes with an audio quality that has been severely compromised, like a commodity rather than the art that it is. From a business standpoint, this is about piracy—a/k/a taking something that doesn't belong to you; and that is morally and legally wrong. The trading of such information—whether it's music, videos, photos, or whatever—is, in effect, trafficking in stolen goods. Back to the obvious: Very successful recording artists are compensated extremely well for what they do. For every Metallica, however, there are an endless number of bands who rely on what ever they can get in royalties to survive. And while we all like to take shots at the big, bad record companies, they have always reinvested profits towards exposing new bands to the public (although sometimes not the RIGHT bands). Without this exposure, many fans would never have the opportunity to learn about tomorrow's bands today. Napster and other such sites were obviously not conceived to lose money. They, like the labels, must make money or they're out of business. And whatever money they are generating from their site is dirty money. It's being taken out of the hands of the artist and the record labels and put into the hands of another corporation.”—Lars Ulrich of Metallica
“As an artist and songwriter I believe that this is an issue that needs to be looked at and taken very seriously. In what other industry can someone take a product, not created by themselves, make money from the use of that product and not compensate the original creator? Someone needs to take a stand and protect the songwriters and artist.”—Victoria Shaw, country music singer/songwriter
“I think the fact that Napster is stealing recorded music is something that we have to stop. It's taking money out of my kid's mouth. That's the way I look at it. It's wrong. It's inherently wrong. It's stealing.”—Art Alexakis of Everclear
“As a band, we are incensed at the amount of disregard Napster has toward how musicians make a living. We only get paid from our recordings if they are bought in legal ways. By disregarding copyright laws we lose out. We are a ‘baby band’, struggling to stay alive financially. Every dollar we lose to “fans” stealing our music hurts . . . if folks knew that the majority of the major label bands are not making any income from their recordings . . . and losing money by touring, they would be astounded and a bit more sympathetic to the artists. What is supposed to set the industry free is killing it.”—The Push Stars

### “There are laws against piracy in this country, and unless we enforce them, how do we expect any other country to care about protecting our rights from piracy?”—Denyce Graves, RCA Victor Red Seal, Classical recording artist

“Everyone I know is excited about all the possibilities the Internet has to offer. As a musician, the Internet has made it possible for me to share my music with people that could have never been reached by conventional methods. It has been taboo for artists to speak out concerning the business side of their music. The fear has been that the buying public, as well as other artists, would perceive this concern as greed, and that the artists' sole purpose for creating was the money. This perception has silenced many artists concerning MP3 and Napster. The silence must end. As a child I created music to express my inner thoughts and feelings, and that purity has stayed with me throughout. The day I decided to share my music with the world, was the day I decided to walk the fine line between art and commerce. I have been blessed in that I do what I love and can support my family with what I create. When my music is given away, as taboo as it is for me to say, it is stealing. I need not defend my motives for making music, but the distribution of my music has made me business conscious. I have decided to sell my music to anyone who wants it, that is how I feed my family, just like a doctor, lawyer, judge, or teacher. Not to insult anyone's intelligence, but my music is like my home. Napster is sneaking in the back door and robbing me blind.”—Scott Stapp, lead singer/lyricist for Creed
“It's high-tech bootlegging, with artists definitely losing revenue. I appreciate that people like my music enough to download it. But we need to join forces and fight this.”—DJ Scratch, artist/producer Billboard Apr. 15, 2000
“[Napster] is particularly discouraging to young artists and songwriters trying to get their foot in the proverbial door of the music business. I suppose it should be a compliment that people dig your music so much that they're swapping it online. But thievery is thievery. If you dig an artist that much, then you should want to help keep that artist alive by purchasing the actual recording.”—Anastacia, Daylight/Epic recording artist Billboard Apr. 15, 2000

### “If artists don't get paid for making music, how are they supposed to survive? Stealing from an artist is not the best way to show your appreciation for their work.”—Aimee Mann Entertainment Weekly Mar. 31, 2000

### “Artists should be compensated for the work that they do.”—Deborah Harry of Blondie Salon Mar. 25, 2000

### “No matter what you do for a living you should get paid for your work, whether you're washing dishes or recording songs.”—Bif Naked Salon Mar. 25, 2000

### “Nobody wants to look the artist in the eye and say, ‘Giving your music away for free is going to make you lots of money’—not while keeping a straight face, anyway.”—Kristin Hersh, Throwing Muses Salon Mar. 25, 2000

“Artists should be compensated for their work and protected against a technology that allows copyrighted music to be illegally downloaded. But Napster and technologies like it are just a part of the overall problem. Intellectual property in the Internet Age must be staunchly protected. Without meaningful safeguards, the livelihood of the creative community is at risk.”—Mike Greene, President and CEO National Academy of Recording Arts and Sciences
“ . . . We send them [artists] to Napster and they see all their work being given away for free, and they're stunned and horrified. What disturbs me the most is that artists are never discussed. Artists just seem to be a ping-pong ball whacked back and forth and nobody gives a fuck about them. And it turns out Napster's no better than the record companies. In fact, they're worse, because they're offering nothing and taking everything. Napster's the tip of the iceberg. The broader question is intellectual property on the Internet. Intellectual property should be valued and protected or we'll go down. And not just music either. Why would anybody sit down and write a novel it it's going to be pirated for free the first day it's released. If nobody values intellectual property, then we'll all be in the insurance business.”—Ron Stone, Gold Mountain Management (represents Bonnie Raitt, Tracy Chapman, Ziggy Marley and others) Salon Mar. 25, 2000
“The artists, writers, and labels aren't being compensated. It's certainly not the way copyright laws were set out to work . . . when managers and artists and labels have no control and it's a free-for-all out there, it's problematic.”—Mike Robertson, Mike Robertson Management (represents Nitty Gritty Dirt band, Wade Hayes, BlackHawk and others) Billboard Apr. 15, 2000
“All of a sudden a song could get out without the act's knowledge or the label's knowledge, and all the hard work that's been put into the project is then lost.”—Ken Crear, Creative Management Group (represents Next, Sisqo, Mary Mary and others) Billboard Apr. 15, 2000

### “Napster is robbing me blind.”—Chris Robinson of the Black Crowes Salon Mar. 25, 2000

“It pisses me off and I resent it. I spent $15,000 on my Web site. I paid a publicist for a year and a half out of my own pocket. And now some kid's going to tell me my catalog should be free? They're just entrepreneurs setting themselves up to make a ton of money off other people's work. Where's the compensation for the artists? I know people using Napster are chuckling about kicking big, bad record labels. But as evil as the record companies may be, at least they're paying for your recording budget, and at least they're promoting you, and paying for tour support. We can make a new model-yeah right. It's laughable. Those people have no idea how the music business works. Because unless you're Alanis Morissette or Dave Matthews, you're not making money on the road. It's all I can do to break even on tour. And the only reason to tour is to promote the sale of my CD.”—Jonatha Brook Salon Mar. 25, 2000
“Our label is behind us from the start. They work hard for every nickel they make off us. They deserve to be paid. It's a no brainer. If it's not scanned, then the label at the end of the year says so long, and all of a sudden our careers are over, and I'm back at McDonald's.”—Morgan Rose, Sevendust Salon Mar. 25, 2000
“If Napster had our best interest in mind then they would ask our artists. Nobody at Napster has ever called to ask our permission. Artists say ‘Ask me.’ Explain what it is and ask if I want to participate. But Napster doesn't give them an opportunity. They're basically saying ‘fuck the workers.’ Let them work their asses off and we'll give it away for nothing. The bigger the lie the more you get away with, I suppose. There's no question Napster's going to lose in court. The only question is how much money in damages they'll have to pay. I hope it's enormous because then the big money investors, which Napster needs, will walk away.”—Cliff Burnstein, Q Prime Management (represents Red Hot Chili Peppers and Metallica) Salon Mar. 25, 2000
“Investors are going to realize it's a theft business and ask, how does it make money? It doesn't. It's all very well to say music should be free, but the reality is if you don't pay the artists, the road crew, the musicians, the recording studio, if there's no money in music, there's not going to be much music left. How many people would be doctors is they had to work for free? What if we said, ‘Hey, the airlines are ripping us off and we don't want to pay for tickets, we'll just steal them.’ Guess how long the airlines would last? If it becomes free, then it becomes extinct.”—Miles Copeland (manager for Sting) Salon Mar. 25, 2000
“I couldn't believe it when I found out that this Napster was linking thousands of people to the new Notorious BIG album “Born Again,” a week before it even hit the streets. This album is a labor of love from Notorious BIG's friends to the man, his kids, the rest of his family and everyone else whose lives will never be the same since BIG passed. BIG and every other artist Napster abuses deserve respect for what they give us.”—Sean “Puffy” Combs, CEO, Bad Boy Entertainment, Inc.
“Dixie Chicks and Senior Management are huge fans of the Internet and its possibilities. While there are great efforts being made to ensure that the rights of the artists and songwriters are protected, Napster's apparent way of doing business sets those efforts way back. If the Internet thieves are not stopped or better regulated, it not only robs current artists but might have even more serious repercussions for the next batch of artists. I support and applaud the RIAA on their efforts to make sure that Internet companies are not stealing the rights of the people who make the music.”—Simon Renshaw, Senior Management (personal manager of the Dixie Chicks)
“Copying and distributing music illegally is the ultimate discrimination. It sends a message to our neighbors who create musical art that what they do, who they are, is not important enough. Does it matter? I can think of several stories where the rights of a particular group of people were deemed unimportant. None of them have a happy ending. Therefore, I strongly urge the operators of NAPSTER to use their technological acumen to bring an end to the trafficking of pirated musical works.”—Frank Breeden, President, Gospel Music Association, Inc.
“With the increasing accessibility of music on the Internet, and the new technology available on it, there must be a matching increase in responsibility. Without public accountability, this responsibility reverts to groups like the RIAA to seek out those who are misusing the advances in technology and to the courts to adapt and enforce the law. Napster is allowing people to disregard copyright laws because they were not written in the spirit of today's technology. These copyright laws are the only things that protect what musicians do for a living; write songs. Napster is allowing people to steal these songs.”—Jeff Cameron, Jeff Hanson Management & Promotions (represents Creed and other artists)

### “Napster is undermining the efforts of creators and innovators of all kinds who are at the forefront of the electronic marketplace.”—Robert Holleyman, President and CEO, Business Software Alliance

From: http://www.riaa.com/about/artists/quotes.asp

### Technology is a Commodity

As technology is a commodity while art is unique in all its individualist glory, the artists ought sit in the driver's seat on the internet, and they will. Aristotle once said that history tells us the way that things are, and story tells us the way things ought to be. And thus the boomer-elite detest lasting, classical story, which passes eternal judgment and sets the artists free. The boomer-elite detest art, and wish to replace it with Simon Cowell, American Idol, myspace bands which are myspace first and bands second. Anything that grows government and erodes private property rights is good, as the boomer elite already have their money and homes, and now they want yours too.

The present invention will liberate artists from the taxing, confiscatory practices, and the degraded, mob-rule mentality of the aggregators, who always place the bottom line over the higher ideals in all their selfishly defined humility. They preach the democratization of technologies, but they prevent artists from accessing DRM. Only Steven Jobs is allowed to use DRM to profit, and only Steven Jobs is allowed to promise DRM, and then destroy DRM, enriching the aggregators and device makers at the expense of the artists.

The present invention bypasses Steven Jobs and the aggregators. The present invention allows the artists to define their rights, and then Steven Jobs and the pomo-hipster aggregators must come to the artists, and negotiate based on the artist's terms. If the iPod can't pay the artists the 70 cents per song they demand, then the iPod will not serve the artist's songs. Other device makers will step forth to serve the artist's needs. If people do not want to pay for the artist's works, then they can listen to mysapce bands and watch youtube films all day long.

The internet is a nascent innovation, and as the universities are dominated by leftists, and as ideas have consequences, the dominant theology is that indie artists must not and cannot have any rights. The dominant technology is that DRM is a most dangerous entity, and allowing artists to protect and profit from their content will cause global warming to accelerate. If DRM is given freely to the people, children in underprivileged neighborhoods will encrypt their songs—they will protect and profit from their creations—and Larry Lessig's friends at Google and youtube will not be able to aggregate and monetize the content, an civilization will end. Instead of John Wayne and Audrey Hepburn, the leftists cackle and promote Lindsay Lohan and Orlando Bloom. Instead of Johnny Cash, the self-satisfied boomers support a Godless Constitution, cackle, and promote Simon Cowell and American Idol, which is first and foremost about Fox, then about Simon Cowell, placing the art—the heart and soul-dead last.

The heart and soul, along with higher ideals, get in the way of the bottom line counted down in dollars from the mint, and thus the boomer elite media mavens, and their useful idiots, detest the heart and soul, Johnny Cash and John Wayne, Audrey Hepburn and Grace Kelly.

Today a law/mba degree is often little more than a ticket to pillage and plunder pensions and come up with deceptive marketing campaigns. In college the mbas/lawyers study Dave Eggers instead of the Great Books and classics, and they learn the degraded, ironic art of hyping and lying, of cheating and deceiving, of finding some fallen arena of groupthink, and harnessing oneself to it, so that they too might share in the massive wealth transfer from the artist and creators, from the preachers, teachers, and firemen, to the distant lawyers and bankers, to the owners of Starbucks and Barnes and Noble, which place Dave Eggers books on the front tables.

I recall well the day we drove out to the snow-covered February hills of Hillsborough, N.C., and we met with a man who was friends with Eric Clapton, in his state-of-ther art recording studio. There, he had been recording the blues artists of North Carolina—the originators of the artform of whom there were all too few recordings. Well, I was representing a company that was founded by someone who had profited vastly in the dot-com bubble, as the insiders took everything public, jacked up the price, and then pillaged and plundered the common man's pensions, savings, and retirements, as seven trillion was transferred from the common investors to the elite. It was so bad that they had to print more money, so they lowered interest rates so people could go into further debt, borrowing against their houses, so that the end result was not only did Wall Street end up with everyone's savings, investments, and pensions, but it ended up with their houses too. The postmodem boomers are driven to recreate the world in their own image, and so everything they touch becomes a bubble. Be it medicine, law school, the church, technology, or real estate, the fundamentals and the higher ideals are thrown out of the way, and the best suited to dishonesty—the marketers and hypesters who humble themselves before the degraded whims of the masses-profit immensely, cashing out on the cultural heritage that was bought for in blood, sweat, and tears-trading in that most precious freedom that never comes free, for baubles, trifles, land, titles, and other fleeting pleasures of the flesh and ego. Covenants were replaced with contracts, as contracts are far more easily dissolved, and the dissolution of the family is a vast and great short-term profit center, as it divides man against woman, children against parents, and hands everyone a credit card or two, and tells them to go forth and go in debt—to consume, consume, consume—to store up treasures on this earth, as heaven is an outdated subject, along with immortal truth, beauty, and rightesousness.

And as artists are the sacred vessels of the exalted, as art is the exalted vessel of Epic Story, of course the boomer elite had to detest DRM at its fundamental level. Communists and socialists, by foolishness or evil, are always excellent short-term investors. Because they are inherently uncreative and mediocre, they must gain their sustenance by exploiting the artists, photographers, models—the content creators—and they must legislate against any system that aims to provide artistic entrepreneurs with the ability to protect and profit from what they create.

Anyways—back to the North Carolina recording studio. The owner was good man—a ine, idealist man—the kind you rarely run into on a college campus these days or in the corporate boardroom, and he kind of smelled where we were coming from. The other people I was with—well one of them in particular—was a bit arrogant, so the owner of the recording studio called him out.

“You're here for my content. I don't need you. You need me.”

He called the bluff. He called the dot-com bluff which had awarded the company we were representing with millions of dollars—all transferred from trusting investors to the soulless marketers, hypesters, and bankers.

“Well I know your boss. I know men far richer than he. Both monetarily and spiritually. And they all say that your boss in an Asshole.”

So it is that A Prominet Content Aggregator prides itself in publishing A Prominent Hipster Author: “My name is A Prominent Hipster Author, and I am an Asshole.”—the ultimate product of the heartless, soulless law school—the exultant creation of the feminist movement which robbed him, along with so many others, of a father, and the definition of higher art driven by the bottom line. A Prominent Hipster author is a victim of society, and it is sad to see multi-millionaires profiting off of him. But it just goes to show that even with an infinite amount of money, one can yet be a very poor man, incapable of the vast wealth that comes from the ability to pass judgment, and the vast accompanying freedom that comes with the ability to speak God's Truth. But A Prominet Content Aggregator is not about art nor artists—it is about enriching the founder. Shakespeare is about art and artists. Melville is about art and artists. 50 cent is about art and artists. A Prominent Hipster Author is about art and artists.

No longer will artists be paid only seven to eleven cents of every ninety-nine cent download, only to see Steve Jobs come out against DRM, so that the aggregators and device makers might profit while the artists starve.

The present invention, by respecting DRM, will foster a vast and immense cultural renaissance, as it will allow artists to protect and profit form their creations as never before, thus providing greater incentive to create lasting, log-term art.

Too many Web 2.0 companies rushed forth with the “we're all equal—the long end of the tail rules-hits are no good,” favoring short-term mediocrity. However, dedicated artists such as J. R. R Tolkien and George Lucas must devote their entire lifetimes to creating their works, and the current Web 2.0 companies do not favor nor support their efforts, as without DRM, it becomes impossible to support oneself from one's art. Instead, the web 2.0 companies make billions off of it, and hire lawyers and donate to law schools to obfuscate the Constitution and promote the myth that digital rights management is dangerous, evil, and bad. Follow the money, and you will see the jealous, uncreative souls profiting off the dedicated, tireless labors of the artistic entrepreneurs—the natural founts of wealth.

The present invention, by offering a trusted repository/application for artists where they can define their rights, and then allowing the DRM providers and device makers to bid on it, creates a DRM marketplace that best serves the artist and consumer. The vast majority of consumers are happy to pay a few dollars for the art they love, and the present invention will allow the artist to get the lion's share of the money that is used to purchase their art.

Because artists provide the spirit and the soul, and because they do it for the sake of doing it, they are perpetually exploited by the aggregators, money men, and socialist/communists who declare that call content is free, so that they might aggregate it and buy themselves vast mansions. Try walking around youtube or google with a video camera, and see how long it takes for them to call the police. Try loading that clip onto google/youtube. “Information wants to be free,” they say, but some information is more equal than others, as they turn right around and protect their trademarks, trade secrets, copyrights, business methods, and bank account information. Indeed, in the wake of all the scandals concerning backdating options, not only does information want to be free, but it also wants to be false. A little satire helps illustrate the point:

### The Steve Jobs essay reads: “Why DRM and Locks on Apple Stores are Dumb by Steven Robs (aka Dr. Elliot McGucken)

### http://www.apple.com/hotnews/thoughtsonmusic/

With the stunning global success of Apple's iPod music player and iTunes online music store, some have called for Apple to “open” the digital rights management (DRM) system that Apple uses to protect its music against theft, so that music purchased from iTunes can be played on digital devices purchased from other companies, and protected music purchased from other online music stores can play on iPods.

Imagine a world where every online store sells DRM-free music, software, movies, and video games encoded in open licensable formats. In such a world, any player or console can play music or games purchased from any store, and any store can sell music, movies, and games which are playable on all players. This is clearly the best alternative for consumers, and Apple would embrace it in a heartbeat. If the big four music companies, and software companies, and Hollywood studios, and video game companies, would license Apple their music, movies, video games, and software without the requirement that it be protected with a DRM, we would switch to selling only DRM-free music, movies, and games on our iTunes store, and DRM-free software in our stores. Every iPod ever made will play this DRM-free music and movies, and we shall give them away for free, along with our trendy iBooks.

In order to lead this initiative, Pixar will begin offering all of its movies for download upon the Apple website, in DRM-free formats, which one can rip, mix, and burn on any device. The record companies caused the Napsterization of the recording industry by being too slow to give their content away for free, and in order to thwart pirates, Hollywood must beat them to the punch. Software too shall be given away for free in DRM-free formats. Final Cut Pro and the Mac OS X will lead the charge. One of most burdensome characteristics of software is that if the customer loses the box with the license key, the customer must purchase an entire new copy to install the software on a second device. This is “unfair play,” und thus all software shall henceforth be released license-free, along with its source code. Now that both Macs and PCs run on Intel architectures, it makes sense that all software should be able to run on all devices.

Just as the musician shall voluntarily give up their rights to their music in this brave new world, Apple will be releasing all of its patents and trademarks for the public good. Citizens are encouraged to show up to Apple with video cameras, walk around, attend meetings, and post the videos to youtube, as information wants to be free.

DRM has failed. The problem, of course, is that there are many smart people in the world, some with a lot of time on their hands, who love to discover such secrets and publish a way for everyone to get free (and stolen) music. They are often successful in doing just that, so any company trying to protect content using a DRM must frequently update it with new and harder to discover secrets. We cannot win. Nor can car security systems nor digital security for banks triumph, as brilliant hackers share secrets about cracking these burdensome entities on the internet. So often it is that customers, forced to buy cars with locks, find themselves locked out of their very own cars!

Starting next week, Apple employees shall be forbidden from locking their cars, and the bank DRM that protects my back-dated stock options shall be removed, as no security system can be superior to hackers, and it is a mark of hubris before Zeus himself to even try. Locks are being removed from Apple stores, so come on by and get your free iPod for your free music, along with a free black turtleneck.

A brave new day is dawning, so drop on by the Apple site to download the following Pixar movies and software in DRM-free formats: The Incredibles, Toy Story, Finding Nemo, A Bug's Life, Cars, and Final Cut Pro. We might have an option for you to pay, or you can use your friend's DRM-free version on your Zune.

Make no mistake—the intermediary class that taxes and torments the people at every turn—the postmodern, soulless, snarky lawyer/mbas who grow the government while pretending to shrink it, who give us Wall Street scandal, after scandal, after scandal, who took our savings in the dot-com bubble and our homes in the real-estate bubble, hate Johnny Cash. They detest the Great Books and Classics—they detest the Odyssey because it is a book about faith and the family, and the family gets in the way of their short-term snarky profits. They detest Dante's Inferno as it exalts women, and the love story gets in the way of their short-term profits. They hate the Constitution and fear Declaration of Independence, and create law schools to twist and contort the simple common-sensical worlds, turning God's Law into a marketplace where ideals are bought and sold as if they were prostitutes. And that's not a dig at prostitutes, who have to make a living in this rough and tumble world—may they sin no more, but I say that the exalted, wealthy lawyers are hundred times as worse.

An artist's art is not a lawyer/mba/blogger/technoartis's to take, and it's not theirs to give away. An artist's art is not related to profit the aggregators who perpetuate the most pernicious myth that artists and authors are of no value on their own, but only have value in the context of the State, the Corporation, and the Machine.

The present invention liberates artists and entertainers-directors and producers—from the billionaire feudal Lords who hire the Larry Lessigs to whine and dine their compatriots at ceremonies of vast pomp and circumstance.

The present invention rights the inverted world by providing rising Hollywood filmmakers, actresses, and actors an opportunity to protect and profit from their creations. The present invention—a DRM marketplace and search engine—allows the artists, producers, and owners to set their terms, and it then lets the snarky aggregators—the Lessigs, double-speakers, lawyers, communists, and socialists, compete to distribute it. An over time, the double-speakers will fade—eternity will wash way their contortions and false convictions and conceits that mark the temporal, misled machinations of men harboring ambitions overshadowing their talents. For lawyers and middling mba middlemen do not understand the blood, sweat, and tears that go into creation. They do not comprehend the divine gift that art is—how it is a gift given to an individual, and how the individual freely passes it to society. But the Founding Fathers did understand this and they left us with a constitution.

Just as the postmodern elite found abortion in the constitution—the right to kill the unborn and innocent—they will find the right to pillage, plunder, and steal the indie artists' rights to protect and profit from their creations. We're all part of a far greater story than we think. With a straight face, they will say that no DRM is the best DRM, that no DRM benefits the artist, that no DRM benefits the consumer, that no DRM will foster the creation of better and greater movies and mashups, as mashups—the result of collective collusion—are inherently better than the individual's vision.

Modern lawyers have little love for literature and the arts—that is why they are able to endure years and years of case studies, which obscure the classical ideals and higher justice that is known by Epic Story. Lawyers are natural, soulless deconstructionists, incapable of art, and they wish to create the world in their own image—soulless mashups, propagandistic documentaries, snarky, puerile remakes, potless, characterless novels, and snarky-snarky-snarky-snark-snark government lobbyists.

Like all the suitor heathens, slobs, and cowards in The Odyssey, laying waste to Odysseus's vast wealth while trying to win Penelope's heart, the intermediary lawyers/mba class is laying to waste our sacred heritage and assaulting the classical spirit by which indie artists thrive. The destruction of truth, the desecration of the handshake, and the defilement of classical honor is the lawyer/mba's way to harness the broken families to the yoke of the machine—the machine that profits via debt, rather than by art.

While NY Times film critic A O Scott loved Grindhouse, he detested 300. This is because he detests Epic Story, as the pomo-hipster elitist must, as story gets in the way of Wall Street's short-term bottom line.

Once upon a time we had Bob Dylan and Johnny Cash. Today it's American Idol. Once upon a time we had John Wayne and Audrey Hepburn. Today we have Lindsay Lohan and Orlando Bloom.

Steve Jobs is the king of proprietary formats and DRM. He could have licensed Apple's DRM to other competitors and collaborators, but he did not. He could give way Pixar's movies in DRM-less formats, but he does not. He gives away other people's works in his own proprietary formats:

http://www.mobilemag.com/content/100/337/C12242/

### DRM-free Good for AAC-compliant Players Only Tuesday Apr. 3, 2007 6:11 AM PDT—By: Dave White

### “Don't start doing the Superior Dance just yet.

That DRM-free music that Apple and EMI have trumpeted is all well and good for iPod users, but what about Sandisk? That's right, we're talking about AAC files . . . In DAP land, there's a clear delineation between players that can play AACs and those that can't. If you own a portable music player made by Apple, Microsoft, Nokia, Sony, or Sandisk (just the e200s), then you're safe because these players will let the sounds of your favorite artists issue forth from their AAC-encoded files. However, if you threw in your lot with Cowon, Creative, Philips, Sandisk, or Toshiba, all you'll hear is the sounds of silence because those companies' players don't support AAC. This probably isn't a permanent condition, but it's the case now. You've been warned. DRM-free AACs: Isn't that special?”—http://www.mobilemag.com/content/100/337/C12242/

Apple and itunes and Steven Jobs are remnants of the pre-internet era. They're all about locking down standards and control, transferring all the wealth to the record companies and device makers, and all the risk to the indie creators. They announce the end of DRM while keeping their content in a proprietary format. Long ago, Steven Jobs could have opened up Fairplay to the rest of the device makers, fostering an openness that would enrich both the artists and the consumers with better art and more profits for the artists, but he chose not to.

The present invention realizes the full glory of the internet, by placing the choice of DRM securely in the artists' hands.

The dying record industries and commoditized device makers are desperately trying to render the artist's Natural Rights null and void. With legions of fanboy lawyer/mbas/technorati on their side, their rants and raves against the simple beauty and elegance of the US Constitution often drowns out the higher glory of Epic Story. But no matter how hard they try, they cannot change one word of the constitution, and while they deconstruct their own souls and go through acrobatic groupthink contortions, like one giant extreme yoga class, all to convince themselves that lawyers such as Larry Lessig are superior to artists such as Johnny Cash, they fall short in reality, though not in their own minds.

The contemporary legions of fanboy mba/lawyers, who are manufactured to further Wall Streets pillaging of pensions and savings, also enjoy profiting off of that which artists dedicate their lives to art.

Some are unable to see the truth. Some do see the truth, but choose to ignore it as there is more money to be made in ignoring the truth. But the fanboys are all united in this—they will engage in ad hominem attacks and underhanded maneuvers common to all communistic systems, all for the sake of pillaging pensions and art. They love American Idol. They love Brokeback Mountain. The love Grindhouse. They hate true art such as Braveheart, 300, Johnny Cash, Bob Dylan, Herman Melville and William Shakespeare. They do not understand true art, nor philosophy, and that is why it is so easy for them to ignore it. That is why it is so easy for them to think that true art matters not. They understand not the greatness of the Creator who is mentioned in our Declaration of Independence.

The snarky pomo-hipster lawyer/mba fanboys railing against DRM, legislating against DRM, and blogging against DRM are very much like those in Plato's Caves, shouting at the shadows on the wall, as Steve Jobs manipulates them to serve his purposes. But the true artists alone see the reality, for they alone understand that art, like freedom, don't come free. It is bought by blood, sweat, and tears. The Founding Fathers understood this, and it's why they gave us a Constitution which granted every artist, author, and inventor the right to protect and profit from their creations.

“America's abundance was created not by public sacrifices to the common good, but by the productive genius of free men who pursued their own personal interests and the making of their own private fortunes. They did not starve the people to pay for America's industrialization. They gave the people better jobs, higher wages, and cheaper goods with every new machine they invented, with every scientific discovery or technological advance—and thus the whole country was moving forward and profiting, not suffering, every step of the way.”—Ayn Rand, Capitalism: The Unknown Ideal

Google is a leftist company because they already have all their money, and they want yours too. They are for higher taxes because they don't pay taxes. They want toy books, your art, your creations, and if you're nice, they will let you put little google ads on it, so that you can make a couple bucks, and they can make a few billion. By being leftists, rich liberals raise the ladders by which they climbed to success, cutting off the competition.

“Aristotle may be regarded as the cultural barometer of Western history. Whenever his influence dominated the scene, it paved the way for one of history's brilliant eras; whenever it fell, so did mankind.”—Ayn Rand, The Voice of Reason

I am no stranger to ad hominem attacks from socialists and little lawyers. Socialism is a seductive philosophy for those who seek to make a virtue out of mediocrity and uncreativity. Larry Lessig is no Johnny Cash. Johnny Cash was a great American—for God and Country. Larry Lessig is for the bottom line—for the good of the elite, at the expense of the inner city artists and entertainers. It has always been curious to me why Lessig et al think that the elie billion aggregators at google have a greater right to profit from an artist's work than does the artists, be they in a major studio or on the streets. It's almost as if they want to keep their wives/partners in business growing government foundations and the welfare state, by denying artists their fundamental rights. At any rate, as socialists and communists must protect their profits and their myths at all costs, I expect the very best in the way of snarkety-snark from them. Go ahead—make my day.

Indeed, they must kill those who come back down into the Cave to tell them of reality—of Truth and Beauty—of that higher justice ecapsulated in the Epic Stories of the Great Books and Classics, of Shakespeare and the Bible, whose they have banned and replaced with case studies and snarky bloggedy-blogs—all for the sake of boosting their bottom line, transferring all the wealth to themselves, and all the risk to the people, as every communist/socialist/Godless soul has done from the dawn of time. Make no mistake—they profit handsomely from the glorious Declaration of Independence and Constitution, and cash in on our vast cultural heritage for the sake of fleeting, superficial riches. Mob mentality and group think are their Gods—the command us to blink and never blink, and work and slave away for their advertisement-supported kingdom.

The present invention, by making all the aggragators compete for the honorable right to protect and distribute the artist's content, rights the universe. For we do not buy computers to read Larry Lessig's novels, to read Larry Lessig's books, to listen to Larry Lessig's music, and to watch Larry Lessig's movies. We do not pay for internet access to download the creations of lawyers and MBAs such as Simon Cowell. We yearn for Art-divine, sacred Art that reminds us of our own glorious individuality.

Because this invention represents a massive paradigm shift which returns the profits to the artists and creators, it will be opposed by tens of thousands of lawyers, mbas, and journalists. They are to be forgiven, for many of them see but one foot in front of them, and if they read it on a blog, it must be true, and so they link to it, and it becomes true. Because they never read the Great Books or Classics, because they never exalted in the supreme glory of God—that God at the center and circumference at the American soul, they connive and contemplate the destruction of the true artists, recreating art in their own image, as Boomers will not be satisfied until every Form of Reality has been inverted to match their infinite egoes. But they are not immortal. They will pass on. And the children—the artists not yet born—will build the world anew, never pausing to wonder at Larry Lessig's art, as he never created any.

But for now, as I walk sown into the cave to serve my fellow men, artists, and creators with this invention, they must attempt to kill me—to defend me, to slander me, to spread lies and deceit. But they have no power over me. Not even Bill Gates himself can close the Gates of eternity's verities. He too had a chance to create this DM marketplace, but he did not, as while a nice guy, I'm not sure he ever understood the artistic foundation of the moral premise—for all of our laws ultimately come to us via art—via Epic Story. Moses came down from the Mountain with the Ten Commandments—one of which says, “Thou shalt not steal.” He did not come out of a Starbucks, as did Larry Lessig, speaking in tongues and declaring that thou shalt not protect and profit from your creations.”

The postmodern boomer ride was a lot of fun, but it's time to move on. As the spirit of this patent rails against their destruction of Truth and Freedom, of Faith and the Family, of American Idol and Reality TV and all they manufacture to replace Epic Art with bottom-line-driven machinery, they will seek to put me to death. Plato foretold this in Book 7 of the Republic—for like the shadows on the wall American Idol is their divine reality, as it places Simon Cowell—a snarky, mean-spirited Boomer-above art.
And if there were a contest, and he had to compete in measuring the shadows with the prisoners who had never moved out of the den, while his sight was still weak, and before his eyes had become steady (and the time which would be needed to acquire this new habit of sight might be very considerable), would he not be ridiculous? Men would say of him that up he went and down he came without his eyes; and that it was better not even to think of ascending; and if anyone tried to loose another and lead him up to the light, let them only catch the offender, and they would put him to death.

Book VII: on Shadows and Realities in Education

### (SOCRATES, GLAUCON.)

AND now, I said, let me show in a figure how far our nature is enlightened or unenlightened: Behold! human beings living in an underground den, which has a mouth open toward the light and reaching all along the den; here they have been from their childhood, and have their legs and necks chained so that they cannot move, and can only see before them, being prevented by the chains from turning round their heads. Above and behind them a fire is blazing at a distance, and between the fire and the prisoners there is a raised way; and you will see, if you look, a low wall built along the way, like the screen which marionette-players have in front of them, over which they show the puppets.
I see.
And do you see, I said, men passing along the wall carrying all sorts of vessels, and statues and figures of animals made of wood and stone and various materials, which appear over the wall? Some of them are talking, others silent.
You have shown me a strange image, and they are strange prisoners. Like ourselves, I replied; and they see only their own shadows, or the shadows of one another, which the fire throws on the opposite wall of the cave?
True, he said; how could they see anything but the shadows if they were never allowed to move their heads?
And of the objects which are being carried in like manner they would only see the shadows?
Yes, he said.
And if they were able to converse with one another, would they not suppose that they were naming what was actually before them?
Very true.
And suppose further that the prison had an echo which came from the other side, would they not be sure to fancy when one of the passers—by spoke that the voice which they heard came from the passing shadow?
No question, he replied.
To them, I said, the truth would be literally nothing but the shadows of the images.
That is certain.
And now look again, and see what will naturally follow if the prisoners are released and disabused of their error. At first, when any of them is liberated and compelled suddenly to stand up and turn his neck round and walk and look toward the light, he will suffer sharp pains; the glare will distress him, and he will be unable to see the realities of which in his former state he had seen the shadows; and then conceive someone saying to him, that what he saw before was an illusion, but that now, when he is approaching nearer to being and his eye is turned toward more real existence, he has a clearer vision-what will be his reply? And you may further imagine that his instructor is pointing to the objects as they pass and requiring him to name them—will he not be perplexed? Will he not fancy that the shadows which he formerly saw are truer than the objects which are now shown to him?
Far truer.
And if he is compelled to look straight at the light, will he not have a pain in his eyes which will make him turn away to take refuge in the objects of vision which he can see, and which he will conceive to be in reality clearer than the things which are now being shown to him?
True, he said.
And suppose once more, that he is reluctantly dragged up a steep and rugged ascent, and held fast until he is forced into the presence of the sun himself, is he not likely to be pained and irritated? When he approaches the light his eyes will be dazzled, and he will not be able to see anything at all of what are now called realities.
Not all in a moment, he said.
He will require to grow accustomed to the sight of the upper world. And first he will see the shadows best, next the reflections of men and other objects in the water, and then the objects themselves; then he will gaze upon the light of the moon and the stars and the spangled heaven; and he will see the sky and the stars by night better than the sun or the light of the sun by day?
Certainly.
Last of all he will be able to see the sun, and not mere reflections of him in the water, but he will see him in his own proper place, and not in another; and he will contemplate him as he is.
Certainly.
He will then proceed to argue that this is he who gives the season and the years, and is the guardian of all that is in the visible world, and in a certain way the cause of all things which he and his fellows have been accustomed to behold?
Clearly, he said, he would first see the sun and then reason about him.
And when he remembered his old habitation, and the wisdom of the den and his fellow-prisoners, do you not suppose that he would felicitate himself on the change, and pity him?
Certainly, he would.
And if they were in the habit of conferring honors among themselves on those who were quickest to observe the passing shadows and to remark which of them went before, and which followed after, and which were together; and who were therefore best able to draw conclusions as to the future, do you think that he would care for such honors and glories, or envy the possessors of them? Would he not say with Homer,
“Better to be the poor servant of a poor master,”
and to endure anything, rather than think as they do and live after their manner?
Yes, he said, I think that he would rather suffer anything than entertain these false notions and live in this miserable manner.
Imagine once more, I said, such a one coming suddenly out of the sun to be replaced in his old situation; would he not be certain to have his eyes full of darkness?
To be sure, he said.
And if there were a contest, and he had to compete in measuring the shadows with the prisoners who had never moved out of the den, while his sight was still weak, and before his eyes had become steady (and the time which would be needed to acquire this new habit of sight might be very considerable), would he not be ridiculous? Men would say of him that up he went and down he came without his eyes; and that it was better not even to think of ascending; and if anyone tried to loose another and lead him up to the light, let them only catch the offender, and they would put him to death.

As artists, poets and philosophers remind us of our individuality, exalting our natural rights in words and music, artists must be destroyed. All wealth and rights must be seen to come from the corporation—from the machine—and the latest iteration of the never-ending quest to enslave the creators to the uncreative has come in the form of groupthink, legalisms, and ironic law schools which rip out the heart and soul and replace it with a cash register, so that the lawyers can go on to work for the record labels or the gargantuan Web 2.0 aggregators and pirates—all of which profit at the expense of the indie artist and art.

For why is it that in this world, where we have never had so many lawyers and snark-a-lark journalists, that everyone is unanimously against DRM, except for artists like 50 Cent and Eminem? Why is it that Lessig et al must forever seek to profit off the labors for rap artists? Why can't they write their own rap albums? Why are Lessig et al all such player haters?

On the back of the book Cowboy Ethics: What Wall Street Can Learn From The Code of The West (Paperback) by James P. Owen (Author), David R. Stoecklein (Photographer) it states,
Having been rocked by one damaging revelation of misbehavior after another, Wall Street is in a state of crisis. Investors are disgusted by the misdeeds of a few and suspicious of the industry at large. Every firm finds its integrity open to question. Regulators are up in arms. And the industry is facing billions of dollars in costs to comply with a floodtide of new regulations.
But imagine what could happen if Wall Street firms looked back to a simpler time when a handshake was enough to seal a deal, and right and wrong were as clear as black and white. What if executives, portfolio managers, analysts, and traders decided that some things aren't for sale? What if every major investment firm agreed to live by the principle that the client always comes first?
In words and images, Cowboy Ethics explores the life and code of the working cowboy as a source of inspiration pointing the industry to a way out of its troubles.
The book is intended as the catalyst for a movement to transform the industry—not with the carrot and stick, but from the inside out—one person, firm, and organization at a time.
The postmodern lawyers/mbas destroyed the Cowboy code as they detest Johnny Cash, Clint Eastwood, Merl Haggard, Willy Nelson, and Toby Keith. They hate men and manliness, as they profit vastly in the cutesy-tootsey-now-you-see-your-pension-now-you-don't world.
Larry Lessig never criticizes his brothers and sisters—the intermediary class—who are profiting so handsomely in the decline and fall of civilization. The decline of the family and the rise of abortion suits them just well, as they already got you parent's pensions and savings in the dot-com boom, and now they want all of your intellectual property-just slap a creative commons license on it.
They hate Johnny Cash because Cash was a Man who Believed in God. Johnny Cash said that his favorite album had been his mother's Prayer Book, and Johnny Cash composed beautiful songs such as When The Man Comes Around—you can watch it on youtube, but Cash ain't getting' paid for it:
Johnny Cash Lyrics—The Man Comes Around Lyrics
Artist: Johnny Cash Lyrics
Song: The Man Comes Around Lyrics
And I heard, as it were, the noise of thunder:
One of the four beasts saying: “Come and see.”
And I saw.
And behold, a white horse.
There's a man goin''round takin' names.
An' he decides who to free and who to blame.
Everybody won't be treated all the same.
There'll be a golden ladder reaching down.
When the man comes around.
The hairs on your arm will stand up.
At the terror in each sip and in each sup.
For you partake of that last offered cup,
Or disappear into the potter's ground.
When the man comes around.
Hear the trumpets, hear the pipers.
One hundred million angels singin'.
Multitudes are marching to the big kettle drum.
Voices callin', voices cryin'.
Some are born an' some are dyin'.
It's Alpha's and Omega's Kingdom come.
And the whirlwind is in the thorn tree.
The virgins are all trimming their wicks.
The whirlwind is in the thorn tree.
It's hard for thee to kick against the pricks.
Till Armageddon, no Shalam, no Shalom.
Then the father hen will call his chickens home.
The wise men will bow down before the throne.
And at his feet they'll cast their golden crown.
When the man comes around.
Whoever is unjust, let him be unjust still.
Whoever is righteous, let him be righteous still.
Whoever is filthy, let him be filthy still.
Listen to the words long down,
When the man comes around.
Hear the trumpets, hear the pipers.
One hundred million angels singin'.
Multitudes are marchin' to the big kettle drum.
Voices callin', voices cryin'.
Some are born an' some are dyin'.
It's Alpha's and Omega's Kingdom come.
And the whirlwind is in the thorn tree.
The virgins are all trimming their wicks.
The whirlwind is in the thorn tree.
It's hard for thee to kick against the pricks.
In measured hundredweight and penny pound.
When the man comes around.
And I heard a voice in the midst of the four beasts,
And I looked and behold: a pale horse.
And his name, that sat on him, was Death.
And Hell followed with him.
It is easy to see why Simon Cowll/Max/Young detsest such songs that remind us that we are all part of a larger story. Shile such sentiments lie at the foundation of all-lasting art, these sentiments get in the way of short-term profits via dishonesty, deception, and the pornifaction and decline of culture. Thus there has ever been a conflict between serving the two masters of God and Mammon.

The lawyer/mba class is a most uncreative class. Not only that, but they are typically soulless, and thus they enjoy playing around with the letter of the law to transfer all the wealth to themselves, and the risk to the producers, workers, and creators, while crucifying the Spirit of The Law.

Let the realities of modern life support this. They found abortion in a Constitution where there is no such right, and as long as that most fundamental form of private property can be taken—life itself—they will take all that they can get. Digital rights management is the least of our worries, but the communistic/socialistic boomers see it as a vast trophy, and one more nail in the coffin of that which they just cannot seem to kill, no matter how hard they try—the spirit of the rugged American Outlaw, and the indie artist.

For make no mistake—every true artist is an indie artist—they are born into this world alone, they live alone, they create alone, and they die alone. If you do not believe me, ask Shakespeare, Beethoven, Jesus, Socrates, Bruno, Einstein, Galileo—they all created vast wealth not by groupthink, but by rendering their rugged, individual visions.

Liberals detest the idea of private property, and thus

GUN, PROPERTY CONDITION FUEL ILL WILL

Elizabeth Edwards afraid of neighbor

She has never met ‘rabid Republican,’ but wouldn't be nice

MIKE BAKER

Associated Press

APElizabeth Edwards, wife of democratic Presidential hopeful John Edwards, introduces him at a campaign town hall meeting in Davenport, Iowa, on April 4.

Peeping Tom leaves ladder behind

Man impersonates brother to avoid DWI

Mother arrested after kids panhandled

Pranksters glue Calif. school doors shut

Malaysian man saves 100 from sinkhole

Mouse delays Vietnamese flight 4 hours

NYC couple hail cab for 2,400-mile ride

Flight canceled after pilot's outburst

102-year-old Calif. woman hits hole-in-1

RALEIGH—Elizabeth Edwards says she is scared of the “rabid, rabid Republican” who owns property across the street from her Orange County home—and she doesn't want her kids going near the gun-toting neighbor.

Edwards, the wife of Democratic presidential candidate John Edwards, particularly recalls the time neighbor Monty Johnson brought out a gun while chasing workers investigating a right of way near his property. The Edwards family has yet to meet Johnson in person.

“I wouldn't be nice to him, anyway,” Edwards said in an interview. “I don't want my kids anywhere near some guy who, when he doesn't like somebody, the first thing he does is pull a gun out. It scares the business out of me.”

But Johnson defended the occasion he brandished a gun, saying those on his land didn't have the proper approval.

“I use the gun for protection, and I considered that an appropriate time,” Johnson said.

“Sometimes you have to take drastic measures.”

Edwards views Johnson as a “rabid, rabid Republican” who refuses to clean up his “slummy” property just to spite her family, whose lavish 28,000-square-foot estate is nearby on 102 wooded acres.

Johnson, 55, acknowledges his Republican roots. But he takes offense to the suggestion he has purposefully left his property, including an old garage he leases for use as a car shop, in dilapidated condition.

Johnson said he has lived his entire life on the property, which he said his family purchased before the Great Depression. He said he's spent a lot of money to try and fix up the 42-acre tract.

“I have to budget. I have to live within my means,” Johnson said. “I don't have millions of dollars to fix the place.”

Johnson, who has posted a “Go Rudy Giuliani 2008” sign on a fence just 100 feet from the entrance to the Edwards' driveway, has criticized Edwards for the scale of their nearby home. The property and home, which includes an indoor basketball court, an indoor handball court and an indoor pool, is valued at $5.3 million.

The Edwardses are still putting the final touches on the property, which they purchased in 2003.

“I thought he was supposed to be for the poor people,” Johnson said. “But does he ever socialize with any poor people? He doesn't speak to me.”

Johnson said he has put his property on the market, in part blaming the high property taxes for his decision to leave. He also wants to move for another reason.

“I don't want to live somewhere where someone's always complaining about me,” he said.—http://www.charlotteobserver.com/112/story/79067.html
Because A Prominet Content Aggregator.com doesn't provide digital rights management (DRM), they have to rely on questionable content to drive sales, as opposed to Hollywood blockbusters or films and works worth protecting and encrypting with DRM. In their recent newsletter, they highlight A Prominent Hipster Author-perhaps their most successful author who says, “My name is A Prominent Hipster Author, and I am an asshole.”:
http://people.A Prominet Content Aggregator.com/blogs/view_post.php?post_id=31714
http://people.A Prominet Content Aggregator.com/blogs/view_post.php?post_id=31714
The crowning event of our trip to Austin was the party we co-sponsored at Austin City Limits Studio. It was a bit of a hike from the Convention Center, but well worth it. The band Voxtrot provided live music and a number of A Prominent Content Aggregator authors (including the infamous A Prominent Hipster Author) were in attendance. It was the perfect way to kick off our first year at SXSW. And just for the record . . . that city skyline in the background is, in fact, fake. I know, you're heartbroken (I was too).
Katie Jamison
in Adventures in on demand publishing
It's all about a party. DRM be damned-no need for that—it's all about a party. They hate the Constitution and the Artist's Rights—it's mob rule and degraded literature for all.
   http://tuckermaxdoucebag.blogspot.com/
   http://facebook.com/group.php?gid=2216899883
Story about A Prominent Hipster author From Facebook.com:
The story below was copied from a Facebook.com account. A link to this story in the comments to an older post awhile ago.
A Prominent Hipster Author's face, meet Megan ******'s hand
Megan was discussing ball shaving with a nice man at a tailgate. Good start to this story;) NE ways, A Prominent Hipster Author was also at the tailgate and started talking shit to Megan (he obviously thought she was a hot girl who would sleep w/ him if acted like an asshole, and he was showing off in front of his buddies). Megan hit him on the arm, and he said that meant Megan wanted to fuck him because if she hit him in the face, then he'd know she was mad. She then dissed his elastic waistband (yes, he was wearing elastic waistband shorts, what is he, 12?), and he said “its so stupid bitch whores like you can suck my dick without any confusion.” So she slapped him in the face!!!
A Prominent Hipster author threw his drink at her, Candice threw her drink at A Prominent Hipster author with lightning fast reflexes, then he proceeded to grab Megan by her hair and hit her in the face with his pathetically small hands. With a bruised face, and a bruised ego, he took his shriveled penis back to his buddies.
In A Prominent Hipster Author's own words, “My name is A Prominent Hipster Author, and I am an asshole.” Oh, and he hits girls.

It is odd that A Prominent Pomo-Hipster Dot Corn CEO, the founder and CEO of A Prominet Content Aggregator, who has three young daughters who already profited immensely as he sold A PROMINET HYPED DOT-COM COMPANY stock on the way down from its pumped-up heights, chose to profit from and promote A Prominent Hipster author, but that is the mark of the boomers—not quite the greatest generation—who always elect to serve the bottom line over the higher ideals.

Ye shall know them by their fruits, and whil A Prominent Pomo-Hipster Dot Com CEO's bottom-up blame-it-on-the-masses “leadership” style is great at producing and hyping A Prominent Hipster Authors, it does not lead to lasting literature, Great Books, nor Hollywood Blockbusters. The A Prominent Hipster Author/Young combo is incapable of the third act—the showdown where the moral entity rides back into town for the showdown—the man with no name, Odysseus, Lincoln, Martin Luther King Jr, and Ronald Reagan. Thus it makes sense that DRM is of no great import to them, as they are not interested in creating lasting art, but only in profiting from short-term art including A Prominent Hipster Author's stories about filming anal sex with agirl, without telling the girl she is being taped. Is this funny? Does the Pomo-hipster MBA/Lawyer/CEOs think this is representative of A Prominet Content Aggregator? What if someone filmed such a story with one of his daughters? What ever happened to the Golden Rule-“do onto others as you would have them do unto you?” What ever happened to real men-our John Waynes and Men with No Names and Odysseus's who had the Authority and Character to pass Judgement, to voyage forth on Hero's Journeys and return on home with both great art and great DRM systems. Ye shall know them by their fruits, and A Prominet Content Aggregator published A Prominent Hipster Author. Does The Prominent Content Aggregator need the money from selling such smut? There is no need for DRM for such stories, as they will never be made into movies, and A Prominent Pomo-Hipster Dot Com CEO then concludes, with masses of bloggers behind him, that there can be no need for DRM for anyone, and so A Prominet Content Aggregator does not offer a whole lot of DRM.

And so it is, by respecting immortal values found in lasting art such as Dante's Inferno and The Odyssey, the present invention will exalt the spirit and soul, by allowing artists to protect and profit from everlasting creations—which must be protected, as they do not come easy.

Again and again—anything goes for the sake of making money—it is groupthink, hype, abuse, and soft porn—anything but digital rights management for the indie creators and artists. Anything that furthers the decline of the family and degraded literature, anything that profits from the decline, does little to fill the black holes of their souls, and they need more and more and more. More taxes, more revenues, more hype, mo Sex and the City shows and A Prominent Hipster Author’ to destroy the spirit and soul—the soul of the man, the soul of the woman, and the soul of capitalism, which John Bogle, the founder and former CEO of Vanguard, like a lone ranger riding into town, so eloquently defends in his book Battle for The Soul of Capitalism.

F. A. Hayek writes, “The most effective way of making people accept the validity of the values they are to serve is to persuade them that they are really the same as those which they, or at least the best amongst them, have always held, but which were not properly understood or recognized before. The people are made to transfer their allegiance from the old gods to the new under the pretense that the new gods really are what their sound instinct had always told them but what before they had only dimly seen. And the most efficient technique to this end is to use the old words but change their meaning. Few traits of totalitarian regimes are at the same time so confusing to the superficial observer and yet so characteristic of the whole intellectual climate as the complete perversion of language, the change of meaning of the words by which the ideals of the new regime are expressed.”

That is why socialists love “entrepreneurship,” or I should say “ironic” entrepreneurship. They build state-sponsored centers of entrepreneurship, growing them bigger and bigger and bigger, and hiring VCs to suck up cash at Universities, instead of professors steeped in the Great Books and Classics. Soulless VCs are much more adept at lock-stepping to the bureaucracy as the University claims more and more land and raises taxes, all in the name of free markets and freedom. The soulless VCs know how to snark the Great Books and classics—they know how to ironically laugh at Jefferson, Adams, and Hamilton—the MBA VCs know how to lie with a straight face, to speak forth one thing and hold in their hearts another, and thus they are ideally suited to sitting around, absorbing tax and tuition dollars, while waiting for the next bubble by which they can rape the common worker's mutual funds, retirement pensions, and tax and tuition dollars. Bureaucracy is entrepreneurship. War is Peace. Freedom is Slavery. The MBAs/law schools do not teach Orwell—they reenact it, as it is far more profitable for the insiders. The ironic socialists are far more sinister than the ones we had just yesterday who admitted to it. Today they just co-opt all the terms such as truth, justice, innovation, entrepreneurship, and yoke them to the ever-burgeoning bureaucracy which ultimately destroys freedom.

Meaning is conveyed by story, and that's why so many media magnates naturally detest the precious and few Great Books and Classics, while favoring businesses based upon mob-rule. With mob-rule in the absence of Truth and Beauty, it is far easier to manipulate and control, to profit off of others in the decline, to hand out meaningless awards and build fleeting, yet formidable, systems which on some days exalts the mediocrity, on other days excoriates it, and keeps everyone living in fear.

The pomo hipster MBA/lawyers are destroying the family for personal gain—pitting men and women against one-another in a storyless, Darwinian pit continually degraded by the media companies. And A Prominent Pomo-Hipster Dot Corn CEO blames it on the people—A Prominent Hipster Author is the people, and a Pomo-hipster MBA/Lawyer/CEOs is the savior, bringing quality programming into your schools and the social sphere for the betterment of all. Ye shall know them by their fruits, and all too many institutions these days lead via bottom-up leadership, because it is easy, instead of top-down, exalted leadership, which is just too damn hard, as it requires passion, vision, and commitment, such as that demonstrated by Martin Luther King Junior, Jack Bogle, and Albert Einstein.

A lot is made of the wisdom of crowds these days, so if the majority of bloggers are against DRM, DRM must be bad and wicked. And too Socrates and Jesus, sentenced to death by mobs, both deserved to die. And the righteous mob that occupied Odysseus's house, should have been able to prevail. Well, were it so, but America was founded as a country that protects the rights of Socrates, Jesus, and Odysseus—the right to say what you wish and won what you do—and artists shall have their DRM marketplace as described in the present invention.

Once upon a time music was about Johnny Cash. Once upon a time it was about Bob Dylan. Once upon a time literature was about Mark Twain. But today it's about Simon Cowell, A Prominent Pomo-Hipster Dot Corn CEO, and Rupert Murdoch. Artists are always put down and kicked around, as the boomers make mediocrity king and hand out awards, degrees, and honors to their useful idiots who promote it, as only then can the show be about Simon Cowell. The talented Tom Petty calls the postmodern heartless, soulless boomers out:

Artist: Tom Petty

Song: Joe

my name's Joe I'm the ceo

yeah, I'm the man

makes the big wheels roll

I'm the hand on

the green light switch

you get to be famous

I get to be rich

go get me a kid

with a good-looking face

bring me a kid

can remember his place

some hungry poet

son of a bitch

he gets to be famous I get to be rich

or bring me a girl

they're always the best

you put 'em on stage

and you have 'em undress

some angel whore

who can learn a guitar lick

hey, that's what I call music

Artist: Tom Petty

Song: Joe

my name's Joe I'm the ceo

yeah, I'm the man

makes the big wheels roll

I'm the hand on

the green light switch

you get to be famous

I get to be rich

go get me a kid

with a good-looking face

bring me a kid

can remember his place

some hungry poet

son of a bitch

he gets to be famous I get to be rich

or bring me a girl

they're always the best

you put 'em on stage

and you have 'em undress

some angel whore

who can learn a guitar lick

hey, that's what I call music

The postmodern boomer elite, having ripped off pensions, savings, and investments in the dot-com bubble, and then profitig further in the real estate bubble, can hire the very best lawyers trained by the very best postmodern professors so that they can efficiently deny the truth and destroy the scared proof. After four years of gutted pomo-hipster, feminist studies, where they never read Dante's Inferno and learned of Beatrice's Glory, nor The Odyssey and learned of Penelope's Faithfulness which was rewarded by Odysseus's Return, nor any of the Great Books and Classics where they would have learned of the better angels of their nature; and after three years of heartless, soulless case studies, where they never witness the Glory of the Constitution, these lawyers, who are handpicked by this self-selecting process of accepting the Godless Reality as the greater reality, are capable of saying anything for the highest bidder, and even better, they are capable of believing it. They will stop at nothing to serve the Almighty Dollar, and they will plot, rage, and rail against these words, these words which propose a new system that better allows artists and creators to protect and profit from their creations, because you see—lawyers and mbas are typically uncreative—and the only way to profit and prosper is by saddling up artists, by harnessing them to their web 2.0 machines, sanctified by their secular popes, who are so brilliant that they can see both abortion and the end of property rights in the Constitution, as they are one and the same thing. Contrast the leaders of these pomo-hipsters to Einstein, “Science without religion is lame, religion without science is blind.” Einstein also stands apart with his notion of deliverance via serving entities greater than ourselves, “A human being is part of the whole called by us universe, a part limited in time and space. We experience ourselves, our thoughts and feelings as something separate from the rest. A kind of optical delusion of consciousness. This delusion is a kind of prison for us, restricting us to our personal desires and to affection for a few persons nearest to us. Our task must be to free ourselves from the prison by widening our circle of compassion to embrace all living creatures and the whole of nature in its beauty. The true value of a human being is determined by the measure and the sense in which they have obtained liberation from the self. We shall require a substantially new manner of thinking if humanity is to survive. (Albert Einstein, 1954) The most beautiful and most profound experience is the sensation of the mystical. It is the sower of all true science. He to whom this emotion is a stranger, who can no longer wonder and stand rapt in awe, is as good as dead. To know that what is impenetrable to us really exists, manifesting itself as the highest wisdom and the most radiant beauty which our dull faculties can comprehend only in their primitive forms—this knowledge, this feeling is at the center of true religiousness. (Albert Einstein—The Merging of Spirit and Science).”

The great thing about a declining civilization is that so many are blind to it, as the decline augments the darkness which augments the decline, until some lone prophet or poet steps forth and is crucified by those who thought it was never about Truth nor Beauty, but only about profiting by their appearance. The further away we get from the original intent of the Constitution, the easier its gets to move further and further way. One of the funniest things is all the law professors who have made a living off the decline, deconstruction, and destruction of the American Soul—of the American Family, the American Worker, and the American Dream. As their salary and benefits augment in the law school bubble, and as the price of their home soars in the real estate bubble, they hand out awards to one-another for little trifles by which they deconstruct the constitution, and take great pride and satisfaction in their ironic accomplishments—transforming all of entirety into their likeness, as they transfer all the risk and labor to the common worker, and all the wealth to themselves. And that is the product they sell—a ticket to join the inside group that never creates wealth, but transfers, taxes, pillages, and plunders it. Sometimes they call it middle-management, and they scheme to cut the pensions as that would boost their bottom line, and sometimes they call it government, and they spend and spend and spend everyone's social security on little pet projects, but the fact is that they all go to the same schools, they all know one-another, their journalists party with them in Hollywood and Martha's Vineyard, and extol the virtues of the great bubbles that transfer billions of wealth to the insiders. And they party it on down, never moving beyond the seventies, replacing Classic, Epic Story with reality TV, dumbed-down talk shows, and remake, after remake, after remake of seventies sitcoms. They advise the rising generation to abort their children, as children take women out of the workplace, and it is more profitable to have women slaving away at corporations as opposed to serving children the family, an they lie to women, destroying their sacred souls from early on, commanding them to sleep around and imitate all the porn. They know that by destroying the feminine soul, they can destroy the masculine soul, and they replace the decline in population with illegal immigrants, as that is far better for the economy. There are no republicans. There are not democrats. There's just the one party now—the party of the ironic lawyer who will say or do anything to make a quick buck—the people and good of the country be damned. And they blame it on the people.

Well—there have ever been two types of leaders in this world—those who lead via higher ideals—via character and conviction—leaders such as Lincoln, Ghandi, Reagan, Jefferson, Winston Churchill. And there have been those leaders who have lead by the bottom line—by the lowest common denominator, by quiet lies, deceit, and stolid service to all that degrades, always kicking the exalted as the priests kicked Jesus, whipping and beating Him, placing a crown of thorn on his heads, and parading him before the Jeering crowds as an example of what happens to those who seek to serve a higher cause.

And so it is that DRM is crucified and sacrificed on the altar of the blog, and Steve Jobs promises that they are only removing DRM for music, but not for movies, just as he promised DRM for music a few shot years ago. Steve Jobs has not the soul nor spirit of the artist, but of the tyrant. Steve Jobs can motivate groups of soulless, faceless, nameless artists, but he is incapable of creating immortal art. He does not understand its deeper, fundamental nature, and thus he does not care if the baby lives or dies, as it is not his child. He makes money off of selling devices—commodities. Picasso made his living off of selling art, as did Beethoven, Shakespeare, and George Lucas. Perhaps Jobs is jealous, because no matter home much he creates, it is always outdated a few moments later. Such is the black hole that the commodity creator—the pomo-hipster-boomer, must always seek to fill, be it via service to the bottom line or the destruction of artist's rights—their sacred rights to protect and profit from their creations.

Make no mistake—this is all about the hero's journey.

The call to adventure is to liberate content creators from the machines that continually commoditize them. The intent came to be in the postmodern era, where soulless contortionists such as Larry Lessig fly around railing against creator's rights. But no matter how hard he tries, he cannot change the Constitution, and even though he can release all of his rap CDs, and Lessig's films, music, and TV shows on Lessig CC licenses, eminem and Fifty Cent will yet choose traditional copyrights. And if offered the system described within this present invention, Eminem and Fifty Cent would choose it.

### SPECIFICATION OF INVENTION

The purpose of this invention is not to duplicate the earlier specification, features, objects, and advantages of the 45 Revolver invention filed by the same inventor as this current invention, but rather it is to build upon it. The 45 Revolver, which affords the artist and creator with a full spectrum of rights management options, may directly serve this present invention, which offers DRM providers and device makers and aggregators and the opportunity to come to the present invention to bid and compete for the right to protect and distribute the artist's content. Dodge City is where every artist, creator, and content owner can walk around freely with their 45 Revolver—an application which affords them a full spectrum of rights management options, before they launch their content out onto its eternal voyage throughout web.

Imagine a place—a town—a portal—a setting—imagine Dodge City—where the artist could upload their song, or their film, or their photography. The plethora of DRM providers, aggregators, and device makers, such as Microsoft®, Apple®, Myspace®, Youtube®, and flickr®, could come to Dodge City to offer the artist distribution for their songs. If some company, such as Microsoft®, Apple®, Myspace®, Youtube®, or Flickr® chose not to participate, that would be fine, as others would take their place, and over time Dodge City, because it is letting the artists choose—providing them with a full spectrum of options, and making the commodities compete for the right to protect and distribute their content—Dodge City would become the place where standards emerge. Imagine the artist who uploads a song. The Dodge City DRM marketplace would allow them to convert the song to any format, including Ogg Vorbis, MP3, AAC, AVI, or any format Microsoft® or Apple® or Google®®comes up with, and it would allow the artists the ability to make their content available in any or all the DRM formats. If some company, such as Apple®, decides that they don't want to play nicely with others, or serve the artists, then Apple will no longer get to walk around Dodge City, which will be their loss, as dodge City is where all the artists will be. The artists will gravitate towards Dodge City as Dodge City respects the artists and their art, as Dodge City understands the primacy of individual rights—not collective obfuscations and groupthink—that is at the center and circumference, the heart and soul, of art. Herman Melville understood the source of all higher art: “But this august dignity I treat of, is not the dignity of kings and robes, but that abounding dignity which has no robed investiture. Thou shalt see it shining in the arm that wields a pick or drives a spike; that democratic dignity which, on all hands, radiates without end from God; Himself! The great God absolute! The centre and circumference of all democracy! His omnipresence, our divine equality!” But as one cannot serve two masters, Melville has been deconstructed and demolished to make way for Mammon—a world where artists and creators become feudal serfs for massive corporations and snarky lawyers.

The present invention allows an artist or creator to upload their content and define their rights. Then, device makers, DRM providers, content aggregators will compete to meet the defined rights for distribution. Over time trusted DRM packages will emerge, and thus even greater opportunity will be afforded to artistic entrepreneurs to devise the optimum DRM packages.

### RAMIFICATIONS AND SCOPE OF INVENTION

Over time trusted DRM packages will emerge, and thus even greater opportunity will be afforded to artistic entrepreneurs to devise the optimum DRM packages. Over time, search engines of superior content will emerge-trusted search engines which spider DRM'd content, which compensate authors and artists for the right to spider and cache their content, instead ofjust taking it.

The present invention allows creators to define just how much every copy of their content costs, so that even when search engines spider their content, they are paid for the copy that is made during the spidering process, which necessitates a copy. If the search engine doesn't want to pay, then they don't get to spider nor cache nor monetize nor link nor excerpt the content, unless the creator makes a different arrangement with them. Over time a search engine may thus emerge consisting of content that is worth paying for. Established search engines may employ this technology to keep content creators and producers happy, while adding vast value to their own search engine databases.

The present invention also allows for DRM that is unlocked via the viewing of an ad. These DRM ads necessitate that the consumer must view the ad before receiving the key that unlocks the content, allowing them to view it.

The overarching spirit of this invention is to serve creators, artists, and authors with novel and improved ways to protect and profit from their inventions.

### BRIEF DESCRIPTION OF DRAWINGS

### Brief Description of Drawings

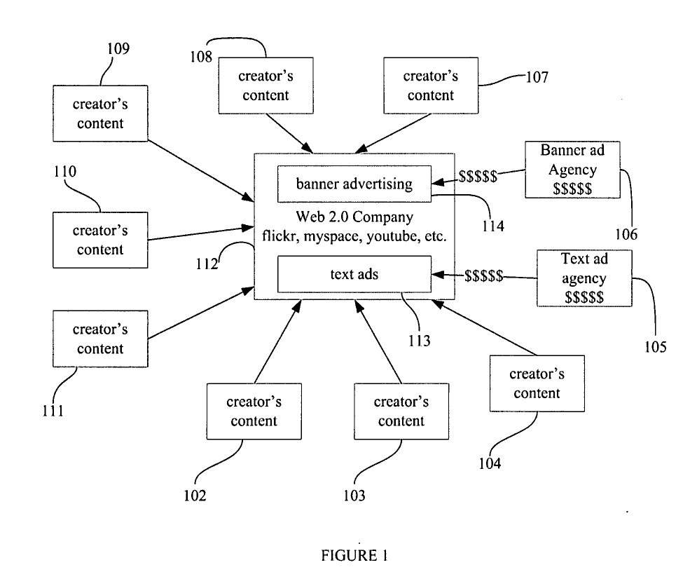

FIG. 1 represent the current state of the web, where creators upload all the content and make none, or very little, of the money. Creators are commoditized by the web companies. Note that both the money and content flow into the Web 1.0/2.0 companies.

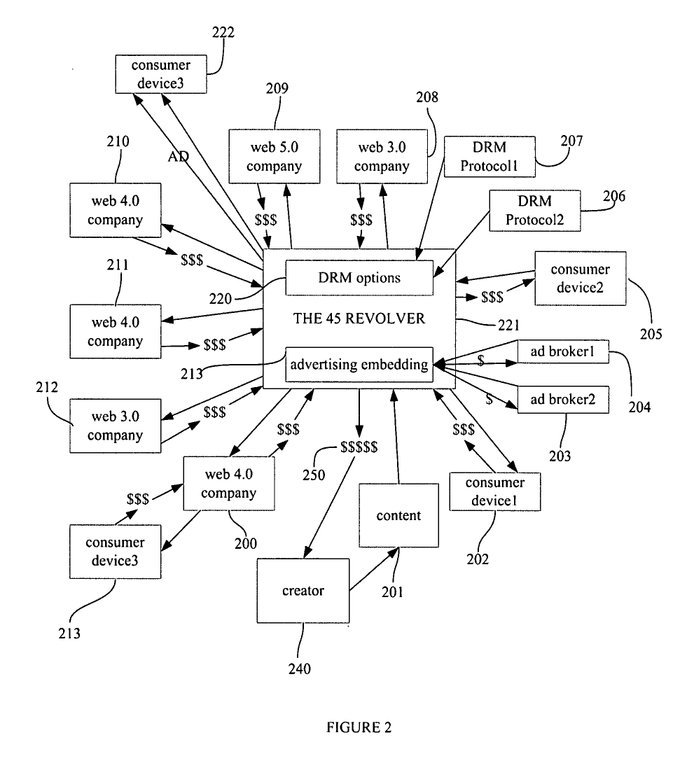

FIG. 2 represents the commodity reversal that an embodiment of the present invention—the 45 Revolver—will allow. Note how more of the money flows back to the creator.

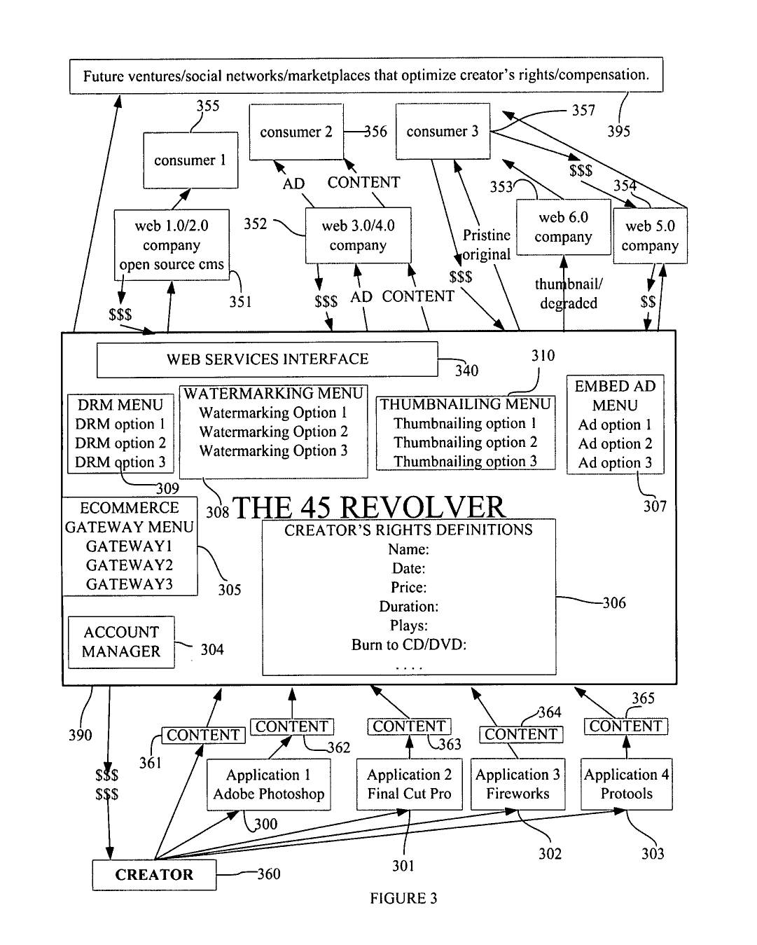

FIG. 3 represents the basic operations and options provided by the 45 Revolver. Note the full and unique spectrum of rights management options.

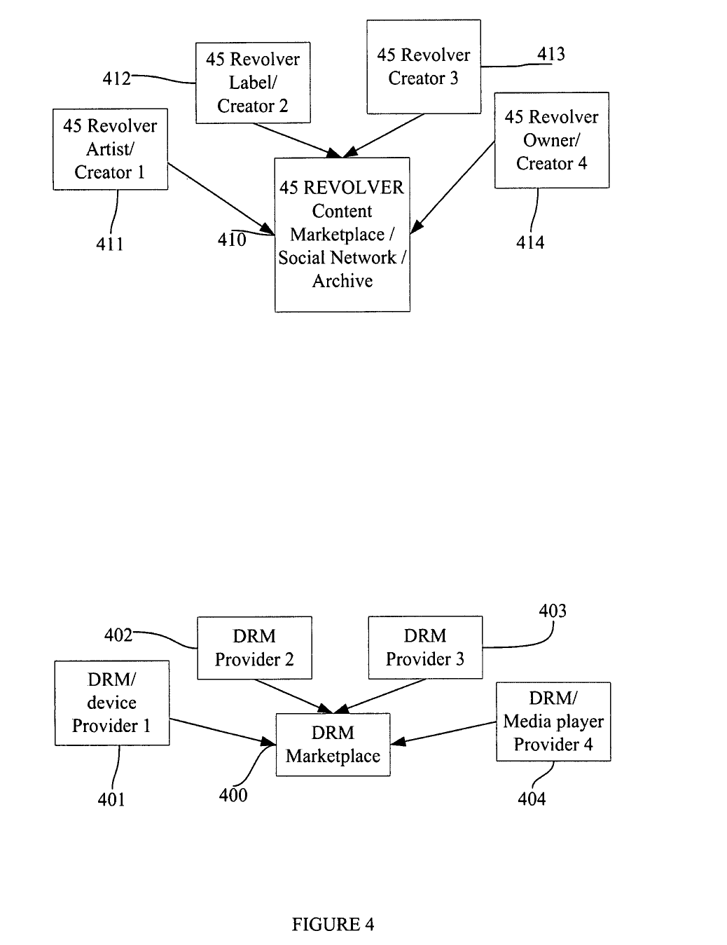

FIG. 4 represents the trusted 45 Revolver marketplace or social network that will naturally emerge from the precepts of this invention, as well as the 45 Revolver DRM marketplace that will naturally emerge form the principles and innovations set forth herein, as DRM providers and device manufactures compete for the right to protect creator's content and allow the creator to profit from their creations in optimum manners.

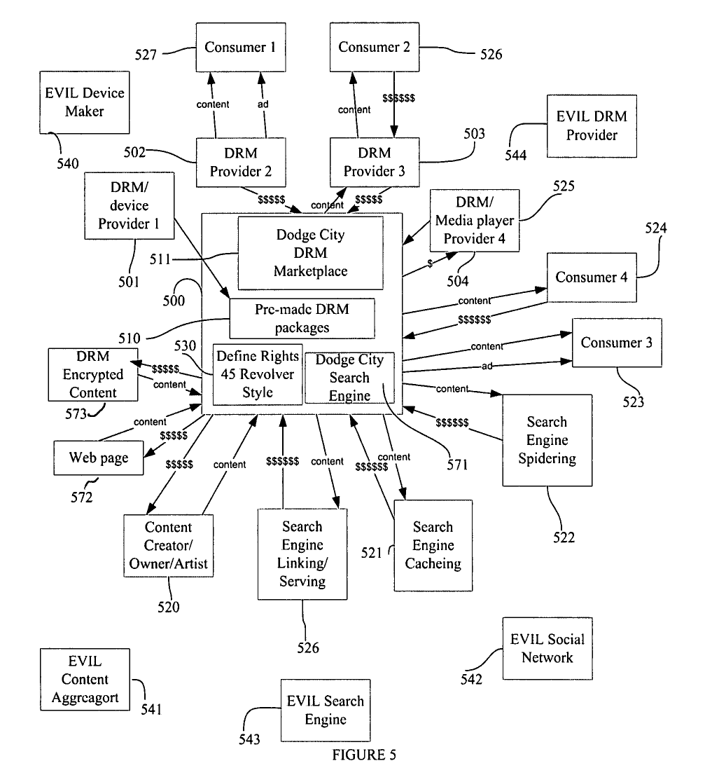

FIG. 5 represents the Dodge City DRM Marketplace/Search Engine/Social Network that will naturally emerge from the precepts of this invention, as DRM providers and device manufactures compete for the right to protect creator's content and allow the creator to profit from their creations in optimum manners. The Dodge City DRM Marketplace shall emerge as a consequence of the 45 Revolver innovation, and thus the 45 Revolver Paptent application may in some regards be considered a parent invention to this present invention. FIG. 5 also represents the Dodge City Search Engine.

The purpose of this invention is not to duplicate the earlier specification, features, objects, and advantages of the 45 Revolver invention filed by the same inventor as this current invention, but rather it is to build upon it.

### DETAILED DESCRIPTION OF DRAWINGS

FIG. 1 represent the current state of the web. Various creators, 102, 103, 104, 107, 108, 109, 110, and 111 upload all the content to the Web 1.0/2.0 companies 112 and. Creators are commoditized by the web companies. Banner ad agency 105 and text ad agency 106 both pay the web 1.0/2.0 company to display banner and text ads. Note that both the money and content flow into the Web 1.0/2.0 companies 112. The creators 102, 103, 104, 107, 108, 109, 110, and 111 make none, or very little, of the money while the Web 1.0/2.0 companies keep the lion's share for themselves, even though the creators did the lion's share of the work.

FIG. 2 represents the commodity reversal that an embodiment of the present invention—the 45 Revolver—will allow. It all begins with the creator 240 and their content 201. Note how more of the money 250 flows back to the creator.

The creator 240 uploads their content 201 into the 45 Revolver application 221. The creator then defines their rights and selects from a full spectrum of digital rights management options 220, provided by DRM protocols 206 and 207, or embedded advertising options 213, provided by a plurality of ad brokers 203 and 204. The content is then made available directly to consumers 202, 205, and 222 and other web companies 208, 209, 210, and 211 over the web using standard and/or secure web protocols. Only the web companies or consumers who agree to the creator's terms are allowed to access and/or distribute the content. Only the companies that pay for the content, or serve advertising associated with the content, which pays the creator 240 in terms the creator 240 sets forth are allowed to use the content on their sites. Only the consumers who pay for the content 201 via consumer device1 202 or consumer device2 205 or view the associated ads as in consumer device 222, are allowed access to the content, according to the rights defined by the creator 240 in the 45 Revolver application 221.

FIG. 3 represents the basic operations and options provided by the 45 Revolver system 390, which can be built on a common web server with common languages and common applications. Note the full spectrum of rights management options—DRM options 309, watermarking options 308, thumbnailing options 310, and advertising options 307. Anyone well-versed in the art of web application development could assemble the combination and build this device. The 45 Revolver also comes with an ecommerce shopping cart gateway 305 to handle transactions and collect payments from customers and other web portals using the content. A web services interface 340 handles account creations, content uploads into other applications and websites 351, 352, 353, and 354. Consumers 355, 356, and 357 interact with the original content 361, 362, 363, 364, 365 in various ways. A hallmark of the 45 Revolver application is that it is capable of manipulating content in hundreds of formats, including but not limited to pictures: jpg, gif, tif, psd, png; film mov, avi; music, avi, mp3 and more. The 45 Revolver application will be continually updated with new tools and protocols to watermark, encrypt, thumbnail, abbreviate, and perform other operations on all digital media.

The 45 Revolver system 390 is capable of registering multiple accounts at multiple content companies 351, 352, 353, and 354 via its web services interface 340, and then uploading content in various versions, along with rights definitions, to the various companies 351, 352, 353. Mulitple content companies could include flickr, mysapce, deviantart, pbase, lulu, youtube, revver, friendster and others. The web services interface 340—using the CURL or similar protocols available off the shelf—will allow the management and tracking of content throughout.

The account manager 304 will display entities including the amount of money made, and all the places the media has been viewed. The ecommerce gateway 305 menu will provide options to handle financial transactions and payment. Payment gateways such as paypal, authorize.net, google payments, or amazon payments may be used to accept credit cards or other funds. Or, the creator might elect to accept checks. At any rate, the creator will be in full control.

In the DRM Menu 309, the Creator can choose from numerous types of DRM, including Windows DRM, Zune DRM, Apple DRM, Google DRM, Sun DRM, open source DRM, or some other type of DRM. With the DRM they can set typical attributes such number of plays, duration media can be played, number of copies that can be made, number of times it can be burned, and more. Over time, favored methods of default DRM schemas will emerge, and as different DRM providers compete, the price of DRM should approach zero, and its ease of use and access and universality will increase. For it will be to the vast benefit of DRM providers to make their DRM inexpensive, easy to use, and universal. This may inspire more open standards for DRM, or it may inspire companies such as Apple to open up their iPod device to other marketplaces than iTunes. Indeed, the ultimate marketplace is the lone creator.

Consumers 355, 356, and 357 interact with content from the 45 Revolver 390 in several fundamental ways which are not meant to limit the scope of the invention. There are hundreds if not thousands of similar scenarios that the 45 Revolver could foster. Consumer 1 355 views content or hears content that a web company 351 purchased from a 45 Revolver System 390. Web company 351 be run upon open source CMS software such as gallery or coppermine or postnuke or joomla. Modules written for such applications will be able to communicate with the stand alone 45 Revolver system 390 via a web services interface 340, so as to transfer appropriate version of the content and rights to the web company 351. Via the web services interface 340 and/or the chosen ecommerce gateway 305. Consumer 2 356 views content from a 45 Revolver system 390 along with an embedded ad from the 45 Revolver system 390. Alternatively, just an ad code could be embedded in the content in the 45 Revolver system 390, and the ad which is served, say from google or yahoo, could end up compensating the owner of the content, who has embedded their ad codes within the content. Such a system could be further developed as another child invention of the present invention. Consumer 3 357 acquires different content different manners. They view a watermarked, degraded, truncated, or thumbnailed version of the content on a web company's site 353—content which was processed in the 45 Revolver system 390, and uploaded via web services 340. Because the watermarked or thumbnailed version has a link embedded back to the original 45 Revolver 390 system, consumer 357 is then able to purchase a pristine original from The 45 Revolver system 390. Also, web 5.0 company 354 hosts degraded, thumbnailed, watermarked versions of the creator's 360 content 361, 362, 363, 364, 365 on their servers, with the agreement that they can sell the pristine original on consignment. Consumer 3 357 purchases the pristine original content from company 354, whereupon company 354 compensates the creator 360 via their 45 Revolver system 390.

The 45 Revolver system 390 is designed to handle all media formats form all applications, 300, 301, 302, 303—the 45 Revolver will be a Creator's best friend throughout their lifetime. As a web application, it could be updated on the fly with all the latest and greatest standards for DRM, watermarking, photography, film, and more. The vast majority of applications, 300, 301, 302, 303, don't come with any rights management tools whatsoever, just as the vast majority of web 2.0 companies come with no rights management features. Thus the principles underlying 45 Revolver system 390 would afford a powerful and much-needed web or desktop application. And anyone who created or owned this trusted bridge—this rights management suite—the primary port for all valuable content launched on out to the world wide web-would be able to conceive of and build superior social networks, content marketplaces, and more. And over time the web services system 340 could be optimized to play with the marketplaces and social networks that get it right—that optimize the creator's compensation.

FIG. 4 depicts the trusted 45 Revolver marketplace or social network or archive 410 that will naturally emerge from the precepts of this invention. As various artists, creators, owners, labels, and studios, 411, 412, 413, 414 employ the 45 Revolver system to define their rights, manipulate their content, and apply their rights and DRM protocols to their content, the 45 Revolver concept will be ideally situated to foster a trusted marketplace, wherein DRM standards congeal around the wishes of the artists and creators, and device manufactures and DRM protocol providers are encouraged to provide inexpensive options, or free DRM options, that best serve the creator, allowing them to fully protect and profit from their creations.

In this context, the 45 Revolver DRM marketetplace 400 will naturally emerge form the principles and innovations set forth herein, as DRM providers 401, 402, 403, 404 and device manufactures compete for the right to protect the creator's content and allow the creator to profit from their creations in optimum manners. Thus the world's first DRM marketplace will emerge—offering an ebay, amazon, or priceline model for DRM packages—any of which could be easily built by someone skilled in the field, with off—the shelf commerce and auction software.

The ramifications of this rights-centric, creator-centric invention is that it will force web 2.0/3.0/4.0, and all other web companies, DRM providers, end-device makers, media player manufacturers, to compete against one-another to offer creators, labels, and studios better and better deals. To the degree that established companies fall short of the higher ideals embodied in the Constitution and Declaration of Independence, more and more opportunities will be given to ventures that respect creators rights 395. The future will belong to a renaissance in rights and compensation for the creator, and to rising entrepreneurs and entrepreneurial desktop application and web 3.0, 4.0, 5.0 ventures that respect and salute the creator's rights with enhanced options and functionality. It was quite clever of the major corporations to hire MBAs/MFAs/JDs to deconstruct the higher ideals, Great Books, and classics, but they have only succeeded in deconstructing their own souls. Betting against eternal ideals is a not a good long-term investment strategy.

The 45 Revolver in FIG. 3 could be integrated directly with a musician's website, such as Kid Rock's website at kidrock.com, or Eminen's website at eminem.com, or 50cent.com. That way, the consumer would know that the content is official, and with the universality of the 45 Revolver that is guaranteed by its novel free market approach to DRM, their device will be able to play it. Over time, devices that do not play songs downloaded straight from the artist's sites, or movies downloaded straight from the Studio's sites, will fade away. Devices built around the principles of the 45 Revolver will allow artists to charge less and make more, and that will bring about good karma.

And there would exist vast opportunities to build trusted marketplaces around the principles of the 45 Revolver.

Unlike youtube, revver, and other web 2.0 companies who want to lock the creator into their specific software, format, and service, the 45 Revolver will always give the user access to the pristine original, as well as interfaces and information that aid in the distribution of the creator's content. Simple web services can register accounts in multiple content companies that aggregate content, and upload, manage, publicize, promote, and profit from the content throughout all of them. The 45 Revolver would be a vast time saver for the creator, artist, and content owner, allowing them to upload the pristine original once to a secure server, and syndicate watermarked, or degraded versions, on out to hundreds of other portals who make a living by commoditizing hundreds of artists. As time goes people will know that the 45 Revolver will be the place to go for the pristine originals.

As the 45 Revolver provides a rights management bridge between content creation applications and content hosting applications, the 45 Revolver could easily lead to the world's largest, most trusted marketplace for digital content. As more and more creators use the 45 Revolver's servers to define their rights, upload content, and have their rights applied to the content, more and more content will reside on the 45 Revolver servers. Now as the 45 Revolver is also committed to offering stand-alone DRM applications that can be integrated into websites such as kidrock.com or eminem.com or fiftycent.com, it will become popular amongst indie artists, who would then be confident that they could upload and trust the 45 Revolver marketplace, which is described in other child patents. In other words, the greatest way to build a marketplace is to empower each indie artist with great and vast freedom—with the 45 Revolver application described herein. This reflects that the greatest way to build a country is via united states-recognizing each states's rights—and wherein the state's respect the individual's rights.

While youtube recently sold for $1.65 billion to google, the Lord of the Rings Movies together raked in around $3 billion at the box office. Factor in the millions upon millions of DVD sales, the hundreds of millions of books sold, and one comes to see that J. R. R. Tolkien was one of the greatest entrepreneurs ever, when it comes to creating enduring wealth. While youtube received millions in venture capital, Tolkien never receieved a penny. Also, while Mark Cuban (blogmaverick.com) points out that Youtube was built upon a lot of pirated content, J. R. R. Tolkien created the entire Lord of The Rings Trilogy himself. Sometimes we Hobbits must leave the shire—the homestead that is taxed and assaulted by the deconstructive media, academy, and government, to fight the Orcs of Mordor, and begin the world anew. The 45 Revolver shall help the Real McCoys tame the Wild West and foster a new era of moral, creator-centric entrepreneurship.

FIG. 5 Many prominent lawyers from prominent law schools including Harvard and Stanford will laugh at FIG. 5, perhaps making it the funniest patent figure ever drawn, but then again, they're silently laughing as Wall Street pilfers pensions and plunders savings, as media CEO elites and government bureaucrats destroy the ideals underlying the family that Moses and Odysseus so loved to serve the short-term bottom line that enriches their superficial souls with fleeting wealth, as academia deconstructs the culture and bans the classics so that the children of the elite mutual fund managers might learn of the postmodern pretensions and marketing tactics by which trillions of dollars are transferred from the common artist, creator, and working man, to the pockets of distant lawyers, as the family is desecrated and Odysssues's home is overrun by the MBA/lawyer suitors who have gained the world but traded their souls for paper-thin degrees and titles, and so it is that the audible laugh heard when they view FIG. 5 will serve its purpose in calling the pomo pretenders out, and thus shall we know that FIG. 5 is a success. Everyone ought go out and rent A Fistful of Dollars, for now is the time when the Man With No Name emerges from the billowing cloud of smoke, as Odysseus did over 2800 years ago, to reclaim that which is so often the province of the rugged individual—the home of the artist and creator—truth, beauty, and freedom. It is easy to see why they have banned the Classic Western and the Epic that reminds us of the better angels of our nature: “When a man with 0.45 meets a man with a rifle, you said, the man with a pistol's a dead man. Let's see if that's true. Go ahead, load up and shoot.”—A Fistful of Dollars. We need to protect the rights of the indie artist and creator, just as Clint Eastwood protects the family and reunites mother and child in A fistful of Dollars, risking his life in doing so, and when asked why he did so, he responds, “because I once knew someone like you, and noone was there to help them.” Well, I once knew a beautiful girl—an indie artist—a Penelope, Beatrice, and Hepburn all in one—and nobody was there to protect her rights so that she might profit from her creations and make her passion her profession. If we let the immortals—the collectivists, dictate and control the rights of the individual creators, they will not hesitate to abuse and abolish those rights, as not only do collectivists not comprehend the glories of rugged independence, but they do not comprehend the moral source and foundation of all lasting art. Letting lawyers/aggregators—the natural born collectivists lacking creativity and individuality—the seed of the moral soul-manage digital rights is like letting foxes guard the henhouse.

FIG. 5 is at the heart and soul of the novelty of this invention. FIG. 5 returns the artist 520 to the driver's seat. It all begins with the divine act of creation, as the content creator uploads their content to the Dodge City DRM Marketpace 500, 511. The content creator is allowed to define their rights 45 Revolver Style 530. Various DRM providers 502, 503, 525 have offered pre-made DRM/distribution packages, as the competitive Dodge City DRM marketplace has encouraged such behavior, by rewarding those who best serve the artists and creators with turnkey packages, that also end up rewarding the end-consumer, as trusted standards emerge that are available to a wide spectrum of devices. No longer shall those who hog DRM-standards and file format standards, such as Apple, while giving away content in non-DRM'd format, dominate. DRM and standards huggers, operating behind thick clouds of lawyer-fueled smoke gained by burning the Great Books, Classics, and the Constitution, all with the purpose of enslaving the artist and creator to the tune of the device makers, are creating an inverted world. The present invention, and the Dodge city DRM Marketplace, sets the world right. Various consumers 523, 524, 526, and 527 consume the content in various DRM formats, all of which are available to artists and creators 520 uploading their content to the Dodge City DRM Marketplace. The Dodge city DRM Marketplace is capable of offering ecommerce transactions, delivering the content to Consumer 3 523, and delivering a portion of the payment to the Content Creator 520. DRM Provider 2 502 and DRM Provider 3 503 both serve the artist's rights definitions and thus they are afforded the opportunity to serve the artist's content, and charge for it, paying the pre-defined commission back to the Dodge City DRM Marketplace 500, which makes sure the artist is compensated. Other evil DRM providers, or device makers, or aggregators, or content aggregators, or search engines, or social networks, or businesses 540, 541, 542, 543, 544 who have terms and conditions not suitable to Dodge City, will be abandoned until they learn to play with others. Those who copy others' content, those who speak out of both sides of their mouth, claiming freedom while locking content into their own standards, and ripping off artists in the digital age as itunes does to Weird Al et al, may not find themselves welcome in Dodge City. All they have to do is better serve the artists, and offer their standards, devices, media players, social networks, and content aggregating sites with options that match the options defined by the artists, who have been afforded a full spectrum of rights management options, that are the very best that the technology can afford. No more crippling of the vast glory of the technology by pretend nor real leftist ideologies nor bottom-line-driven hype nor ironic, snarky, cutesy, effeminate words that mean nothing. In Dodge City every artist walks around with a fully-loaded 45 Revolver, so mess with the best, and die like the rest.

So it is that a greater, lasting ramification of the Dodge City Marketplace is that standards might emerge. Not because lawyers and pundits and bloggers are snarking the Constitution, but because artists, authors, and creators are living the Constitution.

A new breed of search engines 521, 522, 526 will arise, which better pay the content creators. The search engines will pay for spidering the content, cacheing the conent, and/or linking to the content, as defined by the artist, who from this day forth will no longer be bullied by billion dollar conglomerates, record labels, search engines, and snarky-snark lawyers commanding them to give their content away for free, and doing their best to make sure no other options are available.

The Dodge City Marketplace can also lead to a superior search engine 571. As indie artists and authors grow to trust the city where they can freely upload, protect, and profit from their content as they see fit, more and more content will be uploaded there. And over time, superior search capabilities and superior search engines will emerge, as content that is worth being protected is found within the city limits of Dodge City. The Dodge City brand will rely on the fact that all her citizens get a fully loaded 45 Revolver—an opportunity to protect, encrypt, and profit from their content.

The dodge City Marketplace may also spider web pages 572 and seek pre-DRM'd content 573 or DRM-encrypted web pages.

Consumer 1 527 may be served DRM'd content from DRM Provider 2 502 that is unlocked and made viewable when she views an ad, and/or responds to and ad, that is served along with the content from 502.

Due to a combination of corporate bottom-line bickering, snarky lawyers trying, to leave their lasting mark via snark instead of immortal art, and the general deconstruction of higher ideals across the greater culture, The current DRM/device landscape is a vast mess which falls far short of the potential of contemporary technology to serve the spirit of the United States Constitution. Dodge City will become a City on a Hill, providing artists and creators and content owners with the maximum rights options and mechanisms to protect and profit from their art, consumers with the maximum content options, and device makers and DRM providers the maximum opportunity to serve the most artists, creators, and consumers; thusly enriching entrepreneurial companies which best serve everyone upon a level playing field before the Ultimate Umpire's Higher Ideals.

### Description of Various Embodiments

Anyone skilled in the art of web server administration and website creation, design, and hosting, and the architecture of search engines, could build this and other embodiments of the present invention. The 45 Revolver Stand Alone Digital Rights Management application offers a new combination of previously available technologies, that results in a novel and powerful device that 1) empowers artists, 2) empowers consumers, 3) lowers the price of DRM by inspiring more competition, 4) lowers the price of media playing devices by fostering more competition, 5) commoditized the commodities—the web companies-instead of the talent—the creators, artists, and producers. The 45 Revolver Stand Alone digital Rights Management Application will naturally lead to the Dodge City DRM Marketplace. Because every artist will be armed with a 45 Revolver, Justice will Prevail. For if artists cannot be trusted to protect their own rights and to define their own rights, can lawyers be trusted to define their own rights and protect their rights for them? Indeed they have made great short-term profits by deconstructing Common Sense and Higher Ideals, and selling the brave new arbitrary law to the highest bidder, but Classical Law is coming on home.

The current DRM/device landscape is a vast mess which falls far short of the potential of contemporary technology to serve the spirit of the Unisted States Constitution. Dodge City will become a City on a Hill, providing artists and creators and content owners with the maximum rights options and mechanisms to protect and profit from their art, consumers with the maximum content options, and device makers and DRM providers the maximum opportunity to serve the most artists, creators, and consumers; thusly enriching entrepreneurial companies which best serve everyone upon a level playing field before the Ultimate Umpire's Higher Ideals.

The 45 Revolver is the creator's dream software application.

And the 45 Revolver is the tool upon which the Dodge City DRM Marketplace shall be built.

It's the world's first stand-alone digital right management application that provides such a full suite of tools—tools that are necessary to every artist looking to profit from and protect their invention. The present invention is all about calling the Web 2.0 MBA/MFA/JD bluff that says your content isn't worth anything independent of MBA/MFA/JDs. Web 2.0 is where the creators build the content. But nowhere in the Web 2.0 definition does it say anything about the creators getting paid for content they create. That's where Web 3.0 comes in—and web 4.0 and 5.0.

Dodge city will be the new trusted marketplace where all the artists will band together, to form, create, and further an artistic renaissance.

One way to solve the DRM dilemma is to remove ideals in both the artistic and legal realms. Story will thus be done away with, as story cannot live without characters, and there can be no characters without ideals. And by removing ideals in the legal realm, we can easily replace the sacred part of the constitution that recognizes the right of an artist and inventor to own and profit from what they do. But without story, giving up the rights one's creations won't result in that great of a loss, and we can all just create myspace pages with racy pictures from here on out towards eternity.

Anyone skilled in the art of web development, search engine creation, content hosting, and digital rights management, could build the following with readily accessible solutions. Someone skilled in the above arts could creating a marketplace for content comprising: allowing the creator or content owner to upload their content and define their rights, and allowing third parties to compete to meet the rights and payment requirements and serve the content in accordance with the rights defined by said creator or content owner. The content owner can convert their content to multiple formats, both open and proprietary, including jpeg, gif, mp3, ogg vorbis, windows media, quicktime, divx, hd, png, and others and define their rights choosing options from a full-spectrum of rights options including creative commons licenses, traditional copyrights, various Gnu Public Licenses, and DRM formats such as Microsft DRM, Apple DRM, Sun DRM, Google DRM, Realmedia DRM, and other DRM formats. The above third parties could DRM providers like Microsoft or Apple or someone else. The above third parties could be device makers like Microsoft or Apple or someone else. The third parties are content aggregators like google, youtube, myspace, or someone else. The third parties could be search engines such as google, yahoo, or Microsoft, or someone else. The content could be audio, photographic, text, video, some combination of the prior, or some other content. The above third parties could social networks such as facebook or myspace or someone else. The above third parties could be are those who put content into physical form including but limited to CD producers, DVD producers, printers, publishers, and others.

The above third parties cold be those who embed ads and/or paid advertising into content. The above third parties could be DRM providers who embed ads into the content, and when said ads are views or reacted to by consumers of said content, said content is unlocked and made viewable. DRMed content, DRM, copyrights, watermarks, copyright applications, and Trademark applications, may be created with a single click. Default DRM, copyrights, watermarks may be applied automatically. Single click DRM™ and autho-DRM™ may become Trademarks about copyrights.

Also, the present invention would allow someone skilled in the art of search engines to create a superior search engine comprising: allowing the creator or content owner to upload their content and define their rights, with the said search engine making sure that the creator is paid in accordance for their rights definitions for every copy of their content made, where the content is audio, photographic, text, video, some combination of the prior or other form of content, where the copy is made via caching the content, and where the creator is paid any time the cache is made, or copied and diplayed on an end-user or browser's computer, where the copy of the content is made during the spidering process, as all spidering processes by definition must rely on a copy of the content being spidered, where the copies of the content are uploaded to servers owned or operated by said search engine, where copies of the content are uploaded to servers not owned nor operated by said search engine.

Someone skilled in the arts of ecommerce could build the present inventions enhanced digital marketplaces by a) providing a creator to business marketplace, b) a business to business marketplace, and c) a consumer to business marketplace where creators choose from turnkey solutions to protect and distribute their content offered by parties including but not limited to search engines, device makers, DRM providers, content aggregators, social networks, content publishers, content distributors, and others who make money from artistic creations including books, movies, film, audio, music, art, photography, hybrids thereof, and others. 45Gallery is just one preferred embodiment of the 45 Revolver. It is the artist/photographer's dream software application. Other embodiments would handle film, music, books, video games, and further digital content, or combinations thereof.

The 45 Revolver begins with a screen that lets you define your rights.

It makes rights definitions the first step. Your name. Your default price. Other Dublin core information. You get to choose your default DRM settings, payment gateways, watermarking options, and thumbnailing options-all from simple, drop-down menus.

You get to choose everything—the price for the originals, the price for digital copies, the price for prints; the sizes of all the media, and more.

The digital content you create is about to undergo a noble journey through space and time, circling the watery globe for as long as the internet exists. Make no mistake-content is the reason people use the internet. In addition to all the telecoms, flickr, myspace, and google, you ought to get paid for it. That's what web 3.0 is all about—where content creators define their rights and make money.

45Gallery allows you to upload all of your photography/paintings/art, and it automatically watermarks your works, placing your art both in elegant display software (gallery) and robust commerce software (oscommerce). Future versions will handle all media—audio, video, pdfs, and combinations thereof. 45Gallery combines the best of many worlds to offer the web's most powerful turnkey stock photography shop.

Beginning with the leading open source application for photo hosting—gallery—and adding the robust functionality of the leading open source commerce system—scommerce—45Gallery offers a combination of artistic presentation with robust commerce. And as gallery and oscommerce advance, as versions are rendered in Ruby on Rails and future languages, the 45Revolver will ensure that your content is ready to surf the next generation web applications. Another function of the 45Revolver is to always ensure that media is easily ported—both into new and different formats, such as the latest Quicktme or Windows Media or png format, and into various applications, portals, networks, and content aggregators, such as gallery, oscommerce, myspace, zencart, cubecar, glidedigital, youtube, and flickr.

The heart and soul of 45Gallery is the 45Revolver—a stand-alone, rights-centric, creator-centric application that offers a bridge between gallery and oscommerce, and sites beside them.

The 45 Revolver can sit beside any content-hosting application, and it could be written in current LAMP technologies or RUBY on RAILS.

The present invention could sit on myspace servers and handle all the rights management, ecommerce transactions, and watermakring—it would be a Godsend to all the indie, prosumer, and professional artists and bands.

The present invention could sit on flickr servers—it would be a Godsend to all the indie, prosumer, and professional photographers.

The present invention could sit beside any open source content management (CMS) system, thusly supplying the missing piece-a rights management suite.

Web 1.0 and 2.0 are all about aggregators of content making money off of large pools of creators who create all the content and do all the heavy-lifting. The 45Revolver is all about creators making money.

Web 1.0/2.0 viewed the creator as a commodity, with little or no value on their own, but great value in their aggregation. The 45Revolver views web 1.0/2.0 apps as the commodities—having little or no value of their own, but having great value to the creator when they can upload and syndicate, publish, and publicize their content throughout the multitude of Web 1.0/2.0 applications. The key to the 45Revolver is that it always allows the creator to sell the content directly with a simple paypal or credit card transaction, thusly removing the middleman aggregator.

One should not underestimate the value that will come from the 45 Revolver's power and freedom. A rights-centric, creator-centric application that gives the creator the freedom to define rights, and the freedom to publish in all leading portals and applications throughout the web, will give rise to hitherto unforeseen business opportunities. Because of its power and freedom, the 45 Revolver will become a chosen mechanism for publishing and porting content—the first step before launching all content throughout the web, so as to protect it with DRM, brand it with watermarks, and thus monetize it. Because it concentrates on allowing the creator to publish in any portal, because it seeks to make the transfer of contenht from one application to another fluid, the 45 Revolver will become a content highway. And it is more important to own the highways—where everyone travels—than it is to own the destinations, such as Flickr, myspace, lulu, cafepress, and others, all of which would rather that neither users nor content ever use any of the other of hundreds of content marketplaces and portals. Business opportunities for new social networks that pay the creators will emerge. These new social networks may compensate creators based on algorithms tied into the inherent structure and connectivity of the underlying social network, which connects not only people, but also content.

The 45 Revolver will become the center where all roads out to other portals and applications and formats come together. Because of this, business opportunities will abound, and further opportunities for patents will become apparent. A search engine that monitors all of the traffic through various 45 Revolver applications would produce a premium search engine, as creators who care about protecting and profiting from their content generally create better content than found on the average myspace page. A social network that ties into the 45 Revolver, which allows users to upload, display, and sell their protected, branded content, will result in a social network with premium content, as again, those who seek to protect, brand, and profit from their content generally create better content.

Also, as the 45 Revolver allows the embedding of ads and adcodes in all media via various methods, including superimposed keywords, trailers, previews, and more, content that passes on through the 45 Revolver en route to its voyage on out will pay the creator ad in finitum as it voyages around the watery globe. Social networks that seek to support the embedded ad features will prosper as they will receive the premium content. Those networks that do not support the embedded ad features will have to keep on keeping all the money and see how long their userbase lingers.

DRM advertising, where the media is protected by DRM, but it is unlocked whenever an ad is served in conduction with the DRM is another business model the 45 Revolver could inspire. For instance, the 45 Revolver could encrypt all of the photographs, or audio, or video, or any other type of media file. Now the content could be uploaded to a 45myspace, or a 45flickr, where the only way that the media is decrypted is if the 45myspace or 45flick serves an ad alongside the media. Otherwise, the photography would not be visible. Thus the creator is ensured that whenever her content is viewed, and ad is also viewed—an ad which compensates the creator.

Stronger, more pervasive DRM, would be a great way to solve the “fair use” conundrum. The creator would basically be saying—sure, you can go ahead and use my picture on your page, as long as you support the mechanism that displays an ad along with it. “Sure-go ahead and use my video clip on your page, just as long as you support the mechanism that displays an ad before the video,” future creators might say. “On myspace.com you can't see my photos and video, but on 45myspace.com you can, as 45myspace supports a mechanism by which ads are served alongside my content, which I am compensated for. My files are decrypted upon the serving of an ad.”

The 45gallery, an embodiment of the present invention, has the following salient features

1) define rights

2) display art elegantly with fully themable templates

3) sell prints

4) sell downloads

5) choose from multiple DRM formats

6) choose from multiple watermarking options

7) multiple license options

8) batch uploads

9) drag & drop uploads

10) batch watermarking—both custom text and image overlays

11) batch export watermarked images to flickr, pbase, and other popular photo hosting sites

12) specify print sizes and prices by individual image (and quantity if limited edition)

13) customer must accept license agreement prior to allowing checkout

14) agreement presented based on license selected for customer to print.

15) download upon acceptance of payment.

16) download expires by date and/or # of attempted downloads.

17) download links only work if customer pays (random users can't just guess the url or direct link to images)

18) robust search facility by keyword, description and browse by category

19) elegant gallery presentation separated from shopping cart

20) item purchase options on photo's shopping cart detail page

21) robust reporting on sales history, tracking all customers

22) accept payment by paypal, authorize.net, and all popular gateways

23) offline credit card option: see zen cart and how this is handled by storing part and emailing part for security

24) fully customizable appearance for gallery and commerce site

25) 100% of the source code for gallery and shopping cart

26) vast support communities for the gallery (gallery.sourceforge.net) and commerce (creloaded.org and oscommerce.org)

27) phone support for the 45 Revolver Rights Management tool: 919-270-0732

28) software will surf cutting-edge developments in open source software, on out toward ruby on rails.

### Extensive Open Source Feature Set

The 45 Revolver philosophy allows for extensive features and customizability. Based on Open Source, with a proprietary part for the rights management and content syndication, it is designed to surf the waves of innovation for years to come.

The 45 Revolver offers several maverick philosophies about content including the DRC philosophy, which stands for Display, Rights, and Commerce.

There are three entities which the Professional Photographer/Painter/Gallery owner must master. These are Display, Rights, and Commerce, or Art, Law, and Business. 45StockPhotography marries three applications, both open source and proprietary, to realize this.

Display: The famous Open Source Gallery@gallery.sourceforge.net

Rights: Dr. E's 45Revolver (PATENT PENDING)

Commerce: The famous Open Source creloaded.com based on oscommerce.org

When we put all of this together in the 45Gallery/45StockPhotography package, we realize a stock photography solution with unparalleled features. Here're more details of each of the three parts:

Display: The famous Open Source Gallery project which has modules for handling all types of media, including music, photography, film, and more—providing vast open source power. All that's missing is a commerce system, provided by oscommerce or some other application, and rights management suite, provided by the 45 Revolver. Gallery Features:

### 1) Image Magick or NetPBM—pick which image manipulation package you have on your server or want to use.

### 2) Auto Rotate Images—Gallery can look at information in pictures from digital cameras and automatically rotate them as needed.

### 3) Image Quality and Size Defaults—You can limit the quality and size of images so that when images are uploaded, Gallery will resize them to save space.

### 4) Main Gallery Page Settings—The configuration wizard contains all of the settings for how the main Gallery page looks and acts including showing or hiding the album tree, search engine, or album owner, and what frames to show around albums.

### 5) Optional Binaries: zip, jhead, jpegtran—If you have these programs on your webserver, you can enable them to make gallery work better and be more flexible.

### 6) Languages—Choose which languages you want your Gallery to support and how the user is presented with the choice.

### 7) Email Support—Set up email support to have your Gallery email users when their accounts are created or when they forget their password, email you copies, email people when the Gallery is updated, and more!

### 8) Gallery-wide Slideshow—enable or disable a slideshow that includes all pictures in the gallery

### 9) Commenting—turn off or on the public commenting system and configure it.

### 10) Logging—enable logging with syslog or the Windows logger

### 11) RSS publishing—publish your Gallery with RSS![1]

### 12) Album Defaults—set defaults for the way that all new albums will originally look

### 13) Upload a ZIP file full of photos and movies

### 14) Use a form to upload up to 10 photos at each time with and optional file containing descriptions. (screenshot)

### 15) Specify a web page and let Gallery go slurp up all the photos and movies on that page. (screenshot)

### 16) Copy all images to a directory on your webserver and let Gallery copy them directly into your album.

### 17) Use the embedded applet (screenshot) and drag-and-drop pictures and movies to upload them.

### 18) Use Gallery Remote or one of the Other methods available.

### 19) Edit the title, caption, keywords, and other custom fields that you define. (screenshot)

### 20) Modify the thumbnail with java applet, selecting only part of the image to show. [2]

### 21) Rotate the image in increments of 90 degrees.

### 22) Move the photo to a different place in the same album or a different album.

### 23) Hide the photo so that only the album owner or logged in users can see it.

### 24) Delete the photo.

### 25) Add a watermark of your choice to your photo. (screenshot) Adding Photos:

26) Gallery Remote—Gallery Remote is a java program that will run on any system that java will run on. Your users can use to upload photos to your Gallery via a drag-and-drop interface[0] (screenshots). On the standard file upload page there is a link to the Gallery Remote download page which will download the application from the SourceForge server directly to your user.

### 27) Other methods are available to easily add pictures to your Gallery including ones that support Windows XP, Apple's iPhoto, Mobile Phones, perl, python, and more.

28) RSS can be used to publish your Gallery and updates to it. Customizing:

### 29) CSS—Modify Gallery's style sheets, use your existing site's style sheet, or write your own to control colors, borders, spacing [0]

30) Themes—Gallery comes with lots of themes are there are plenty more to download. Check out The user contributions page to start looking for more skins and other easy customizations. [0]
31) html_wrap—Have an existing HTML template for your site but don't use a content management system? htmlwrap is for you! You can include content above, below, to the left, and to the right of gallery to make it blend in with the rest of your site. (example 1, example 2, example 3)[0]
32) changing code—Gallery is open source so you can easily change the source code to make it do whatever you want it to do.
Indie Rights: Dr. E's 45 Revolver. The following application could be designed by someone well-versed in web development and software engineering

### 1) Allows creator/user to define default rights

### 2) Allows creator/user to choose from multiple DRM protocols

### 3) Offers multiple watermarking options

### 4) Offers multiple thumbnailing/abbreviating options

### 5) Stores pristine original securely

### 6) Rights management for any and all content

### 7) Thumbnailing for any and all content types

### 8) Embedding ads into any and all content types

### 9) Text Watermarking

### 10) Graphical Watermaking

### 11) Define price

### 12) Define exif/other embedded metadata

### 13) Export/publish watermarked, thumbnailed, degraded DRM'd, or other format to flickr, lulu, myspace, pbase, cafepress, amazon, itunes, web 1.0/2.0/3.0 company, etc.

### 14) Allow creator to always sell directly to consumer, bypassing all other commerce portals

### 15) Embed ads

### 16) Embed adcodes in metadata, so that when content is displayed on any site, the ads pay the creator

Microsoft's DRM, Apple's DRM, Open Source DRM, and/or some other DRM may be used here within this part of the overall application.

Functionality from Microsoft's DRM, as defined at http:www.microsoft.com/windows/windowsmedia/forpros/drm/sdksandversions:aspx includes

### Operating Systems: Windows Media DRM 10 Windows XP, and non-Windows-based portable and network devices

Portable Device Support: Portable audio players, mobile phones, set-top boxes, and DVD players that support Windows Media DRM playback

Codecs: Windows Media Audio 1, 2, 7, 8, 9, 9 Professional, and 9 Voice, Windows Media Video 7, 8, 9 and 9 Image, Microsoft MPEG-4 version 1 through 3, ISO MPEG-4 version 1, and Windows Media Screen 7

The creator would get to control the Business Rules, setting options for all of the following.

### Business Rules

Expiration date
Unlimited play
Burn to CD (# of times)
Start time
End time
Duration (period media can be used)
Counted operations (plays, transfers)

### User Experience:

Greater device functionality
Subscription content transfer to devices
Faster license acquisition and renewal
Playback of protected content on network devices
Same, plus revocation and exclusion are extended to portable devices and network devices.
   Security: Encryption of content and license, plus:
Individualization
Secure Audio Path (Windows Millennium Edition and Windows XP)
Revocation of player application
Revocation of content (version 7.1 and later)
Exclusion of player application (version 7.1 and later)
Exclusion of Protected Content Module (version 7.1 and later) revocation and exclusion are extended to portable devices and network devices.

### Commerce Component: The famous Open Source creloaded project based on oscommerce can be easily installed by anyone with knowledge in web development.

Features: from oscommerce.org: Although osCommerce is still in its development stage, the available Milestone releases are considered to be stable with the following features:

### 1) General Functionality

### 2) Compatible with all PHP 4 version

### All features enabled by default for a complete out-of-the-box solution

### 3) Object oriented backend (MS3)

### 4) Completely multilingual with English, German, and Spanish provided by default

### 5) Setup/Installation

### 6) Automatic web-browser based installation and upgrade procedure

### 7) Design/Layout

8) Template structure implementation to:
allow layout changes to be adaptive, easy, and quickly to make (MS3)
allow easy integration into an existing site (MS3)

### 9) Support for dynamic images

### 10) Administration/Backend Functionality

### 11) Supports unlimited products and categories

+ Products-to-categories structure
+ Categories-to-categories structure

### 12) Add/Edit/Remove categories, products, manufacturers, customers, and reviews

### 13) Support for physical (shippable) and virtual (downloadable) products

### 14) Administration area secured with a username and password defined during installation (MS3)

### 15) Contact customers directly via email or newsletters

### 16) Easily backup and restore the database

### 17) Print invoices and packaging lists from the order screen

### 18) Statistics for products and customers

### 19) Multilingual support

### 20) Multicurrency support

### 21) Automatically update currency exchange rates

### 22) Select what to display, and in what order, in the product listing page

### 23) Support for static and dynamic banners with full statistics

### 24) Customer/Frontend Functionality

### 25) All orders stored in the database for fast and efficient retrieval

### 26) Customers can view their order history and order statuses

### 27) Customers can maintain their accounts

+ Addressbook for multiple shipping and billing addresses

### 28) Temporary shopping cart for guests and permanent shopping cart for customers

### 29) Fast and friendly quick search and advanced search features

### 30) Product reviews for an interactive shopping experience

### 31) Forseen checkout procedure

### 32) Secure transactions with SSL

### 33) Number of products in each category can be shown or hidden

### 34) Global and per-category bestseller lists

### 35) Display what other customers have ordered with the current product shown

### 36) Breadcrumb trail for easy site navigation

### 37) Product Functionality

### 38) Dynamic product attributes relationship

### 39) HTML based product descriptions

### 40) Automated display of specials

### 41) Control if out of stock products can still be shown and are available for purchase

### 42) Customers can subscribe to products to receive related emails/newsletters

### 43) Payment Functionality

### 44) Accept numerous offline payment processing (cheque, money orders, offline credit care processing, . . . )

### 45) Accept numerous online payment processing (2CheckOut, PayPal, Authorize.net, iPayment, . . . )

### 46) Disable certain payment services based on a zone basis

### 47) Shipping Functionality

### 48) Weight, price, and destination based shipping modules

### 49) Real-time quotes available (UPS, USPS, FedEx, . . . )

### 50) Free shipping based on amount and destination

### 51) Disable certain shipping services based on a zone basis

### 52) Tax Functionality

### 53) Flexible tax implementation on a state and country basis

### 54) Set different tax rates for different products

### 55) Charge tax on shipping on a per shipping service basis

And because we're using the creloaded version of oscommerce, we find the following enhancements form the creloaded.com site within our commerce: CRE Loaded 6.15 Full List of Contributions Installed: Value Added Features:

### 1) Admin Control By Michael Bryant

### 2) All-Prods-v2.4 Author: v 1.0 by Mat Bennett, Updated for Milestone MS 2.2 by Farrukh Saeed

### 3) All-Categories Author: Ingo Malchow, info@gamephisto.de

4) All-Manufacturers Author: Alex Kaiser, et al5) Column Product Listing MS2 Author: David Garcia Watkins, Updated for MS2 by Michael Sasek, *Additional Bugfixes by Souza Credit Class/Gift Voucher/Discount Coupons 5.10b Author: Ian Wilson, Updated for MS2 by Strider, *Additional bugfixes by Andre, Nick Stanko

### 6) Define Mainpage v1.2 Author: Mattice, Updated for MS2 by Lee Nielsen

### 7) Google Adsense SSL Safe Code Author: Tom O'Neill

### 8) OSC-Affiliate 1.09 Author: Henri Schmidhuber, Updated to BTS v1.0 by Paul Langford

### 9) Purchase Without Account Author: Cheng et al, Updated by David Graham and Tom O'Neill

### 10) SaleMaker 2.2MS2v1.01 Author: Marcel van Lieshout

### 11) Specials On Main Page by Default Author: Steve Kemp

### 12) UltraPics v1.1 Author: Lee Nielsen (MaxiDVD)

### 13) Wish List V 2.2 Author:Jesse Labrocca, Updated by Talon177

### 14) X-Sell MS2 Author: Joshua Dechant Admin Enhancements:

### 15) Attribute_Sorter—Copier v5.1 Author: Linda McGrath

### 16) Admin With Access Levels 2.2 Author: Zaenal Muttaqin, Updated for MS2 by Seth Lake

### 17) Basic Template Structure 1.3+Fixes Author: Brenden Vickery, Modified by Paul Langford

### 18) Category Box Enhancement 1.1 Author: Nils Petersson

### 19) DHTML Menu in Admin V. 2 Author: Matti Putkonen, Updated by Sheetal

### 20) Download_Controller v5.3 MS2.2 Author: Linda McGrath, Updated by Farrukh Saeed

### 21) Down for Maintenance v1.1b Author: Linda McGrath osCommerce@WebMakers.com, Updated by Robert Hellemans

### 22) Easy Populate 2.75 Author: Tim Wasson, Updated for MS2 by Deborah Carney, Bugfixes by Deborah *Carney and Ian Corner, CRE Enhancements by Tom O'Neill

### 23) Edit Orders 1.56 MS2 Author: Jonathan Hilgeman

### 24) Infobox Admin v1.1MS2 Author: Paul Langford

### 25) Meta Tag Controller/Generator Author: Brenden Vickery, Bugfixes by xxGeek

### 26) Mysql Backup Author: The Zen Cart Team

27) osC-PrintOrder with Store Logo v1.0 Author: Randy Newman

### 28) Super Friendly Admin Screen—Version 2.1 Author: Kerry Watson, Updated by David Graham (nimitz1061)

### 29) Template Install & Configure V1.2 Author: Paul Langford

### 30) Who's Online Enhancement 1.3 Author: Calvin K

### 31) WYSIWYG HTML Editor for Admin 1.7 Author: Lee Nieslen

### 32) WYSIWYG HTML Editor Added to Coupons and Gift Vouchers Author: WI Benjamin

### Enhanced Customer Care:

### 33) FAQ Desk 1.01 Author:Carsten aka moyashi, Updates By: Wolfen aka 241

34) Information System V1.1f. Author: Joeri Stegeman, addition by: Xander Witteveen and Janusz Oles

### 35) News Desk 1.48.3 Author:Carsten aka moyashi Updates By: Wolfen aka 241

### Payment Modules:

### 36) Authorize.net Consolidated 1.7 Author: Austin Renfroe, Updated by David Graham and Tom O'Neill

### 37) EFSnet Payment Module Author: John Nelson

### 38) GeoTrust/SkipJack Payment Module Author: Paul Kim

### 39) PayBox Payment Module Author: Emmanuel Alliel

### 40) Paypal Shopping Cart IPN 2.8 Author: Greg Baboolal, CRE Integration by David M. Graham

### 41) Pay Junction payment module Author: Robert Krimen rkrimen@payjunction.com

### 42) Quick Commerce Pro payment module Author: Tom O'Neill (zipl) based on Authorize.net 1.7 Shipping Modules:

### 43) FedEx 1.11 MS2 Author: Steve Fatula

### 44) UPS Choice 1.8 Author: Fritz Clapp

### 45) USPS Methods 2.5 Author: Brad Waite, Updated for MS2 by Brad Waite/Fritz Clapp

46) Zone World 2.0 Author: Elari and Friends of Zone World CRE Loaded integration: David Graham Order Total Modules:

### 47) Qty discount v1.41 Author: Joshua Dechant Reports:

### 48) MonthlySales&Tax1.55 Author: Fritz Clapp InfoBox Additions:

### 49) Banner-ad-in-a-box V1.1 Author: Aubrey Kilian

### 50) Category Tree Author: Gideon Romm

### 51) Category Drop Down Author: David Garcia Watkins, Fixes by Brian Kiggin and Paul Boekholt

### 52) Credit Card in a Boxes for OSC Author: koreantown@hanmail.net, Updated by elari

### 53) Donate for Nonprofit Site Author: Anon

### 54) Google Ad Box Author: Tom O'Neill

### 55) Shop by Price Author: Meltus, Updated for admin control by Charles Williams

So it is that a robust and versatile embodiment of the 45 Revolver, designed to allow authors, artists, creators to protect audio, video, and photography, and other files, could be readily assembled from “off—the shelf components” by an expert in the field. The novel combination, complete with the fundamental rights-management suits offering a plurality of digital rights management options, would greatly empower the creator.

None of the prior art offers options so extensive nor versatile, nor any application that seeks to offer the user so many ways to protect and profit from their creations.

The present invention allows the creator to bypass all the traditional and new middlemen, take their rights into their own hands, and read the maximum benefits that the technology can afford in a novel, hitherto unseen, manner.

### Further Embodiments

Imagine if search engines had to pay copyright holders a price-per-page to scan books, and/or a fee each time a page from the book was accessed. Imagine if search engines had to pay for copying images, video, and thumbnails, either whenever they copied such assets, or when they displayed such asetts, or when they mined such assets for the information by which search is made possible—both content and links. Imagine if search engines paid content creators whenever ads were served alongside content created by said content creators, form the search engine's servers. This would improve the quality of the search engines while also enriching creators of content. Imagine the following:

1) a mechanism by which authors set the price for the scanning and indexing of their works within directories.
2) mechanism by which authors and creators set the price per page view when a scanned page is viewed within a search engine.
3) mechanism by which authors and creators may embed ads and images within their works, so that ads and images displayed alongside, before, after, or superimposed on their work.
4) mechanism by which text ads revenue is given to authors when their books are scanned.
5) new search engine of premium content wherin copying content isn't free.

### 6) A search engine that pays creators when their content is served off the search engine's servers

### 7) A search engine that shares ad revenue with the content creators

All this could be made possible by the 45 Revolver.

Furthermore, as people are growing weary and wary of banner ads and text ads, media-embedded ads have a lot to gain. Embedding ads in photographs and video could go a long ways. Various kinds of novel ads, which scroll across the bottom of the video or photograph, could be served.

### Further Objects and Advantages

Prior art did not emphasize the creation of stand-alone, proprietary nodes, but rather open source modules that would sit on top of open source software.

While the linux operating system has proven a success, the open source model has not fared as well for creating universal standards for digital rights management and content management. Hundreds of open source content management applications exist, each with different protocols for RSS feeds.

Because the open source community is not predispositioned towards the concept of property rights management, a proprietary bridge between various open source CMA and ecommerce, capable of rights management, such as the 45 Revolver makes sense

If one was seeking to build the greatest content marketplace, one would wish to begin by empowering the individual artist and creator to the fullest extent. Thus the present invention could also lead to the world's leading marketplace for content.

The content marketplace powered by the 45 Revolver would include:

### 1. Full Artistic Control: Open Source CMS allows Artist-Hackers to get under the hood to change themes, graphics, UI, sound quality, modules, etc.

### 2. Distribution: Open Source CMS coupled with RDF/RSS fosters efficient searches and syndication on the semantic web, and thus effective distribution.

3. DRM: Open Source CMS coupled with an extensible rights language such as the CC licenses expressed in RDF/RSS allows a full spectrum of rights definitions in parallel with distribution. Open security standards and protocols afford financial transactions, secure delivery, and trusted ratings for marketplaces and content.

If we used modules instead of stand-alone applications, the modules would be subject to any security breaches in the open source applications. The stand-alone application would provide an extra layer of protection form the modules.

By utilizing stand-alone applications, coupled with modules, the stand-alone application would provide more flexibility. For instance, if an open source application were surpassed in functionality by another open source application, and one wanted to switch, one could still use the same stand-alone bridge to manage content from the new open source application.

If the nodes were open source, they would be easily modified, and it would be more difficult to maintain a standard that would allow one to scale a massive marketplace.

If the nodes were modules, they would be more dependent on the fate of the open source application, and more subject to any security breaches. By creating a stand-alone rights management application such as the 45 Revolver, one will allow artists, creators, and content owners to maximize their reach, audience, and profits.

### FURTHER RAMIFICATIONS OF INVENTION

Open Source software rocks. I use it all the time.

Proprietary software rocks. I use it all the time.

Both are firmly rooted in intellectual property law.

I want you to own your intellectual property, and I want to own mine. I want you to have the freedom, and the power, to do with your IP what you wish. Without power to take advantage of cutting-edge technology, what use is freedom?

Thus it makes sense that web 4.0 and web 5.0, where creators will get to own and profit from their content, should be based on a set of patents penned not by a corporation nor a legion of lawyers nor a publicly-traded open source company, but by an individual. By the lone Ranger. By Odysseus. By Ranger McCoy.

Postmodernism has taken a vast toll upon culture—in Hollywood, on Wall Street, in NY publishing, and in once sacred institutions such as the family, the church, and academia. If you don't believe me, chances are you have been postmodernized. They have convinced you that ideals are not real, and you have been programmed to work in a cubicle, acquire vast and random debts, and deny your soul, or something.

As it stands, companies such as Google and Red Hat have legions of lawyers to convince you that your natural rights as expressed in the Constitution are a joke, that your ideas are not worth patenting, that your content is worthless on its own, that content aggregators are more important than creators.

But what aggregator is more important than Shakespeare? What aggregator has a greater market capitalization than Dante, than Homer, than Jesus and Socrates? The 45 Revolver & the Commodity Reversal

All the digital content you create has a chance of outliving you. As it travels from disk to disk about the watery world, the digital bits nor bytes will ever change, thus promising it a far greater chance of eternity than mortal flesh. As the billion dollar internet industry is built upon content, that means that your content is doing the heavy-lifting in the information age, and it could be doing it for a long, long time to come. Being paid for it is your natural right.

Your photography will be quite happy to labor on out towards eternity, and while the copyrights will expire about seventy years after your death or so, you should profit from it while you can. And so should your children. It's not like you build a house and then give it to flickr, yahoo, google, and lulu so they can make money off of it—you don't hand them the keys to your house and let them sell advertising over the paintings on your wall, so why should you give them all your content and expect nothing in return?

Web 4.0 and 5.0 are where the content creators will make money. Technology is the natural commodity as by and large it is based on natural algorithms, whereas copyrighted material—the unique, distinct creation of a single individual, imprinted with their soul, is a natural asset than cannot be commoditized. And yet the present web, as well as the mega corporations, are based n treating artists and creators as commodities—as widgets. This explains the simultaneous creation of wealthy content aggregators and the declining Hollywood box office, the death of literature, the eradication of DJs who say what they want to say and play what they want to play, and the soulessness of video games.

But something is about to happen.

Creators are about to take the law into their own hands as never before.

And this will result in the commodity reversal.

The 45 Revolver is a foundational invention that enables other inventions. The 45 Revolver empowers creators as never before. The 45 Revolver enables the commodity reversal. In its most simple form, the concept is expressed in the figures and the above 45gallery embodiment.

Thus it is seen how the corporate and open source philosophies, by keeping DRM separated from the creator, have failed to come up with a viable, trusted, popular, and useful solution. The 45 Revolver stand-alone rights management application offers such a solution for DRM, by placing a full spectrum of DRM choices in the creators' hands, and it will thus enrich consumers, businesses, and society; all because it will enrich creators.

The individual entity is the leading contributor to content on the web, and yet there exists no simple system nor method for an individual entity to quickly and easily encode, protect, and distribute their media. The 45 Revolver provides this. The 45 Revolver will foster and father far more in the realm of innovation.

The Dodge City Marketplace can also lead to superior search engines 571. As indie artists and authors grow to trust the city where they can freely upload, protect, and profit from their content as they see fit, more and more content will be uploaded there. And over time, superior seach capabilities and superior search engines will emerge, as content that is worth being protected is found within the city limits of Dodge City.

### FURTHER SCOPE AND RAMIFICATIONS OF INVENTION

The embodiments described, as well as future embodiments of the same principles, will open the floodgates of opportunity for artistic entrepreneurs to protect and profit from their content, as well as for entrepreneurs to build enhanced content marketplaces and search engines that deal with content that is worth protecting because people are willing to pay for it. So it is that a cultural renaissance might be fostered via such a system.

“The world will know that free men stood against a tyrant, that few stood against many, and before this battle was over, that even a God-King can bleed.”—300

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for creating a marketplace for content comprising: allowing the creator or content owner to upload their content and define their rights, and allowing third parties to compete to meet the rights and payment requirements and serve the content in accordance with the rights defined by said creator or content owner.

2. The method in claim 1 where the said content owner can convert their content to multiple formats, both open and proprietary, and define their rights choosing options from a full-spectrum of rights options including creative commons licenses, traditional copyrights, various Gnu Public Licenses, and DRM formats.

3. The method in claim 1 where said third parties are DRM providers.

4. The method in claim 1 where said third parties are device makers.

5. The method in claim 1 where said third parties are content aggregators

6. The method in claim 1 where said third parties are search engines.

7. The method in claim 1 where said content is audio, photographic, text, video, some combination of the prior.

8. The method in claim 1 where said third parties are social networks.

9. The method in claim 1 where said third parties are those who put content into physical form including but limited to CD producers, DVD producers, printers, publishers, and others.

10. The method in claim 1 where said third parties are those who embed ads and/or paid advertising into said content.

11. The method in claim 1 wherein said third parties are DRM providers who embed ads into the content, and when said ads are views or reacted to by consumers of said content, said content is unlocked and made viewable.

12. The method in claim 1 wherein DRMed content, DRM, copyrights, watermarks, copyright applications, and Trademark applications, may be created with a single click.

13. The method in claim 1 where default DRM, copyrights, watermarks may be applied automatically.

14. A method for creating a search engine comprising: allowing the creator or content owner to upload their content and define their rights, with the said search engine making sure that the creator is paid in accordance for their rights definitions for every copy of their content made.

15. The method in claim 12 where said content is audio, photographic, text, video, some combination of the prior.

16. The method in claim 12 where the copy is made via caching the content, and where the creator is paid any time the cache is made, or copied and diplayed on an end-user or browser's computer

17. The method in claim 12 where the copy of the content is made during the spidering process, as all spidering processes by definition must rely on a copy of the content being spidered

18. The method in claim 12 where the copies of the content are uploaded to servers owned or operated by said search engine

19. The method in claim 12 where copies of the content are uploaded to servers not owned nor operated by said search engine.

20. A method for aggregating content and building digital marketplaces by providing a creator to business marketplace and business to business marketplace and consumer to business marketplace where creators choose from turnkey solutions to protect and distribute their content offered by parties including but not limited to search engines, device makers, DRM providers, content aggregators, social networks, content publishers, content distributors, and others who make money from artistic creations including books, movies, film, audio, music, art, photography, hybrids thereof, and others.
